(19) United States
(12) Patent Application Publication
(10) Pub. No.: US 2025/0144616 A1
(43) Pub. Date: May 8, 2025

(54) FILTRATION SAMPLING AND TESTING DEVICES

(71) Applicant: HERO SCIENTIFIC LTD, Jerusalem (IL)

(72) Inventors: Zvi FELDMAN, Sde Zvi (IL); Robert Eric LEVITZ, Beit Shemesh (IL)

(73) Assignee: HERO SCIENTIFIC LTD, Jerusalem (IL)

(21) Appl. No.: 19/012,335

(22) Filed: Jan. 7, 2025

Related U.S. Application Data
(63) Continuation of application No. PCT/IL2023/050728, filed on Jul. 12, 2023.
Application No. PCT/IL2023/050728 is a continuation-in-part of application No. PCT/IL2023/050014, filed on Jan. 5, 2023.
(60) Provisional application No. 63/388,851, filed on Jul. 13, 2022.
(60) Provisional application No. 63/432,231, filed on Dec. 13, 2022.

(51) Int. Cl. B01L 3/00; G01N 1/40

(52) U.S. Cl. CPC B01L 3/502; G01N 1/4077; B01L 2300/0681; B01L 2400/0478; G01N 2001/4088

(57) ABSTRACT

A filtration assembly is provided that includes a tubular container shaped so as to define a proximal container opening for receiving a liquid specimen sample. A plunger includes a plunger head and a plunger rod, and is insertable into the tubular container via the proximal container opening. A filter support is shaped so as to define a support surface on which a filter is removably disposed, and a plurality of filtrate-passage openings through the filter support into a waste liquid receptacle. The filtration assembly is configured such that provision of gas from a source of gas, when the liquid specimen sample is contained in the tubular container and the filter is disposed on the support surface, pushes at least a portion of the liquid specimen sample through the filter and the filtrate-passage openings and into the waste liquid receptacle. Other embodiments are also described.

### CROSS-REFERENCE TO RELATED APPLICATIONS

The present application is a continuation of International Application PCT/IL2023/050728, filed Jul. 12, 2023, which published as PCT Publication WO 2024/013747 A2 to Feldman et al., and which:
(a) claims priority from and is a continuation-in-part (CIP) of International Application PCT/IL2023/050014, filed Jan. 5, 2023, which published as PCT Publication WO 2023/131948 to Levitz et al.; and
(b) claims the benefit of U.S. Provisional Application 63/388,851, filed Jul. 13, 2022, and U.S. Provisional Application 63/432,231, filed Dec. 13, 2022.

All of the above-referenced applications are assigned to the assignee of the present application and incorporated herein by reference.

### FIELD OF THE APPLICATION

Applications of the present invention relate to sampling biological liquids.

### BACKGROUND OF THE APPLICATION

Many techniques exist for testing for the presence of bacteria and viruses for aiding in disease diagnosis. For example, testing for the influenza virus includes molecular-based detection methods, viral culture methods, and immunoassay methods. Influenza virus testing includes the testing of nasal swabs, nasopharyngeal swabs, nasal aspirates, nasopharyngeal aspirates, nasal washes, nasopharyngeal washes, throat swabs, and a combination of samples.

PCT Publication WO 2018/158768 to Fruchter et al. describes inter alia a method for testing for presence of a particulate selected from the group consisting of: a microorganism, a fungus, a bacteria, a spore, a virus, a mite, a biological cell, a biological antigen, a protein, a protein antigen, and a carbohydrate antigen. The method includes (a) collecting, in a tube, fluid that potentially contains the particulate, (b) using a plunger to push the fluid through a filter removably disposed at a distal portion of the tube or at a distal end of the plunger, and subsequently, (c) while the filter is inside the tube, ascertaining if any of the particulate was trapped by the filter by applying a particulate-presence-testing-facilitation solution to the filter.

PCT Publication WO 2020/049569 to Fruchter et al. describes inter alia a testing device for testing for the presence of particulate in a liquid. The testing device includes a liquid container for containing the liquid; a filter, disposed in or downstream of the liquid container; a liquid-pressure source, which is arranged to apply pressure to drive the liquid contained in the liquid container through the filter; and a filter chamber that is (a) disposed downstream of the liquid container, (b) shaped so as to define an inlet, and (c) in fluid communication with the filter.

PCT Publication WO 2022/149135 to Feldman et al. describes inter alia a sampling device for concentrating a liquid specimen sample, including a filtration assembly, which includes a tubular container and a plunger. The plunger includes a plunger head and a plunger rod that is shaped so as to define an internal plunger space having a plunger-space proximal opening through a proximal end of the plunger rod. The sampling device is configured such that a filter is removable from the tubular container via the plunger-space proximal opening while the plunger head is within the tubular container.

US Patent Application Publication 2011/0318814 to Kshirsagar et al. describes inter alia a method for isolating microorganisms from a sample, the sample including sample matrix and microorganisms, the method including the steps of providing a receptacle, the receptacle configured to allow filtering of the sample and to reversibly contain the sample and a concentration agent; adding the sample to the receptacle, wherein a microorganism-bound composition will be formed in the receptacle, the microorganism-bound composition including concentration agent-bound microorganisms and sample matrix; and filtering the microorganism-bound composition through a filter to collect the concentration agent-bound microorganisms on the filter. The filter has an average pore size that is greater than the average size of the microorganisms. Kits and systems are also described.

U.S. Pat. No. 5,077,012 to Guirguis describes an apparatus for collecting biological fluids and holding samples taken from a biological fluid for qualitative and quantitative testing. The apparatus comprises a tubular container open at both ends with a quantitative test storage unit removably secured to one of said tubular container ends. The quantitative test storage unit has an open end, a cytology membrane mounted in the storage unit and a retaining rib. A shuttle assembly is slidably mounted in the tubular container comprising a cylindrical hollow piston defining a chamber, a thumb cover covering one end of the piston and a fluid flow aperture formed in the piston and a qualitative sample container assembly removable secured to the piston. The qualitative sample container assembly comprises a clip on membrane assembly including a membrane containing immobilized antibodies and a filter housing mounted to the clip on membrane assembly. The filter housing is adapted to be seated in the quantitative test storage unit after being slidably transported along the tubular container by the piston.

U.S. Pat. No. 8,322,539 to Ellis et al. describes a filter vial for separating biological and chemical fluids having a cylindrical sidewall with an open top and a closed bottom. A protrusion extends upwards from the middle of the bottom to form an annular recess. A tubular plunger has an open bottom end to which is fastened an annular cup having an outer sidewall sized to fit into and seal against the vial's sidewall. An inner sidewall of the annular cup holds a filter over an opening in the bottom of the plunger and forms a shaped cavity leading to that filter. The annular cup on the plunger fits into the annular recess in the vial to force fluid from the vial through the filter and into the plunger.

US Patent Application Publication 2015/0076069 to Ellis et al. describes a filter vial and piston where the vial has a cylindrical wall with a closed bottom and open top and with the hollow, tubular piston therein. The piston has a position stop located and configured to abut a mating position stop on the vial to limit relative movement of the piston and vial. The position stops are located to stop the distal end of the piston away from the bottom of the vial a distance of about 10-30% the height of the vial. That a material to be dissolved in a liquid in the vial and to remove unwanted molecules from the liquid with the piston forcing the liquid through the filter but not squeezing the slurry of material so as to force it into the filter.

### SUMMARY OF THE APPLICATION

Some applications of the present invention provide sampling devices for concentrating a liquid specimen sample. Some of the sampling devices comprise a filtration assembly, which comprises a tubular container for receiving the liquid specimen sample, a plunger, and a filter disposed in the tubular container. The filtration assembly is configured such that movement of a plunger head within the tubular container, when the liquid specimen sample is contained in the tubular container and the filter is disposed in the tubular container, pushes at least a portion of the liquid specimen sample through the filter.

In some configurations, the sampling devices comprise a mechanical energy storage element. The filtration assembly is configured such that movement of the plunger head within the tubular container, when the liquid specimen sample is contained in the tubular container and the filter is disposed on the support surface additionally stores mechanical energy in the mechanical energy storage element. In some of these configurations, the filtration assembly is configured to push an additional portion of the liquid specimen sample through the filter upon release of at least a portion of the mechanical energy stored in the mechanical energy storage element. For example, the filtration assembly may be configured such that the release of the at least a portion of the mechanical energy proximally moves the tubular container with respect to the plunger head, thereby pushing the additional portion of the liquid specimen sample through the filter.

In other configurations, the sampling devices comprise a pre-loaded energy storage element. The filtration assembly is configured such that release of energy from the pre-loaded energy storage element, when the liquid specimen sample is contained in the tubular container and the filter is disposed on the support surface, pushes at least a portion of the liquid specimen sample through the filter and the filtrate-passage openings and into the waste liquid receptacle. For some applications, the pre-loaded energy storage element comprises a source of gas. In some of these configurations, the source of gas comprises a substance that releases gas when combined with a liquid, while in others of these applications, the source of gas comprises a compressed gas container.

There is therefore provided, in accordance with an application of the present invention, a sampling device for concentrating a liquid specimen sample, the sampling device including a filtration assembly, which includes:
a tubular container, which is shaped so as to define an inner wall and a proximal container opening for receiving the liquid specimen sample;
a plunger, which (i) includes a plunger head and a plunger rod, which has a distal end portion to which the plunger head is coupled, and (ii) is insertable into the tubular container via the proximal container opening, such that a lateral surface of the plunger head forms a fluid-tight movable seal with the inner wall of the tubular container;
a waste liquid receptacle;
a filter;
a filter support, which is shaped so as to define (a) a support surface on which the filter is removably disposed, and (b) a plurality of filtrate-passage openings through the filter support into the waste liquid receptacle; and
a pre-loaded energy storage element,
wherein the filtration assembly is configured such that release of energy from the pre-loaded energy storage element, when the liquid specimen sample is contained in the tubular container and the filter is disposed on the support surface, pushes at least a portion of the liquid specimen sample through the filter and the filtrate-passage openings and into the waste liquid receptacle.

For some applications, the pre-loaded energy storage element includes a source of gas.

For some applications, the source of gas includes one or more substances that generate gas.

For some applications, the source of gas includes a compressed gas container.

For some applications, the filtration assembly is configured such that movement of the plunger head within the tubular container causes the source of gas to provide gas by releasing or generating the gas.

For some applications:
the movement is non-rotational movement,
the sampling device further includes a container housing, and
the filtration assembly further includes a plunger support, which is (a) coupled to a proximal portion of the plunger and (b) hingedly attached to the container housing.

For some applications:
the plunger rod is shaped so as to define the waste liquid receptacle within the plunger rod, and
the plunger head includes the filter support.

For some applications:
the sampling device further includes a container housing,
the tubular container is disposed at least partially within the container housing, such that the tubular container is moveable with respect to the container housing, and
the filtration assembly is configured such that the release of energy from the pre-loaded energy storage element proximally moves the tubular container with respect to the plunger head, thereby pushing the at least a portion of the liquid specimen sample through the filter and the filtrate-passage openings and into the waste liquid receptacle.

For some applications:
the pre-loaded energy storage element includes a source of gas, which is configured to provide gas into a space by releasing or generating the gas, the space defined between (a) a proximally-facing internal surface of the container housing and (b) an external surface of the tubular container that is defined by a distal end of the tubular container, and
the filtration assembly is configured such that providing the gas into the space increases pressure in the space, thereby proximally moving the tubular container with respect to the plunger head.

For some applications, a distal bottom surface of the tubular container includes the filter support.

For some applications:
the filtration assembly further includes:
   a housing, which includes the tubular container; and
   a plunger support, which is couplable to the housing, and which includes a plunger tube, in which the plunger rod is at least partially disposed so as to be axially moveable with respect to the plunger tube, and
the filtration assembly is configured such that the release of energy from the pre-loaded energy storage element distally moves the plunger rod with respect to the plunger tube, thereby pushing the at least a portion of the liquid specimen sample through the filter and the filtrate-passage openings and into the waste liquid receptacle.

For some applications:
the pre-loaded energy storage element includes a source of gas, which is configured to provide gas into a space by releasing or generating the gas, the space defined between (a) a proximal surface of the plunger rod and (b) a distally-facing internal surface of the plunger support, and
the filtration assembly is configured such that providing the gas into the space increases pressure in the space, thereby distally moving the plunger rod with respect to the plunger tube.

For some applications:
the pre-loaded energy storage element includes a source of gas, and
the filtration assembly is configured such that coupling of the plunger support to the housing causes proximal movement of the plunger rod within the plunger support, which causes the source of gas to provide gas by releasing or generating the gas.

For some applications:
the pre-loaded energy storage element includes a source of gas, which is configured to provide gas into a space by releasing or generating the gas, the space defined within the filtration assembly,
the filtration assembly is shaped so as to define an energy-storage element chamber, which is in fluid communication with the space only by one or more narrow openings having a total area of 75-8,000 square microns, and
the pre-loaded energy storage element is disposed in the energy-storage element chamber.

There is further provided, in accordance with an application of the present invention, a method for concentrating a liquid specimen sample, the method including:
placing, via a proximal container opening, the liquid specimen sample in a tubular container of a filtration assembly of a sampling device;
inserting a plunger head of a plunger of the filtration assembly into the tubular container via a proximal container opening of the tubular container, such that a lateral surface of the plunger head forms a fluid-tight movable seal with an inner wall of the tubular container, wherein the plunger further includes a plunger rod, which has a distal end portion to which the plunger head is coupled; and
causing a pre-loaded energy storage element of the filtration assembly to release energy so as to push at least a portion of the liquid specimen sample through a filter removably disposed in the tubular container on a support surface of a filter support, wherein the filter support is shaped so as to define a plurality of filtrate-passage openings through the filter support into a waste liquid receptacle of the filtration assembly.

For some applications, the pre-loaded energy storage element includes a source of gas.

For some applications, the source of gas includes one or more substances that generate gas.

For some applications, the source of gas includes a compressed gas container.

For some applications, causing the pre-loaded energy storage element to release the energy includes moving the plunger head within the tubular container to cause the source of gas to provide gas by releasing or generating the gas.

For some applications:
the sampling device further includes a container housing,
the filtration assembly further includes a plunger support, which is (a) coupled to a proximal portion of the plunger and (b) hingedly attached to the container housing, and
moving the plunger head within the tubular container includes non-rotationally moving the plunger head within the tubular container.

For some applications:
the plunger rod is shaped so as to define the waste liquid receptacle within the plunger rod, and
the plunger head includes the filter support.

For some applications:
the sampling device further includes a container housing,
the tubular container is disposed at least partially within the container housing, such that the tubular container is moveable with respect to the container housing, and
causing the pre-loaded energy storage element to release the energy proximally moves the tubular container with respect to the plunger head, thereby pushing the at least a portion of the liquid specimen sample through the filter and the filtrate-passage openings and into the waste liquid receptacle.

For some applications:
the pre-loaded energy storage element includes a source of gas, and
causing the pre-loaded energy storage element to release the energy includes causing the source of gas to provide gas into a space by releasing or generating the gas, the space defined between (a) a proximally-facing internal surface of the container housing and (b) an external surface of the tubular container that is defined by a distal end of the tubular container, so as to increases pressure in the space, thereby proximally moving the tubular container with respect to the plunger head.

For some applications, a distal bottom surface of the tubular container includes the filter support.

For some applications:
the filtration assembly further includes:
   a housing, which includes the tubular container; and
   a plunger support, which is couplable to the housing, and which includes a plunger tube, in which the plunger rod is at least partially disposed so as to be axially moveable with respect to the plunger tube, and
causing the pre-loaded energy storage element to release the energy distally moves the plunger rod with respect to the plunger tube, thereby pushing the at least a portion of the liquid specimen sample through the filter and the filtrate-passage openings and into the waste liquid receptacle.

For some applications:
the pre-loaded energy storage element includes a source of gas, which is configured to provide gas into a space by releasing or generating the gas, the space defined between (a) a proximal surface of the plunger rod and (b) a distally-facing internal surface of the plunger support, and
causing the pre-loaded energy storage element to release the energy includes causing the source of gas to provide the gas into the space so as to increase pressure in the space, thereby distally moving the plunger rod with respect to the plunger tube.

For some applications:
the pre-loaded energy storage element includes a source of gas, and
causing the pre-loaded energy storage element to release the energy includes coupling of the plunger support to the housing to cause proximal movement of the plunger rod within the plunger support, which causes the source of gas to provide gas by releasing or generating the gas.

For some applications:
the pre-loaded energy storage element includes a source of gas, which is configured to provide gas into a space by releasing or generating the gas, the space defined within the filtration assembly,
the filtration assembly is shaped so as to define an energy-storage element chamber, which is in fluid communication with the space only by one or more narrow openings having a total area of 75-8,000 square microns, and
the pre-loaded energy storage element is disposed in the energy-storage element chamber.

For some applications, the method further includes, after the filter has been removed from the tubular container, detecting the presence of a biological particulate trapped by the filter.

For some applications, detecting the presence of the biological particulate trapped by the filter including using a lateral flow test strip to detect the presence of the biological particulate trapped by the filter.

For some applications, the biological particulate is selected from the group consisting of: a virus, a bacterium, a microorganism, a fungus, a spore, a mite, a biological cell, a biological antigen, a protein, a protein antigen, and a carbohydrate antigen.

For some applications, the liquid specimen sample includes gargled fluid.

There is still further provided, in accordance with an application of the present invention, a sampling device for concentrating a liquid specimen sample, the sampling device including a filtration assembly, which includes:
a tubular container, which is shaped so as to define an inner wall and a proximal container opening for receiving the liquid specimen sample;
a plunger, which (i) includes a plunger head and a plunger rod, which (a) has a distal end portion to which the plunger head is coupled, and (b) is shaped so as to define a waste liquid receptacle within the plunger rod, and (ii) is insertable into the tubular container via the proximal container opening, such that a lateral surface of the plunger head forms a fluid-tight movable seal with the inner wall;
a filter; and
a mechanical energy storage element,
wherein the plunger head includes a filter support, which is shaped so as to define (a) a support surface on which the filter is removably disposed, and (b) a plurality of filtrate-passage openings through the filter support into the waste liquid receptacle, and
wherein the filtration assembly is configured such that movement of the plunger head within the tubular container, when the liquid specimen sample is contained in the tubular container and the filter is disposed on the support surface:
   pushes at least a portion of the liquid specimen sample through the filter and the filtrate-passage openings and into the waste liquid receptacle, and
   stores mechanical energy in the mechanical energy storage element.

For some applications:
the sampling device further includes a container housing,
the tubular container is disposed at least partially within the container housing, such that the tubular container is moveable with respect to the container housing, and
the mechanical energy storage element is disposed within the container housing, outside the tubular container and in direct or indirect contact with an external surface of the tubular container, such that movement of the plunger head within the tubular container moves the tubular container with respect to the container housing, thereby storing the mechanical energy in the mechanical energy storage element.

For some applications, the filtration assembly is configured to push an additional portion of the liquid specimen sample through the filter upon release of at least a portion of the mechanical energy stored in the mechanical energy storage element.

For some applications, the filtration assembly is configured such that the release of the at least a portion of the mechanical energy proximally moves the tubular container with respect to the plunger head, thereby pushing the additional portion of the liquid specimen sample through the filter.

For some applications:
an outer wall of the container housing is shaped so as to define an optical window,
the filtration assembly further includes a visual indicator, and
the filtration assembly is configured such that the visual indicator is:
   not visible through the optical window when the tubular container is at a plurality of first distal axial locations within the filtration assembly, at which location the visual indicator is not axially aligned with the optical window, and
   visible through the optical window when the tubular container is at a second proximal axial location within the filtration assembly, at which location the visual indicator is axially aligned with the optical window.

For some applications, the mechanical energy storage element includes an elastic element configured to store the mechanical energy.

For some applications, the elastic element includes a spring.

For some applications, the spring is partially pre-loaded with mechanical energy in a pre-insertion state of the sampling device in which the plunger head is not within the tubular container.

For some applications:
the sampling device further includes a container housing,
the tubular container is disposed at least partially within the container housing, such that the tubular container is moveable with respect to the container housing,
the mechanical energy storage element is disposed within the container housing, outside the tubular container and in direct or indirect contact with an external surface of the tubular container defined by a distal end of the tubular container, such that movement of the plunger head within the tubular container moves the tubular container with respect to the container housing, thereby storing the mechanical energy in the mechanical energy storage element, and
the spring is disposed between the external surface of the tubular container and a proximally-facing internal surface of the container housing.

For some applications, the spring is disposed encircling at least a longitudinal portion of the tubular container.

For some applications, the spring is disposed alongside at least a longitudinal portion of the tubular container.

For some applications, the mechanical energy storage element includes a plurality of springs disposed alongside the at least a longitudinal portion of the tubular container.

For some applications, the mechanical energy storage element is disposed within the tubular container.

For some applications, the mechanical energy storage element includes a flexible container containing a gas.

There is additionally provided, in accordance with an application of the present invention, a method for concentrating a liquid specimen sample, the method including:
placing the liquid specimen sample in a tubular container of a filtration assembly of a sampling device;
inserting a plunger head of a plunger of the filtration assembly into the tubular container via a proximal container opening of the tubular container, such that a lateral surface of the plunger head forms a fluid-tight movable seal with an inner wall of the tubular container, wherein the plunger further includes a plunger rod, which (a) has a distal end portion to which the plunger head is coupled, and (b) is shaped so as to define a waste liquid receptacle within the plunger rod; and
distally advancing the plunger head within the tubular container so as to:
   drive at least a portion of the liquid specimen sample through a filter removably disposed in the tubular container on a support surface of a filter support, wherein the filter support is shaped so as to define a plurality of filtrate-passage openings through the filter support into the waste liquid receptacle, and
   store mechanical energy in a mechanical energy storage element of the filtration assembly.

For some applications:
the sampling device further includes a container housing,
the tubular container is disposed at least partially within the container housing, such that the tubular container is moveable with respect to the container housing,
the energy storage element is disposed within the container housing, outside the tubular container and in direct or indirect contact with an external surface of the tubular container, and
distally advancing the plunger head within the tubular container includes distally advancing the plunger head within the tubular container so as to move the tubular container with respect to the container housing, thereby storing energy in the energy storage element.

For some applications, the filtration assembly is configured to push an additional portion of the liquid specimen sample through the filter upon release of at least a portion of the mechanical energy stored in the mechanical energy storage element.

For some applications, the filtration assembly is configured such that the release of the at least a portion of the mechanical energy proximally moves the tubular container with respect to the plunger head, thereby pushing the additional portion of the liquid specimen sample through the filter.

For some applications:
an outer wall of the container housing is shaped so as to define an optical window,
the filtration assembly further includes a visual indicator, and
the filtration assembly is configured such that the visual indicator is:
   not visible through the optical window when the tubular container is at a plurality of first distal axial locations within the filtration assembly, at which location the visual indicator is not axially aligned with the optical window, and
   visible through the optical window when the tubular container is at a second proximal axial location within the filtration assembly, at which location the visual indicator is axially aligned with the optical window.

For some applications, the mechanical energy storage element includes an elastic element configured to store the mechanical energy.

For some applications, the elastic element includes a spring.

For some applications, the spring is partially pre-loaded with energy in a pre-insertion state of the sampling device in which the plunger head is not within the tubular container.

For some applications:
the tubular container is disposed at least partially within the container housing, such that the tubular container is moveable with respect to the container housing,
the mechanical energy storage element is disposed within the container housing, outside the tubular container and in direct or indirect contact with an external surface of the tubular container defined by a distal end of the tubular container, such that movement of the plunger head within the tubular container moves the tubular container with respect to the container housing, thereby storing the mechanical energy in the mechanical energy storage element, and
the spring is disposed between the external surface of the tubular container and a proximally-facing internal surface of the container housing.

For some applications, the spring is disposed encircling at least a longitudinal portion of the tubular container.

For some applications, the spring is disposed alongside at least a longitudinal portion of the tubular container.

For some applications, the mechanical energy storage element includes a plurality of springs disposed alongside the at least a longitudinal portion of the tubular container.

For some applications, the energy storage element is disposed within the tubular container.

For some applications, the energy storage element includes a flexible container containing a gas.

For some applications, the method further includes, after the filter has been removed from the tubular container, detecting the presence of a biological particulate trapped by the filter.

For some applications, detecting the presence of the biological particulate trapped by the filter including using a lateral flow test strip to detect the presence of the biological particulate trapped by the filter.

For some applications, the biological particulate is selected from the group consisting of: a virus, a bacterium, a microorganism, a fungus, a spore, a mite, a biological cell, a biological antigen, a protein, a protein antigen, and a carbohydrate antigen.

For some applications, the liquid specimen sample includes gargled fluid.

There is yet additionally provided, in accordance with an application of the present invention, a container assembly including:
(a) an extraction tube, which is shaped so as to define:
   an internally-wider proximal portion, shaped so as to define a proximal opening of the extraction tube, and
   an internally-narrower distal portion, shaped so as to define a closed distal end of the extraction tube;
(b) an elongate sealing insert, which is removably coupled to the extraction tube, and which includes:
   a shaft including a distal shaft portion, the distal shaft portion narrower than, and removably disposed at least partially within, the internally-narrower distal portion of the extraction tube;
   one or more distal plugs located along the distal shaft portion or at a distal end of the distal shaft portion, and removably disposed within the internally-narrower distal portion of the extraction tube; and
   one or more proximal plugs located along the shaft proximal to the one or more distal plugs;
(c) a first substance, contained within the internally-narrower distal portion of the extraction tube distal to the one or more distal plugs, such that the one or more distal plugs seal the first substance within the internally-narrower distal portion of the extraction tube; and
(d) a second substance, separate and distinct from the first substance, contained within the extraction tube distal to the one or more proximal plugs and proximal to the one or more distal plugs, such that:
   the one or more proximal plugs seal the second substance within the extraction tube, and
   the one or more distal plugs sealingly isolate the second substance from the first substance,
the container assembly is configured such that proximal withdrawal of the one or more distal plugs from within the internally-narrower distal portion to the internally-wider proximal portion, by proximal withdrawal of the shaft, brings the second substance into fluid communication with the first substance.

For some applications, both the first and the second substances include liquids.

For some applications, one of the first and the second substances includes a liquid and the other of the first and the second substances includes a solid.

For some applications, the one or more proximal plugs include a proximal plug located along the distal shaft portion, and removably disposed within the internally-narrower distal portion of the extraction tube.

For some applications, the one or more proximal plugs include a proximal plug removably plugging the proximal opening of the extraction tube.

For some applications, the one or more proximal plugs include:
a first proximal plug located along the distal shaft portion, and removably disposed within the internally-narrower distal portion of the extraction tube, and
a second proximal plug removably plugging the proximal opening of the extraction tube.

For some applications:
the container assembly further includes a third substance, contained within the extraction tube proximal to the first proximal plug and distal to the second proximal plug, such that:
   the second proximal plug seals the third substance within the extraction tube, and
   the first proximal plug sealingly isolates the third substance from the second substance, and
the container assembly is configured that:
   proximal withdrawal of the first proximal plug from within the internally-narrower distal portion to the internally-wider proximal portion, by proximal withdrawal of the shaft, brings the third substance into fluid communication with the second substance, and
   proximal withdrawal of the one or more distal plugs from within the internally-narrower distal portion to the internally-wider proximal portion, by further proximal withdrawal of the shaft, brings the second and the third substances and into fluid communication with the first substance.

For some applications, the kit further including a filter assembly including:
a filter;
a vial; and
a filter shaft, which includes:
   a proximal portion that is slidably disposed passing through a shaft-passage hole through an end of the vial opposite a vial opening; and
   a distal portion that is coupled to the filter,
the kit is configured such that the vial is insertable at least partially into the extraction tube, and distally advanceable within the extraction tube until the filter is positioned near the closed distal end of the extraction tube, and
the extraction tube is shaped so as to prevent the vial from reaching the closed distal end of the extraction tube, such that the vial slides up a portion of the filter-withdrawal shaft as the filter is positioned near the closed distal end, thereby ejecting the filter from the vial opening and exposing the filter to the first and the second substances in the internally-narrower distal portion of the extraction tube.

There is also provided, in accordance with an application of the present invention, a method including:
orienting a container assembly such that a proximal opening of an extraction tube of the container assembly is above a closed distal end of the extraction tube with respect to the Earth,
   wherein the extraction tube is shaped so as to define:
      an internally-wider proximal portion, shaped so as to define the proximal opening of the extraction tube, and
      an internally-narrower distal portion, shaped so as to define a closed distal end of the extraction tube;
   wherein the container assembly further includes an elongate sealing insert, which is removably coupled to the extraction tube, and which includes:
      a shaft including a distal shaft portion, the distal shaft portion narrower than, and removably disposed at least partially within, the internally-narrower distal portion of the extraction tube;
      one or more distal plugs located along or at a distal end of the distal shaft portion, and removably disposed within the internally-narrower distal portion of the extraction tube; and
      one or more proximal plugs located along the shaft proximal to the one or more distal plugs;
   wherein the container assembly further includes:
      a first substance, contained within the internally-narrower distal portion of the extraction tube distal to the one or more distal plugs, such that the one or more distal plugs seal the first substance within the internally-narrower distal portion of the extraction tube; and
      a second substance, separate and distinct from the first substance, contained within the extraction tube distal to the one or more proximal plugs and proximal to the one or more distal plugs, such that (a) the one or more proximal plugs seal the second substance within the extraction tube, and (b) the one or more distal plugs sealingly isolate the second substance from the first substance; and
proximally withdrawing the one or more distal plugs from within the internally-narrower distal portion to the internally-wider proximal portion, by proximally withdrawing the shaft, so as to bring the second substance into fluid communication with the first substance.

For some applications, both the first and the second substances include liquids.

For some applications, one of the first and the second substances includes a liquid and the other of the first and the second substances includes a solid.

For some applications, the one or more proximal plugs include a proximal plug located along the distal shaft portion, and removably disposed within the internally-narrower distal portion of the extraction tube.

For some applications, the one or more proximal plugs include a proximal plug removably plugging the proximal opening of the extraction tube.

For some applications, the one or more proximal plugs include:
a first proximal plug located along the distal shaft portion, and removably disposed within the internally-narrower distal portion of the extraction tube, and
a second proximal plug removably plugging the proximal opening of the extraction tube.

For some applications:
the container assembly further includes a third substance, contained within the extraction tube proximal to the first proximal plug and distal to the second proximal plug, such that:
   the second proximal plug seals the third substance within the extraction tube, and
   the first proximal plug sealingly isolates the third substance from the second substance, and
the method further includes, before proximally withdrawing the one or more distal plugs from within the internally-narrower distal portion to the internally-wider proximal portion:
   proximally withdrawing the first proximal plug from within the internally-narrower distal portion to the internally-wider proximal portion, by proximally withdrawing the shaft, so as to bring the third substance into fluid communication with the second substance, and
proximally withdrawing the one or more distal plugs includes proximally withdrawing the one or more distal plugs from within the internally-narrower distal portion to the internally-wider proximal portion, by further proximally withdrawing the shaft, so as to bring the second and the third substances and into fluid communication with the first substance.

For some applications, the method further includes, after proximally withdrawing the one or more distal plugs from within the internally-narrower distal portion to the internally-wider proximal portion:
inserting a vial of a filter assembly at least partially into the extraction tube, and distally advancing the vial within the extraction tube until a filter of the filter assembly is positioned near the closed distal end of the extraction tube, wherein the filter assembly further includes a filter shaft, which includes (a) a proximal portion that is slidably disposed passing through a shaft-passage hole through an end of the vial opposite a vial opening; and (b) a distal portion that is coupled to the filter,
the extraction tube is shaped so as to prevent the vial from reaching the closed distal end of the extraction tube, such that the vial slides up a portion of the filter-withdrawal shaft as the filter is positioned near the closed distal end, thereby ejecting the filter from the vial opening and exposing the filter to the first and the second substances in the internally-narrower distal portion of the extraction tube.

The present invention will be more fully understood from the following detailed description of embodiments thereof, taken together with the drawings, in which:

### BRIEF DESCRIPTION OF THE DRAWINGS

FIGS. 1A-B are schematic illustrations of a sampling device for concentrating a liquid specimen sample, and a portion of the sampling device, respectively, in accordance with an application of the present invention;

FIGS. 2A-D are schematic illustrations of the sampling device of FIGS. 1A-B and a method of using the sampling device, in accordance with respective applications of the present invention;

FIGS. 3A-I are schematic cross-sectional illustrations of the sampling device of FIGS. 1A-B and the method of using the sampling device, in accordance with respective applications of the present invention;

FIGS. 3J-K are schematic illustrations of another method of using the sampling device of FIGS. 1A-B, in accordance with an application of the present invention;

FIG. 4 is an enlarged schematic illustration of a portion of the sampling device of FIGS. 1A-B, in accordance with an application of the present invention;

FIGS. 5A-B are schematic illustrations of another sampling device for concentrating a liquid specimen sample, and a portion of the sampling device, respectively, in accordance with an application of the present invention;

FIGS. 6A-E are schematic illustrations of the sampling device of FIGS. 5A-B and a method of using the sampling device, in accordance with respective applications of the present invention;

FIGS. 7A-E are schematic cross-sectional illustrations of the sampling device of FIGS. 5A-B and the method of using the sampling device, in accordance with respective applications of the present invention;

FIGS. 8A-B are schematic illustrations of still another sampling device for concentrating a liquid specimen sample, and a portion of the sampling device, respectively, in accordance with an application of the present invention;

FIGS. 9A-E are schematic illustrations of the sampling device of FIGS. 8A-B and a method of using the sampling device, in accordance with respective applications of the present invention;

FIGS. 10A-E are schematic cross-sectional illustrations of the sampling device of FIGS. 8A-B and the method of using the sampling device, in accordance with respective applications of the present invention;

FIGS. 11A-D are schematic illustrations of another sampling device and a method of using the sampling device, in accordance with respective applications of the present invention;

FIGS. 12A-C are schematic cross-sectional illustrations of yet another sampling device and a method of using the sampling device, in accordance with respective applications of the present invention;

FIGS. 13A-D are schematic cross-sectional illustrations of still another sampling device and a method of using the sampling device, in accordance with respective applications of the present invention;

FIGS. 14A-E are schematic cross-sectional illustrations of another sampling device and a method of using the sampling device, in accordance with respective applications of the present invention;

FIGS. 15A-B are schematic illustrations of still another sampling device and a method of using the sampling device, in accordance with respective applications of the present invention;

FIGS. 16A-D are schematic cross-sectional illustration of the sampling device of FIG. 15A-B and the method of using the sampling device, in accordance with respective applications of the present invention;

FIGS. 17A-D are schematic illustrations of yet another sampling device and a method of using the sampling device, in accordance with respective applications of the present invention;

FIGS. 18A-D are schematic cross-sectional illustration of one configuration of the sampling device of FIG. 17A-D and the method of using the sampling device, in accordance with respective applications of the present invention;

FIGS. 19A-D are schematic cross-sectional illustration of another configuration of the sampling device of FIG. 17A-D and the method of using the sampling device, in accordance with respective applications of the present invention;

FIGS. 20A-D are schematic cross-sectional illustration of yet another configuration of the sampling device of FIG. 17A-D and the method of using the sampling device, in accordance with respective applications of the present invention;

FIGS. 21A-C are schematic illustrations of still another sampling device and a method of using the sampling device, in accordance with respective applications of the present invention;

FIGS. 22A-F are schematic cross-sectional illustrations of a sampling device for concentrating a liquid specimen sample and a method of using the sampling device, in accordance with respective applications of the present invention;

FIGS. 23A-E are schematic illustrations of another sampling device and a method of using the sampling device, in accordance with respective applications of the present invention;

FIGS. 24A-E are schematic cross-sectional illustrations of the sampling device of FIGS. 23A-E and the method of using the sampling device, in accordance with respective applications of the present invention;

FIG. 25 is a schematic illustration of a kit, in accordance with an application of the present invention;

FIG. 26 is a schematic illustration of a testing kit, in accordance with an application of the present invention; and

FIGS. 27A-E are schematic cross-sectional views of a container assembly and a method of using the container assembly, in accordance with an application of the present invention.

### DETAILED DESCRIPTION OF APPLICATIONS

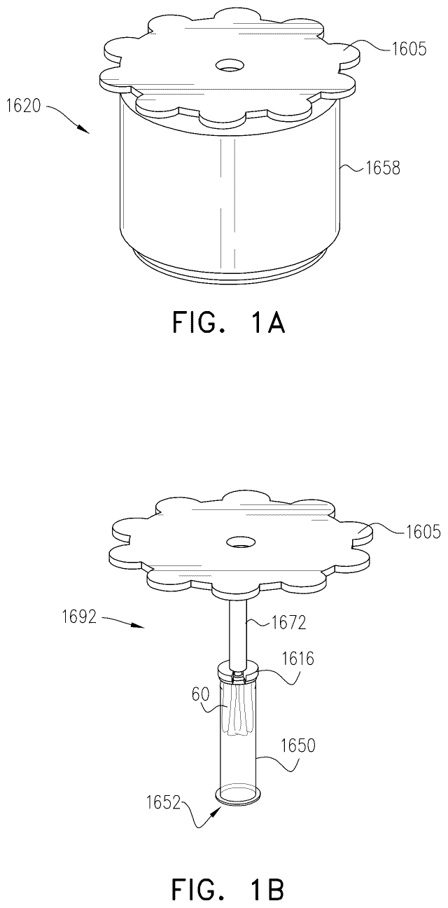

FIGS. 1A-B are schematic illustrations of a sampling device 1620 for concentrating a liquid specimen sample 22, and a portion of the sampling device, respectively, in accordance with an application of the present invention.

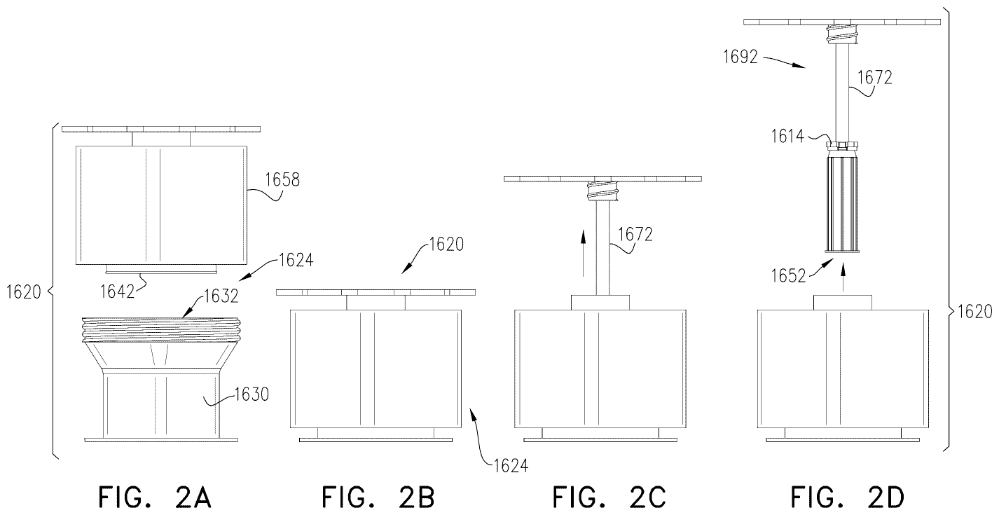

Reference is also made to FIGS. 2A-D, which are schematic illustrations of sampling device 1620 and a method of using sampling device 1620, in accordance with respective applications of the present invention.

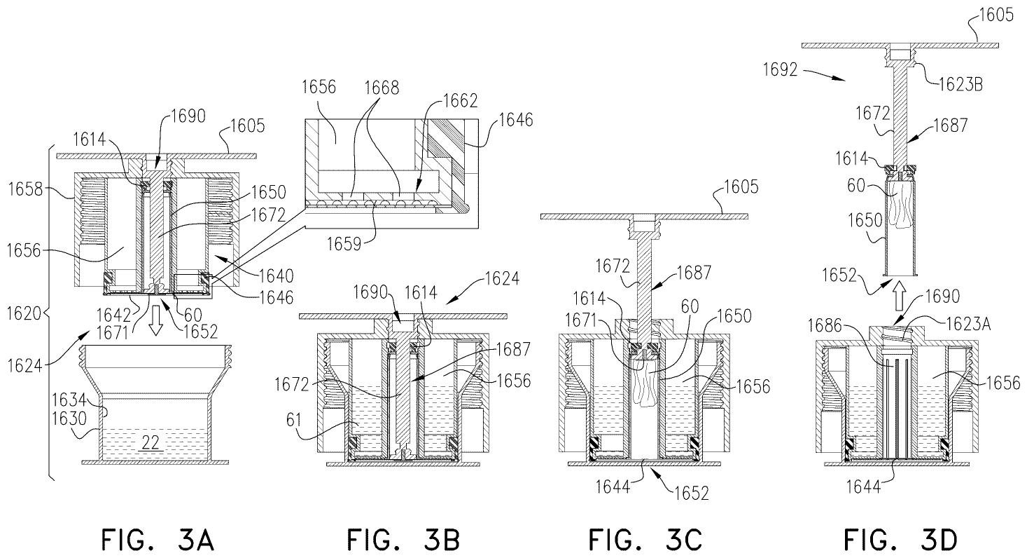

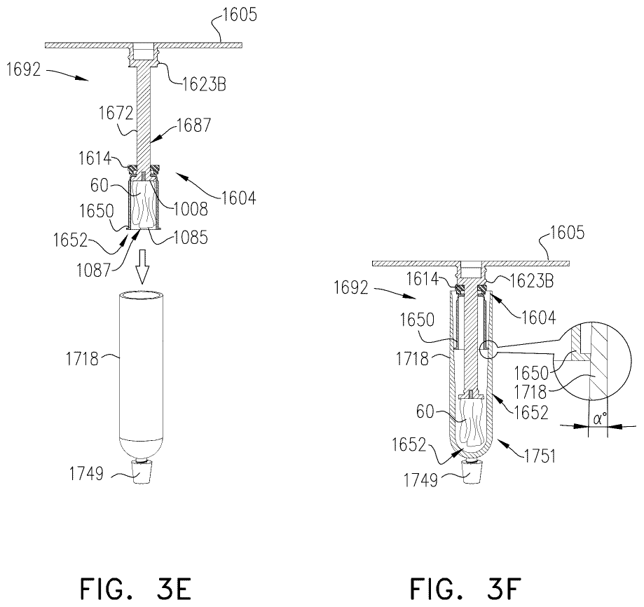

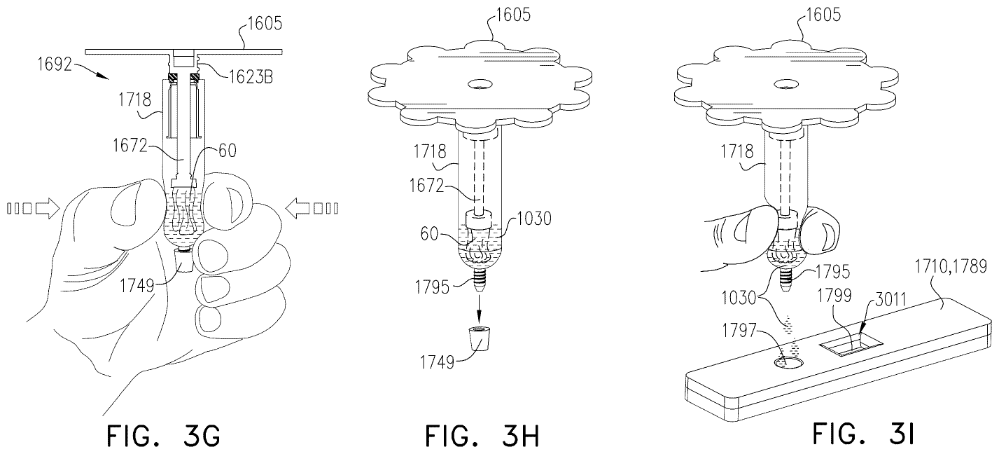

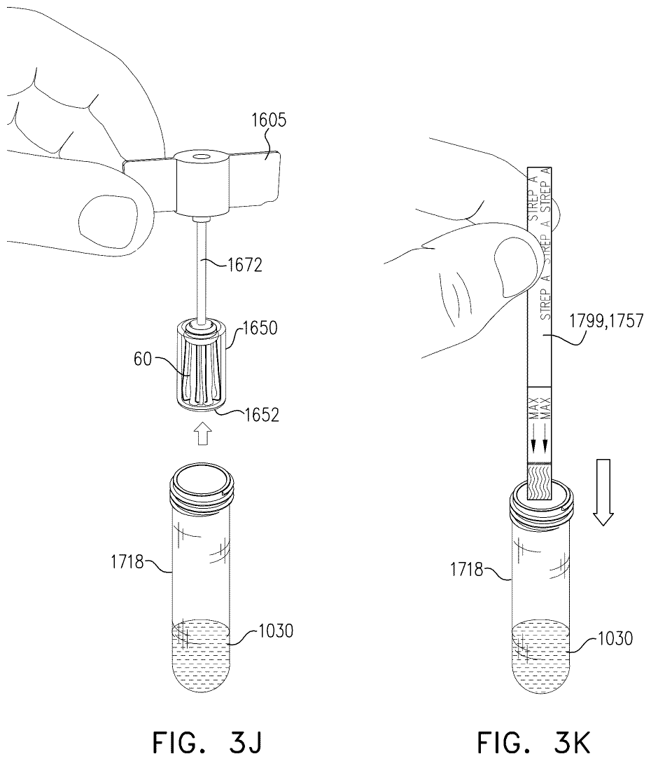

Reference is also made to FIGS. 3A-I, which are schematic cross-sectional illustrations of sampling device 1620 and a method of using sampling device 1620, in accordance with respective applications of the present invention. Reference is also made to FIGS. 3J-K, which are schematic illustrations of another method of using sampling device 1620, in accordance with an application of the present invention.

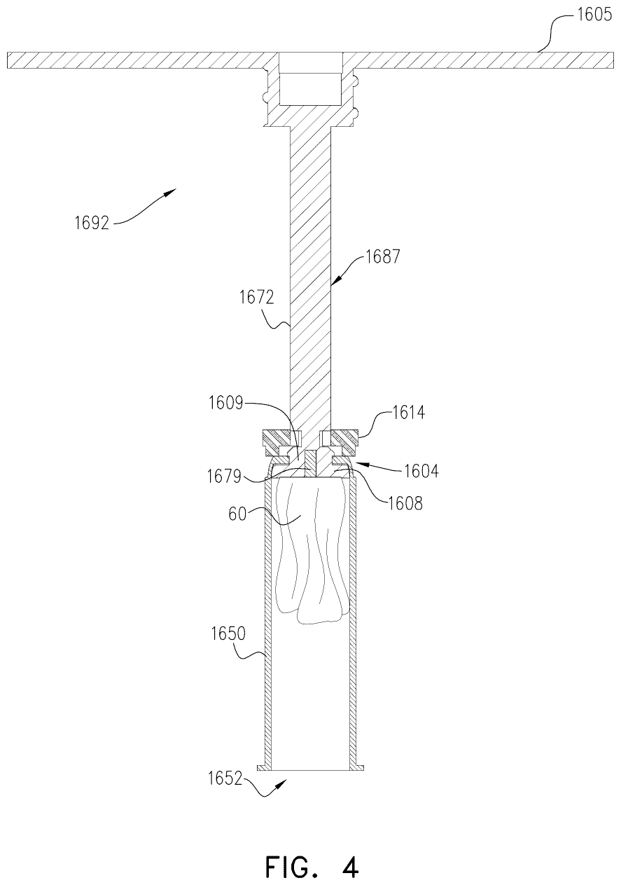

Reference is further made to FIG. 4, which is an enlarged schematic illustration of a portion of sampling device 1620 in the state shown in FIGS. 2D and 3D, in accordance with an application of the present invention.

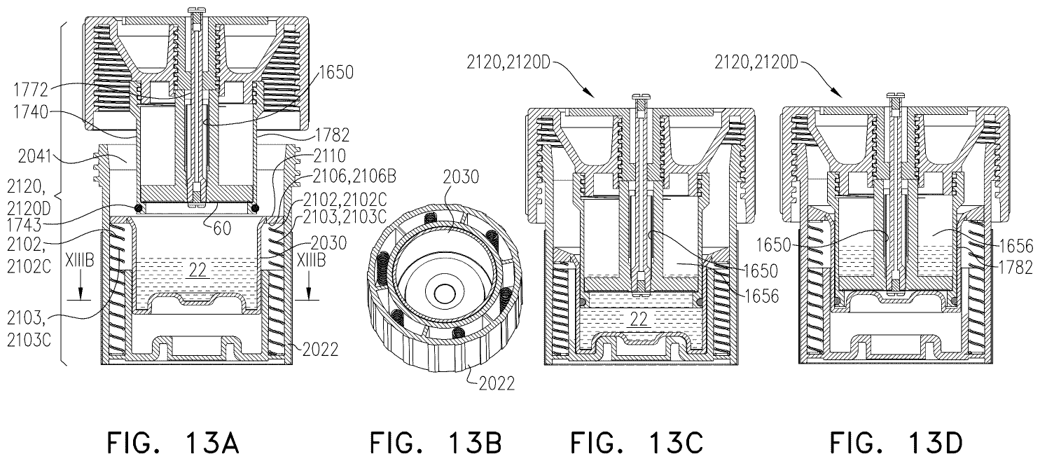

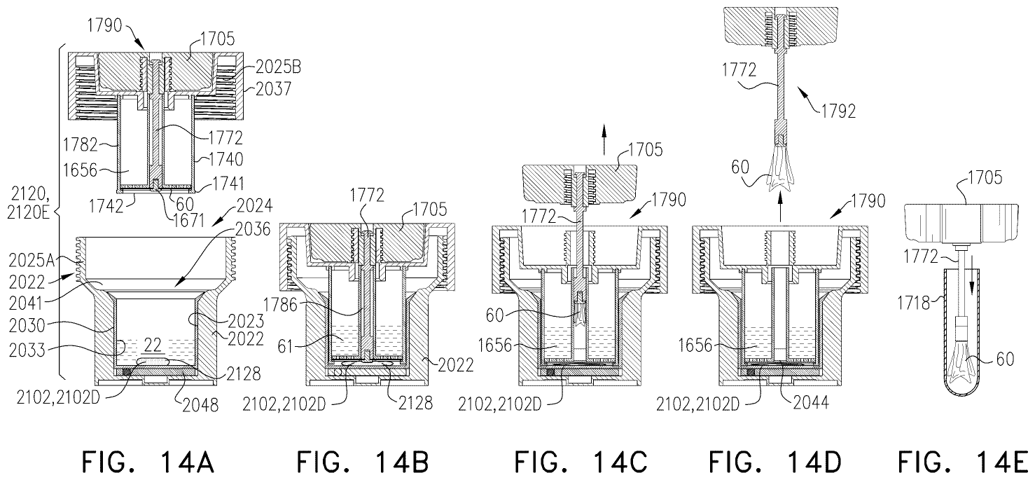

Sampling device 1620 comprises a filtration assembly 1624 and a collection vial 1650. The features of sampling device 1620, including but not limited to collection vial 1650, may be implemented in any of the other sampling devices described hereinbelow, mutatis mutandis. Similarly, sampling device 1620 may be implemented in combination with any of the features of the other sampling devices described hereinbelow, mutatis mutandis, including, by way of example and not limitation, the reversible filter-clamping techniques of sampling devices 1820 or 1920, described in International Application PCT/IL2023/050014, filed Jan. 5, 2023, which published as PCT Publication WO 2023/131948 to Levitz et al. and which is assigned to the assignee of the present application and incorporated herein by reference, with reference to FIGS. 11A-13F and FIGS. 14A-16E thereof, respectively.

Filtration assembly 1624 comprises tubular container 1630, a plunger 1640 (labeled in FIG. 3A), and a filter 60.

Tubular container 1630 is shaped so as to define a proximal container opening 1632 (labeled in FIG. 2A) for receiving liquid specimen sample 22, after or during collection of liquid specimen sample 22 from the subject. Tubular container 1630 is also shaped so as to define an inner wall 1634 (labeled in FIG. 3A). At least a portion of tubular container 1630, such as a distal portion, may define a syringe barrel.

As labeled in FIGS. 2A and 3A, plunger 1640 comprises a plunger head 1642 and a plunger rod 1682. Plunger 1640 is insertable into tubular container 1630 via proximal container opening 1632, such that a lateral surface 1646 of plunger head 1642 (labeled in FIG. 3A) forms a fluid-tight movable seal with inner wall 1634. To this end, lateral surface 1646 may comprise an elastomeric material, such as natural rubber, synthetic rubber, a thermoplastic elastomer, or a combination thereof. Optionally, filtration assembly 1624 further comprises a plunger support 1658, which is coupled to a proximal portion of plunger 1640. Plunger support 1658 may be configured to be coupled to tubular container 1630. A portion of plunger support 1658 may serve as a handle to enable easy manipulation of plunger 1640, including insertion of plunger 1640 into tubular container 1630. Optionally, a portion of plunger support 1658 surrounds plunger 1640.

For some of these applications, plunger rod 1682 is shaped so as to define an internal plunger space 1686 (labeled in FIG. 3D). For some of these applications, a proximal end of plunger rod 1682 is shaped so as to define a plunger-space proximal opening 1690 of internal plunger space 1686. Plunger head 1642 is shaped so as to define a plunger-head opening 1644 (labeled in FIG. 3C) through plunger head 1642 and into internal plunger space 1686.

Typically, collection vial 1650 is removably disposed at least partially within internal plunger space 1686.

Typically, collection vial 1650 is positioned proximal to plunger head 1642.

Reference is made to FIGS. 2A and 3A. Optionally, proximal container opening 1632 is shaped as a funnel to facilitate receipt of liquid specimen sample 22 during collection of the liquid specimen sample. For example, liquid specimen sample 22 may be expressed (e.g., spit) from subject's mouth into tubular container 1630, or transferred to tubular container 1630 from a collection container. Optionally, the funnel shape of proximal container opening 1632 is similar to funnel-shaped proximal opening 36 shown in FIG. 1 of US Patent Application Publication 2019/0381498 to Fruchter et al., which is incorporated herein by reference. Tubular container 1630 may be cylindrical, as shown, or may alternatively have another, non-circular cross-sectional shape. Alternatively or additionally, tubular container 1630 may have different cross-sectional shapes along respective different longitudinal portions of the tubular container; optionally, one or more of the cross-sectional shapes is circular.

Typically, tubular container 1630 has an internal volume of at least 0.5 ml (e.g., at least 1 ml, such as at least 5 ml), no more than 500 ml (e.g., no more than 70 ml), and/or 0.5 ml (e.g., 1 ml or 5 ml)-500 ml (e.g., 70 ml).

For some applications, tubular container 1630 does not comprise a Luer lock or any other type of needle-coupling mechanism.

As shown in FIGS. 2D, 3C, and 3D, collection vial 1650 is typically shaped so as to define a vial opening 1652.

For some applications, collection vial 1650 has a volume of at least 1 ml, no more than 50 ml, and/or 1-50 ml, such as at least 2 ml, no more than 20 ml, and/or 2-20 ml, e.g., at least 3 ml (e.g., at least 5 ml), no more than 15 ml, and/or 3 (e.g., 5)-15 ml. For some applications, collection vial 1650 has a greatest internal diameter of no more than 35 mm, e.g., no more than 20 mm, such as no more than 15 mm or no more than 10 mm.

Collection vial 1650 typically has a greatest outer diameter that is less than (e.g., less than 80%, such as less than 70%) an inner diameter of an axial portion of tubular container 1630 in which plunger head 1642 is distally advanceable.

Collection vial 1650 typically is not shaped so as to define any pressure-release openings and does not comprise any pressure-release valves.

Reference is made to FIGS. 3B-D. Typically, filtration assembly 1624 further comprises a waste liquid receptacle 1656 for receiving a filtrate 61. For some of these applications, plunger rod 1682 is shaped so as to define therewithin waste liquid receptacle 1656. Typically, waste liquid receptacle 1656 partially or entirely surrounds internal plunger space 1686, such as shown.

For some applications, plunger head 1642 is shaped so as to define a filter support 1662 (labeled in FIG. 3A), which is shaped so as to define:
a support surface 1659, which may be perpendicular to a central longitudinal axis of plunger head 1642 (as shown), or may be angled with respect to the central longitudinal axis (configuration not shown),
a plurality of filtrate-passage openings 1668 through filter support 1662 into waste liquid receptacle 1656, and
a central opening that defines plunger-head opening 1644 (labeled in FIGS. 3C and 3D).

Filter 60 is (removably) disposed on support surface 1659, typically on an upstream side of support surface 1659 (which, in the configuration of sampling device 1620, is a distal side of support surface 1659).

Reference is made to FIGS. 2A-B and 3A-B. Filtration assembly 1624 is configured such that movement (typically distal advancement) of plunger head 1642 within tubular container 1630, when liquid specimen sample 22 is contained in tubular container 1630 and filter 60 is disposed in tubular container 1630, pushes at least a portion of liquid specimen sample 22 through filter 60. Filter 60 is configured to concentrate at least a portion of liquid specimen sample 22 onto filter 60, while allowing filtrate 61 to pass through filter 60. Typically, distal advancement of plunger 1640 within tubular container 1630 applies pressure to drive (e.g., push) at least a portion of liquid specimen sample 22 contained in tubular container 1630 through filter 60, such as shown in the transitions between FIGS. 2A and 2B and between FIGS. 3A and 3B.

Filtration assembly 1624 is configured such that movement of plunger head 1642 within tubular container 1630, when liquid specimen sample 22 is contained in tubular container 1630 and filter 60 is disposed in tubular container 1630, pushes at least a portion of liquid specimen sample 22 through filter 60 and filtrate-passage openings 1668 and into waste liquid receptacle 1656.

Optionally, waste liquid receptacle 1656 is shaped so as to define an opening through an external wall of waste liquid receptacle 1656 to release displaced air. For example, the opening may be located on a proximal portion of the external wall, typically above the highest level that filtrate 61 is expected to reach during ordinary use of the device. For some applications, waste liquid receptacle 1656 comprises an air filter (e.g., an N98 filter) that is disposed to filter air that passes out of waste liquid receptacle 1656 through the opening. Alternatively or additionally, for some applications, waste liquid receptacle 1656 comprises a one-way pressure-sensitive valve disposed in the opening.

Filter 60 comprises synthetic or natural materials formed, for example, as a matrix, membrane, fabric, beads, or other configuration. For some applications, filter 60 comprises a mechanical filter, which is configured to mechanically filter particulate from liquid specimen sample 22 by size-based filtration. Optionally, filter 60 comprises a depth filter.

Alternatively or additionally, for some applications, filter 60 comprises fixed antibodies configured to capture the particulate (e.g., free viral particles) by affinity-based filtration.

For some applications, for example, when filter 60 is used for capturing free virus, virions, or viral particles by size-based filtration, filter 60 may have a pore size of 0.01-0.3 microns and/or a molecular weight cut off of 10 kDa-500 kDa. For some applications, filter 60 has a pore size of 0.2-5.0 microns, such as 0.2-2.0 microns (e.g., 0.8 to 1.5 microns, such as 1.2 microns), for example, when filter 60 is used for capturing bacteria by size-based filtration.

For some applications, filter 60 comprises a polyethersulfone (PES) membrane filter.

Alternatively or additionally, for some applications, filter 60 has a nominal pore size of 30 microns-1.5 mm, the nominal pore size representative of a minimum size of spherical particles necessary for the filter to retain 85% of the spherical particles when H2O containing the spherical particles is passed through the filter at 20 degrees C. under pressure supplied by a 10 cm water column. For these applications, filter 60 may implement techniques described in U.S. Provisional Application 63/117,294, filed Nov. 23, 2020, is assigned to the assignee of the present application and incorporated herein by reference, and/or in PCT Publication WO 2021/224925 to Levitz et al., which is incorporated herein by reference.

For example, the nominal pore size may be at least 40 microns, such as at least 60 microns, e.g., at least 100 microns, at least 120 microns, at least 150 microns, at least 200 microns, or at least 500 microns. Alternatively or additionally, for example, the nominal pore size may be less than 1 mm, such as less than 750 microns, less than 500 microns, or less than 250 microns.

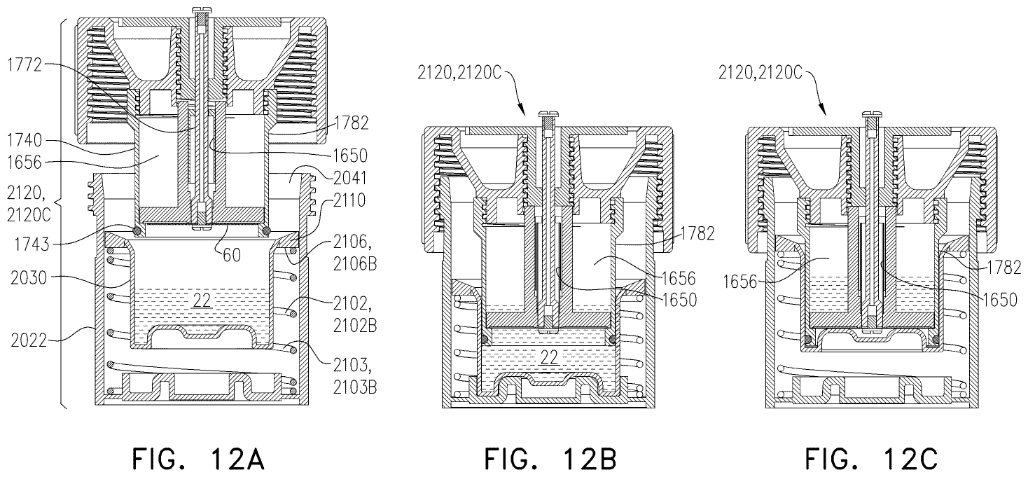

For some applications, filtration assembly 1624 comprises a plurality of filters, such as described with reference to FIGS. 10A-B in PCT Publication WO 2022/149135 to Feldman et al., which is assigned to the assignee of the present application and incorporated herein by reference. Optionally, two or more of the plurality of filters touch one another, such as shown in FIGS. 10A-B of the '024 publication, or are separated by one another by one or more thin spacers, e.g., having a thickness of at least 0.05 mm, no more than 1 mm, and/or 0.05-1 mm (configuration not shown). Alternatively or additionally, two or more of the plurality of filters are spaced apart from another, which case filtration assembly 1624 optionally comprises a corresponding number of filter supports 1662, some or all of which may have some or all of the characteristics of filter support 1662 (configuration not shown). Further alternatively or additionally, filtration assembly 1624 comprises one or more additional filters downstream of filter 60 (configuration not shown).

Reference is made to FIGS. 2D and 3D. Sampling device 1620 is typically configured such that filter 60 is removable from tubular container 1630 via a plunger-space proximal opening 1690 while plunger head 1642 of plunger 1640 (and typically filter support 1662) remains within tubular container 1630 (filter 60 is also removable from tubular container 1630 via plunger-space proximal opening 1690 if plunger head 1642 has been removed from tubular container 1630). As mentioned above, plunger head 1642 is shaped so as to define plunger-head opening 1644 through plunger head 1642 and into internal plunger space 1686 of plunger 1640.

Sampling device 1620 is configured such that filter 60 is advanceable into (e.g., entirely into) collection vial 1650 via vial opening 1652 while collection vial 1650 is disengageably coupled to filtration assembly 1624, such as shown in FIGS. 2C and 3C.

Reference is made to FIGS. 2C and 3C. For some applications, sampling device 1620 is configured such that filter 60 is advanceable into collection vial 1650 via vial opening 1652 while plunger head 1642 (and typically filter support 1662) remains within tubular container 1630, such as shown in FIGS. 2C and 3C. For some of these applications, sampling device 1620 is configured such that filter 60 is advanceable into collection vial 1650 via vial opening 1652 while plunger head 1642 is advanced as far as possible within tubular container 1630, such as shown in FIGS. 2C and 3C. Alternatively or additionally, for some applications, sampling device 1620 is configured such that filter 60 is advanceable into collection vial 1650 via vial opening 1652 without any proximal withdrawal of plunger head 1642 within tubular container 1630, such as shown in FIGS. 2C and 3C.

Reference is made to FIGS. 2D and 3D. For some applications, sampling device 1620 is configured such that collection vial 1650 is decouplable from filtration assembly 1624 while plunger head 1642 remains within tubular container 1630, such as shown in FIGS. 2D and 3D, typically, but not necessarily, via a proximal end of plunger 1640. For some of these applications, sampling device 1620 is configured such that collection vial 1650 is decouplable from filtration assembly 1624 while plunger head 1642 is advanced as far as possible within tubular container 1630, such as shown in FIGS. 2D and 3D. Alternatively or additionally, for some applications, sampling device 1620 is configured such that collection vial 1650 is decouplable from filtration assembly 1624 without any proximal withdrawal of plunger head 1642 within tubular container 1630, also such as shown in FIGS. 2D and 3D.

Collection vial 1650 is disengageably coupled to filtration assembly 1624. Once collection vial 1650 has been decoupled from filtration assembly 1624, a diagnostic test may be performed for the presence of particulate trapped by filter 60, which is now in collection vial 1650. For some applications, such as for transporting collection vial 1650 to a remote diagnostic laboratory, sampling device 1620 further comprises collection vial cap, which is configured to seal vial opening 1652.

For some applications, collection vial 1650 is disengageably coupled to plunger 1640. Such as described hereinbelow, once collection vial 1650 has been removed from plunger 1640, a diagnostic test may be performed for the presence of particulate trapped by filter 60, which is now in collection vial 1650. For some applications, such as for transporting collection vial 1650 to a remote diagnostic laboratory, sampling device 1620 further comprises a collection vial cap, which is configured to seal vial opening 1652.

Reference is still made to FIGS. 1A-4. For some applications, such as shown in FIGS. 3A-4, sampling device 1620 comprises a withdrawer 1692, which comprises a filter-withdrawal shaft 1672. Filter-withdrawal shaft 1672:
is disposed partially within collection vial 1650 within internal plunger space 1686,
includes a proximal portion 1687 that is slidably disposed passing through a shaft-passage hole 1609 through an end 1604 of collection vial 1650 opposite vial opening 1652 (labeled in FIG. 4), and
includes a distal portion 1608 (labeled in FIG. 4) that is coupled or couplable (directly or indirectly) to filter 60, typically via an end 1604 of collection vial 1650 opposite a vial opening 1652.

Sampling device 1620 is configured such that proximal movement (e.g., withdrawal) of filter-withdrawal shaft 1672, while plunger head 1642 (and typically filter support 1662) remains within tubular container 1630, collects filter 60 in collection vial 1650 by pulling filter 60 at least partially into (such as entirely into) collection vial 1650 via plunger-head opening 1644 (which, as mentioned above, is defined by the central opening of filter support 1662) via vial opening 1652 (as shown in the transitions between FIGS. 2B and 2C and between FIGS. 3B and 3C). At least a portion of filter 60 is typically bunched up within collection vial 1650, such as into a flower-like arrangement, from the filter's initial flat shape while disposed on filter support 1662.

Typically, sampling device 1620 is configured such that further proximal withdrawal of filter-withdrawal shaft 1672 out of internal plunger space 1686, while plunger head 1642 (and typically filter support 1662) remains within tubular container 1630, pulls collection vial 1650 out of internal plunger space 1686 via plunger-space proximal opening 1690 (as shown in the transitions between FIGS. 2C and 2D and between FIGS. 3C and 3D). It is noted that filter-withdrawal shaft 1672 of sampling device 1620 is not an element of filtration assembly 1624, but instead is removable therefrom, as shown in FIGS. 2D and 3D.

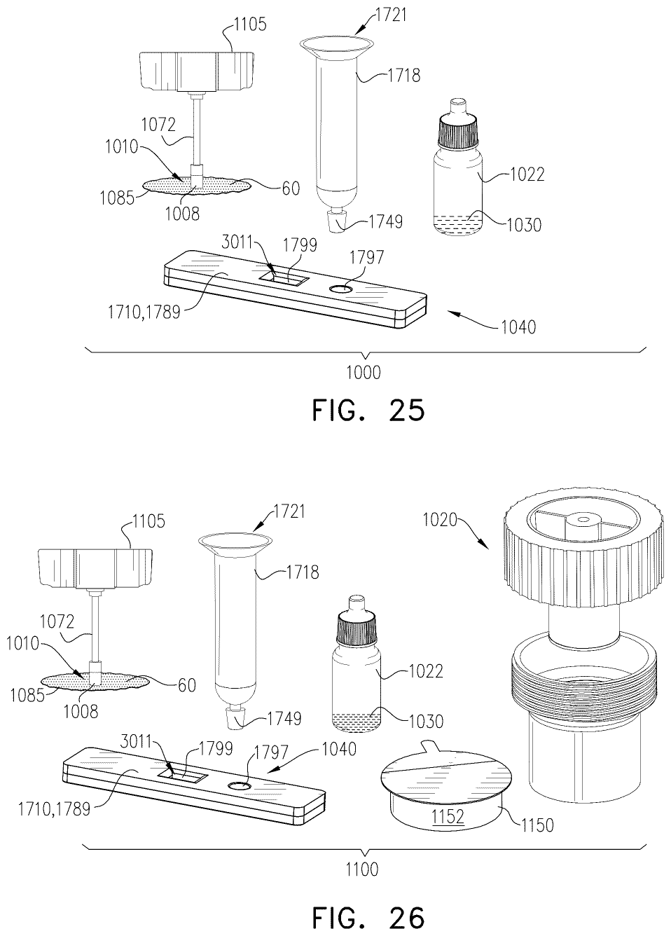

For some applications, distal portion 1608 of filter-withdrawal shaft 1672 is coupled to filter 60 before use of filter 60 (typically during manufacture), while for other applications, distal portion 1608 of filter-withdrawal shaft 1672 is couplable to filter 60 during use of filter 60, such as, by way of example and not limitation, described in above-mentioned International Application PCT/IL2023/050014 with reference to FIGS. 25A-E and 26A-E thereof.

For some applications, sampling device 1620 comprises a distal plate 1671 (labeled in FIG. 3A), which is disposed in contact with a distal surface of filter 60, and is coupled (directly or indirectly) to filter-withdrawal shaft 1672 through end 1604 of collection vial 1650. For example, distal plate 1671 may be circular, i.e., shaped as a disc, or any other shape. Distal plate 1671 may be flexible, e.g., comprise silicone, or may be rigid, e.g., comprise metal or a polymer.

For some applications, withdrawer 1692 further comprises a shaft handle 1605, which is coupled to a proximal portion of filter-withdrawal shaft 1672. Optionally, shaft handle 1605 is shaped as a wing nut.

For some applications, filtration assembly 1624 (e.g., plunger-space proximal opening 1690 and/or plunger support 1658) and withdrawer 1692 (either shaft handle 1605 or filter-withdrawal shaft 1672) are shaped so as to define corresponding screw threads 1623A and 1623B (e.g., female and male screw threads 1623A and 1623B) (labeled in FIG. 3D), respectively, which (a) removably couple filter-withdrawal shaft 1672 to plunger rod 1682, such as shown in FIG. 3B, while filter-withdrawal shaft 1672 is disposed passing through internal plunger space 1686, and (b) prevent the premature proximal withdrawal of filter-withdrawal shaft 1672 out of internal plunger space 1686. Sampling device 1620 is configured such that rotation of filter-withdrawal shaft 1672 and plunger-space proximal opening 1690 with respect to each other (a) causes at least an initial portion of the proximal withdrawal of filter-withdrawal shaft 1672 out of internal plunger space 1686, such as shown in the transition between FIG. 3B and FIG. 3C, and (b) decouples female and male screw threads 1623A and 1623B from each other, thereby allowing the continuation of the proximal withdrawal of filter-withdrawal shaft 1672 out of internal plunger space 1686, such as shown in FIGS. 3C-D. Alternatively, shaft handle 1605 may be shaped so as to define screw thread 1623B, such as described hereinbelow regarding shaft handle 1805 and withdrawer 1892, mutatis mutandis.

Optionally, in configurations in which plunger support 1658 and/or plunger 1640 and tubular container 1630 are threadingly coupled to each other, (a) the threading between plunger-space proximal opening 1690 and filter-withdrawal shaft 1672 or shaft handle 1603 and (b) the threading between plunger 1640 and tubular container 1630 have opposite handedness.

For other applications, filtration assembly 1624 and filter-withdrawal shaft 1672 are not threadingly coupled together, and plunger-space proximal opening 1690 and shaft handle 1605 are not threadingly coupled together.

Reference is made to FIGS. 2D, 3A-F, and 4. For some applications, sampling device 1620 further comprises a seal 1614 that inhibits fluid leakage between proximal portion 1687 of filter-withdrawal shaft 1672 and shaft-passage hole 1609.

Optionally, an inner portion of seal 1614 may snap into an external circumferential groove of proximal portion 1687 of filter-withdrawal shaft 1672 upon the proximal withdrawal of most or all of filter-withdrawal shaft 1672 from collection vial 1650, such as shown in FIG. 4.

Reference is again made to FIGS. 1A-4. As described hereinabove, filter-withdrawal shaft 1672 include distal portion 1608 that is directly or indirectly coupled to filter 60. Exemplary ways in which the distal portion of the filter-withdrawal shaft may be directly or indirectly coupled to filter 60 include, but are not limited to:
the distal portion of filter-withdrawal shaft 1672 may be directly coupled to filter 60, such as shown in FIG. 4, e.g., by an adhesive and/or by distal plate 1671 (labeled in FIG. 3A, which may be fixed, e.g., pinned, to the distal end of the distal portion of filter-withdrawal shaft 1672; in these configurations, the distal portion of the filter-withdrawal shaft passes through the end of the collection vial opposite the vial opening; and
the distal portion of filter-withdrawal shaft 1672 may be indirectly coupled to the filter, such as shown in FIG. 4, e.g., by a rod 1679 (labeled in FIG. 4) that (a) is fixed to the distal end of the distal portion of filter-withdrawal shaft 1672 and (b) passes through the end of the collection vial opposite the vial opening, and optionally further by an adhesive and/or by distal plate 1671 which may be integral with rod 1679 or fixed to rod 1679.

It will be appreciated by persons skilled in the art who have read the present application that the distal portions of filter-withdrawal shaft 1672 may be directly or indirectly coupled to the filter in additional ways, all of which are within the scope of the present invention.

Optionally, filter-withdrawal shaft 1672 is coupled to filter 60 in ways described hereinbelow with reference to FIGS. 25 and 26.

Reference is now made to FIGS. 3E-I. For some applications, the method optionally continues as shown in FIGS. 3E-I. By way of example and not limitation, collection vial 1650 is shown as being shorter in FIGS. 3E-I than in FIGS. 1A-3D. In actual use, the collection vial has the same length throughout its use, i.e., the same length in FIGS. 1A-3D as in FIGS. 3E-I. If the collection vial is shorter than shown in FIGS. 1A-3D, the collection vial occupies only a proximal portion of internal plunger space 1686.

As shown in FIGS. 3E-F, collection vial 1650 is inserted at least partially into an extraction tube 1718, and distally advanced within extraction tube 1718 until bunched-up filter 60 is positioned near a distal end 1751 of extraction tube 1718 opposite a proximal end opening 1721. Extraction tube 1718 is shaped so as to prevent collection vial 1650 from reaching distal end 1751 of extraction tube 1718, such that collection vial 1650 slides up a portion of filter-withdrawal shaft 1672 as bunched-up filter 60 is positioned near distal end 1751, thereby ejecting bunched-up filter 60 from vial opening 1652 of collection vial 1650 and exposing bunched-up filter 60 to a liquid 1030, such as described hereinbelow, within the distal portion of extraction tube 1718.

This technique may aid with the insertion of bunched-up filter 60 into extraction tube 1718. Collection vial 1650 is readily inserted into extraction tube 1718, thereby inserting bunched-up filter 60 into extraction tube 1718 while the bunched-up filter is initially within collection vial 1650. Collection vial 1650 also may serve to cover and/or shield bunched-up filter 60 when filter 60 is exposed to the environment, such as before insertion into extraction tube 1718 and/or after optional removal from extraction tube 1718, such as described hereinbelow with reference to FIG. 3J, or in above-mentioned International Application PCT/IL2023/050014 with reference to FIGS. 32G and 34D thereof; in this sense, collection vial 1650 may also function as a sleeve for covering and/or shielding bunched-up filter 60.

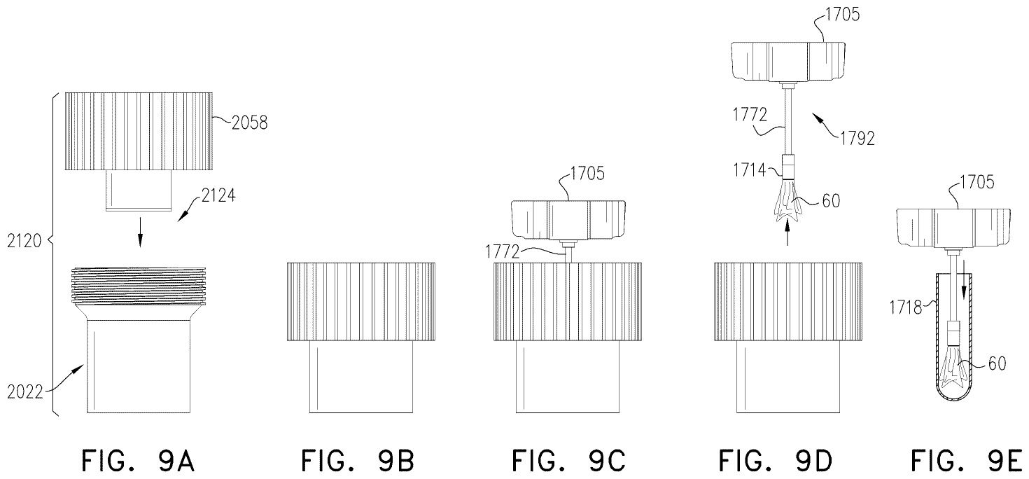

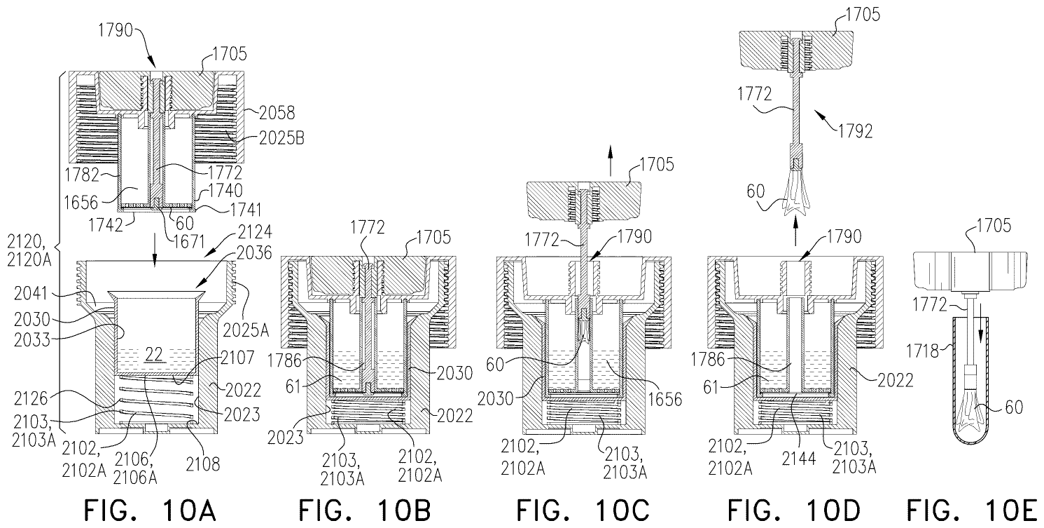

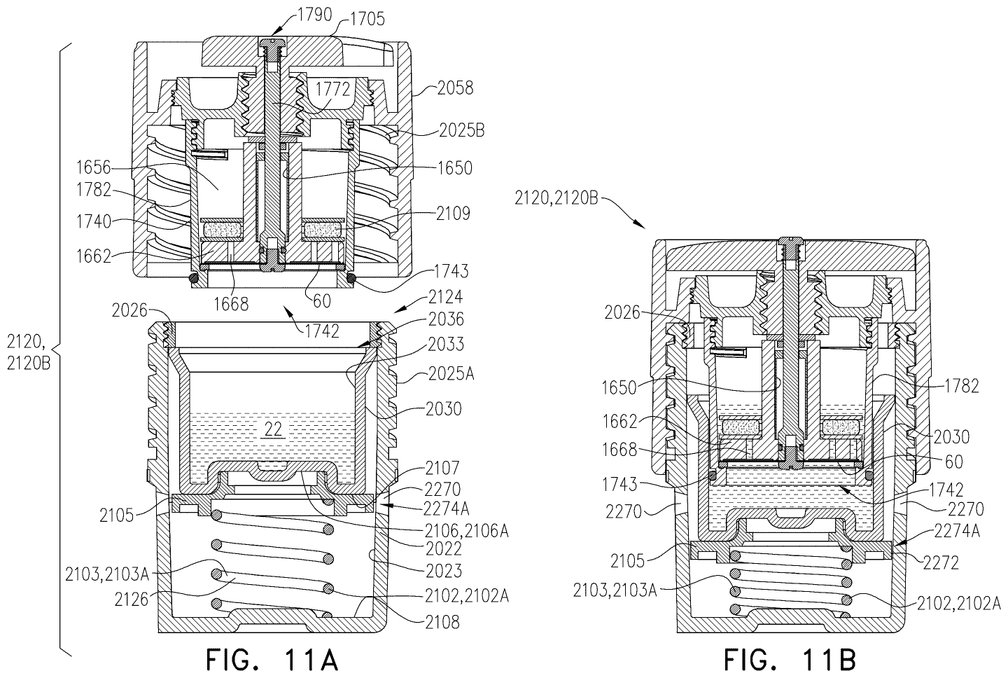

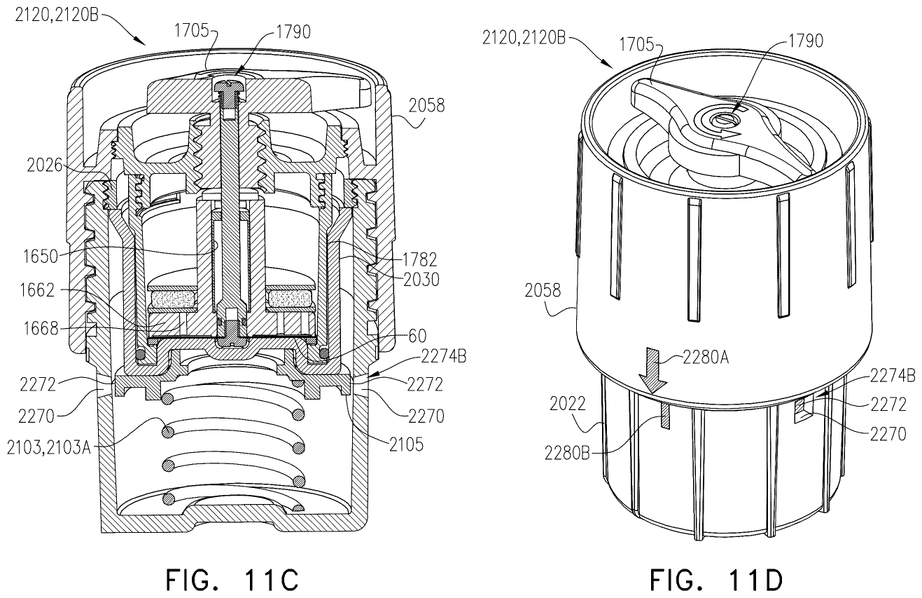

Optionally, as shown in FIGS. 3E-H, extraction tube 1718 may comprise a screw-off distal tip cap 1749 that removably seals distal end 1751 of extraction tube 1718 opposite proximal end opening 1721. The liquid within extraction tube 1718 may be expelled (e.g., squeezed or dripped out) of extraction tube 1718, such as described hereinbelow with reference to FIG. 3I, or in above-mentioned International Application PCT/IL2023/050014 with reference to FIGS. 9C-D thereof.

For some applications, such as shown in FIG. 3G, while bunched-up filter 60 is exposed to liquid 1030 in extraction tube 1718, filter 60 is squeezed (e.g., by squeezing flexible extraction tube 1718) at least one time without expelling any of liquid 1030 from extraction tube 1718. Screw-off distal tip cap 1749, if provided, is then removed from extraction tube 1718, such as shown in FIG. 3H.

For some applications, extraction tube 1718 is oriented horizontally (rather than vertically) during all or a portion of the exposure of bunched-up filter 60 to liquid 1030 in extraction tube 1718. For example, filter 60 may be rotated in extraction tube 1718, optionally while only partially immersed in liquid 1030.

As shown in FIG. 3I, liquid 1030 within extraction tube 1718 is expelled (e.g., squeezed or dripped out) from extraction tube 1718, such as onto a sample pad 1797 of a lateral flow test strip 1799, such as a lateral flow immunoassay test strip. Alternatively, lateral flow test strip 1799 may comprise another type of lateral flow test strip, such as a CRISPR/Cas9-based lateral flow assay. Optionally, liquid 1030 is expelled from extraction tube 1718 by squeezing extraction tube 1718 at least one time, so as to both squeeze a portion of liquid 1030 from filter 60 and expel the portion of the liquid from the extraction tube. In the technique illustrated in FIG. 3I, liquid 1030 within extraction tube 1718 is expelled from extraction tube 1718 while filter 60 remains within extraction tube 1718.

The techniques of FIG. 3E, FIG. 3F, FIG. 3G, FIG. 3H, and/or FIG. 3I may optionally be implemented in combination with the techniques of any of the sampling devices described herein.

For some applications, collection vial 1650 is flexible. Bunched-up filter 60 is exposed to liquid 1030 in extraction tube 1718, as described above. The bunched-up filter is then withdrawn from extraction tube 1718 and pulled at least partially into collection vial 1650 via vial opening 1652, by proximally moving filter shaft 1672 with respect to collection vial 1650. Thereafter, the bunched-up portion of filter 60 is squeezed by squeezing collection vial 1650, while at least a portion of the bunched-up filter 60 is covered and/or shielded by collection vial 1650, to squeeze a portion of liquid 1030 from filter 60 (configuration not shown).

Reference is made to FIGS. 3J-K. The step illustrated in FIG. 3J may optionally be performed after the step illustrated in FIG. 3F or after the step illustrated in FIG. 3G (i.e., with or without squeezing filter 60 while it is in extraction tube 1718). After bunched-up filter 60 has been exposed to liquid 1030 in extraction tube 1718 (typically bathed in liquid 1030 for a certain amount of time), filter-withdrawal shaft 1672 is withdrawn from extraction tube 1718. This proximal movement of filter-withdrawal shaft 1672 with respect collection vial 1650 pulls filter 60 at least partially into (such as entirely into) collection vial 1650 via vial opening 1652.

For some applications, bunched-up filter 60 is removed from extraction tube 1718 while extraction tube 1718 is squeezed. For example, extraction tube 1718 may be squeezed before removing bunched-up filter 60, such as shown in FIG. 3G, and extraction tube 1718 may continue to be squeezed during removal of bunched-up filter 60 from extraction tube 1718.

For some applications, after removal of filter 60 from extraction tube 1718, liquid 1030 is tested for the presence of a target analyte released into liquid 1030 from particulate trapped by filter 60. For example, a lateral flow test strip, such as a lateral flow immunoassay test strip, optionally implemented as a dipstick 1757, may be inserted into liquid 1030 in extraction tube 1718, such as shown in FIG. 3K.

Alternatively, the step illustrated in FIG. 3J may be followed by the techniques of FIGS. 32H-K, 34E-F, or 35A-D of above-mentioned International Application PCT/IL2023/050014.

The techniques of FIG. 3J and/or FIG. 3K may optionally be implemented in combination with the techniques of any of the sampling devices described herein.

Alternatively, such as described in above-mentioned International Application PCT/IL2023/050014 with reference to FIGS. 32H-K or 34E-F thereof, after bunched-up filter 60 is exposed to liquid 1030 in extraction tube 1718 (typically bathed in liquid 1030 for a certain amount of time), collection vial 1650 is removed from extraction tube 1718, and filter 60 is squeezed to partially release the portion of liquid 1030 from filter 60, such as onto sample pad 1797 of lateral flow test strip 1799, such as a lateral flow immunoassay test strip. Alternatively, filter 60 is squeezed by squeezing flexible collection vial 1650 (configuration not shown).

Reference is again made to FIG. 3J. For some applications, after bunched-up filter 60 is bathed in liquid 1030 within extraction tube (and optionally squeezed within extraction tube 1718), a portion of liquid 1030 is discarded, such as by draining the portion of liquid 1030 from extraction tube 1718. For example, extraction tube 1718 may have the configuration described hereinabove with reference to FIGS. 3E-H, and screw-off distal tip cap 1749 may be removed from extraction tube 1718, such as shown in FIG. 3H, in order to discard the portion of liquid 1030.

For some applications, liquid specimen sample 22 is received from a subject's mouth. For some applications, liquid specimen sample 22 comprises gargled fluid, i.e., a gargle fluid that the subject has gargled in his or her mouth and spit out, perhaps along with some saliva. In the present application, including in the claims and Inventive Concepts, “gargled fluid” means “gargle fluid” that has been gargled by a subject. Typically, the gargle fluid includes water, carbonated water, saline (e.g., phosphate buffered saline), pelargonium sidoides extract, tannic acid, balloon flower platycodon grandiflorus, berberine sulfate, S-carboxymethylcysteine, curcumin, coloring, flavoring, a detergent (such as Polysorbate 20 (e.g., Tween® 20)), or any combination thereof. In some applications, the gargle fluid is carbonated. Alternatively or additionally, for some applications, a detergent, such as Polysorbate 20 (e.g., Tween® 20) is added to the gargled fluid after being gargled by the subject. Alternatively, liquid specimen sample 22 may comprise another type of biological fluid, such as blood (e.g., diluted blood), urine, stool (e.g., diluted stool), gastrointestinal (GI) fluid, or bronchoalveolar lavage fluid.

Alternatively, liquid specimen sample 22 comprises saliva not swabbed from the throat of a subject (i.e., the saliva was collected without swabbing the subject's throat). (The distinction between “swab” as a verb and as a noun is noted. A “swab” (as a noun) may be used to obtain saliva without “swabbing” (as a verb) the subject's throat. For example, the subject may suck on a swab, or a swab may be dipped in a container into which gargle fluid or saliva has been placed.) By contrast, in commonly-practiced techniques for testing for strep, the tonsils are swabbed. Further alternatively, liquid specimen sample 22 comprises liquid from a cultured medium containing a biological sample which had been incubated within tubular container 30 or incubated separately from the device and then added to tubular container 30.

Liquid specimen sample 22 (e.g., saliva) may be spit directly by the subject into tubular container 30 or transferred by a healthcare worker from another container into which the subject spit. Alternatively, in the case of saliva, the saliva may be collected from the subject's mouth by having the subject suck on a swab or other absorbent collecting element, such as flocked swabs or cotton rolls.

For some applications in which the method does not comprise swabbing the throat of the subject, liquid specimen sample 22 is collected by drawing liquid specimen sample 22 out of an oral cavity of the subject via an anterior opening of the oral cavity by contacting one or more portions of the oral cavity with an absorbent material, e.g., a flocked or cotton swab, or a sponge (e.g., at a tip of a collector shaft), without swabbing the oropharynx of the subject. (For example, an ORAcollect®. RNA Saliva Collection Device (DNA Genotek Inc., a subsidiary of OraSure Technologies, Inc. (Bethlehem, PA, USA)) may be used.) Optionally, the absorbent material is located on a tip of a collector shaft, and liquid specimen sample 22 is drawn out of the oral cavity via the anterior opening of the oral cavity using the absorbent material by inserting the tip of the collector shaft into the oral cavity. For some of these applications, liquid specimen sample 22 is drawn out of the oral cavity via the anterior opening of the oral cavity using the absorbent material by the subject sucking on the absorbent material. For example, the one or more portions of the oral cavity may include one or more of buccal mucosa, the tongue (e.g., under the tongue), the gums (e.g., the lower gums), and/or the palatal mucosa. For example, for swabbing the lower gums, absorbent material (e.g., at a tip of a collector shaft) may be rubbed back and forth along the lower gums several times. (The anterior opening of the oral cavity is the opening of the mouth between the lips, between outside the oral cavity and inside the oral cavity.)

Alternatively, liquid specimen sample 22 comprises an incubated culture medium containing a biological sample.

Reference is still made to FIGS. 1A-4. In some applications of the present invention, a method for concentrating liquid specimen sample 22 is provided. The method comprises:
placing liquid specimen sample 22 in tubular container 1630 of filtration assembly 1624, such as shown in FIGS. 2A and 3A;
inserting plunger head 1642 of plunger 1640 into tubular container 1630 via proximal container opening 1632 of tubular container 1630, such as shown in the transition between FIGS. 2A and 2B and between FIGS. 3A and 3B;
distally advancing plunger head 1642 within tubular container 1630 to drive at least a portion of liquid specimen sample 22 through filter 60 disposed in tubular container 1630, such as shown in FIGS. 2B and 3B (it is noted that in this configuration, filter 60 is not initially disposed in tubular container 1630 when liquid specimen sample 22 is placed in tubular container 1630, and is inserted into tubular container 1630 as plunger head 1642 is inserted into tubular container); and
removing filter 60 from tubular container 1630 via plunger-space proximal opening 1690 while plunger head 1642 and filter support 1662 remain within tubular container 1630, as shown in FIGS. 2C-D and 3C-D.

For some applications, liquid specimen sample 22 may be acquired and/or may have any of the characteristics described hereinabove.

For some applications, the method further comprises sealing vial opening 1652 with a collection vial cap after filter 60 has been advanced into collection vial 1650.

For some applications, the method further comprises, after filter 60 has been removed from tubular container 1630, detecting the presence of a biological particulate trapped by filter 60. For example, the biological particulate may be selected from the group consisting of: a virus, a bacterium, a microorganism, a fungus, a spore, a mite, a biological cell, a biological antigen, a protein, a protein antigen, and a carbohydrate antigen.

For some applications, such as shown in FIGS. 31 and 3K, detecting the presence of the biological particulate trapped by filter 60 comprising using lateral flow test strip 1799 (e.g., a lateral flow immunoassay test strip) to detect the presence of the biological particulate trapped by filter 60. The lateral flow test strip is optionally contained in a housing 1710 (e.g., comprising a cartridge 1789 (also known as a cassette) or a card 3294, such as described hereinbelow with reference to FIGS. 34E-F of above-mentioned International Application PCT/IL2023/050014), or implemented as a dipstick 1757, as is known in the lateral flow art, such as shown in FIG. 3K.

For some applications, filter-withdrawal shaft 1672 is not pre-coupled to filter 60 (configuration not shown, but optionally may be similar to the configuration described hereinbelow with reference to FIGS. 26A-E of above-mentioned International Application PCT/IL2023/050014, mutatis mutandis). Instead, the filter-withdrawal shaft is advanced within internal plunger space 1686 (and optionally inserted into internal plunger space 1686) and coupled to filter 60 after plunger 1640 has been inserted into tubular container 1630 (and optionally been moved within tubular container 1630 to push the at least a portion of liquid specimen sample 22 through filter 60).

For some applications, the method further comprises bathing filter 60 with liquid 1030 within collection vial 1650 (or extraction tube 1718, if provided) after filter 60 has been advanced into collection vial 1650 (and into extraction tube 1718, if provided). For example, the liquid 1030 may be selected from the group consisting of: a lysis buffer, an extraction buffer, saline solution, a transport medium, and one or more reagents, such as one or more reagents for use in a lateral flow test.

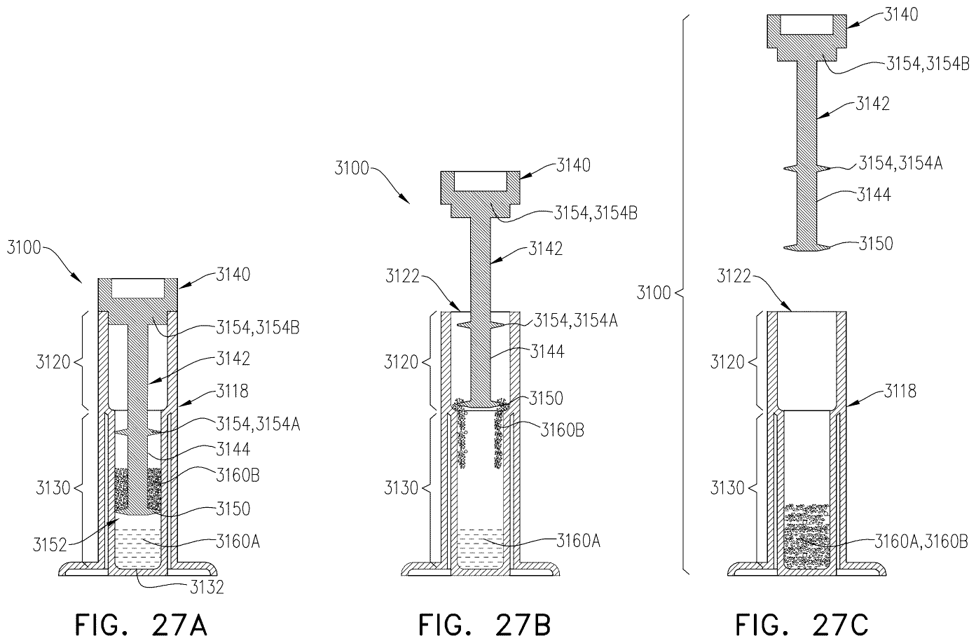

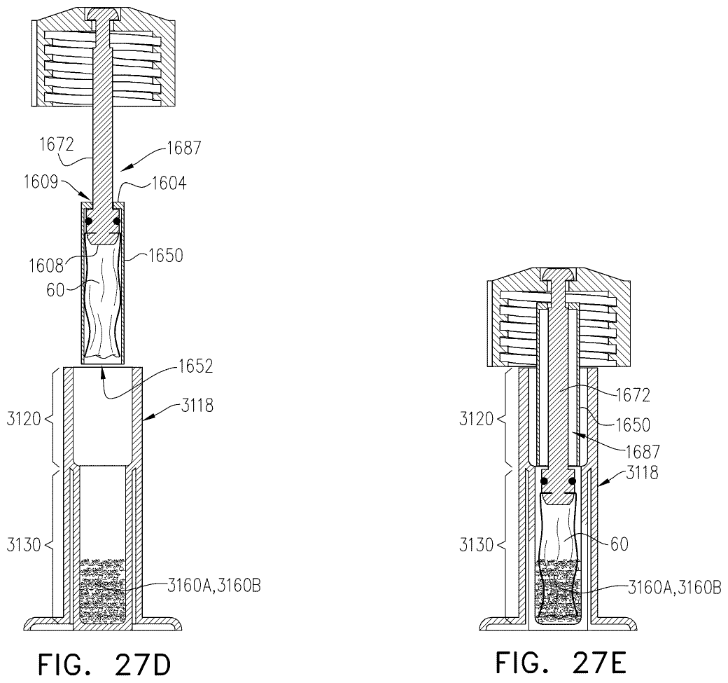

In any of the applications of the present invention described herein, liquid 1030 may comprise two or more liquids that are combined (and optionally mixed together), a solid (e.g., a powder) and a liquid that are combined (and optionally mixed together), or two solids (e.g., two powders) that are combined (and optionally mixed together), typically during the testing procedure, for example as described hereinbelow with reference to FIGS. 27A-C, or as described in above-mentioned International Application PCT/IL2023/050014 with reference to FIGS. 32B and 34A thereof. In any of the applications of the present invention described herein, liquid 1030 may comprise one or more liquids that are combined with a solid, such as a powder (and optionally mixed together), typically during the testing procedure; for example, the powder may be provided contained within one of the tubes described herein, such as one of the extraction tubes described herein.

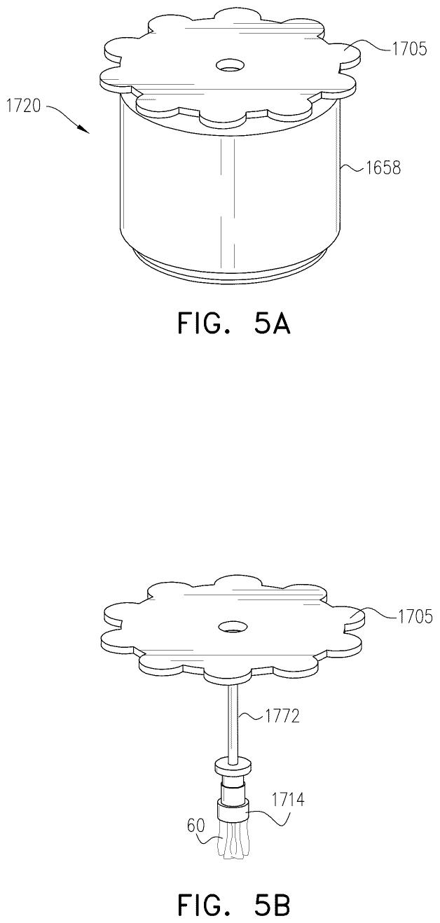

Reference is now made to FIGS. 5A-B, which are schematic illustrations of a sampling device 1720 for concentrating liquid specimen sample 22, and a portion of the sampling device, respectively, in accordance with an application of the present invention.

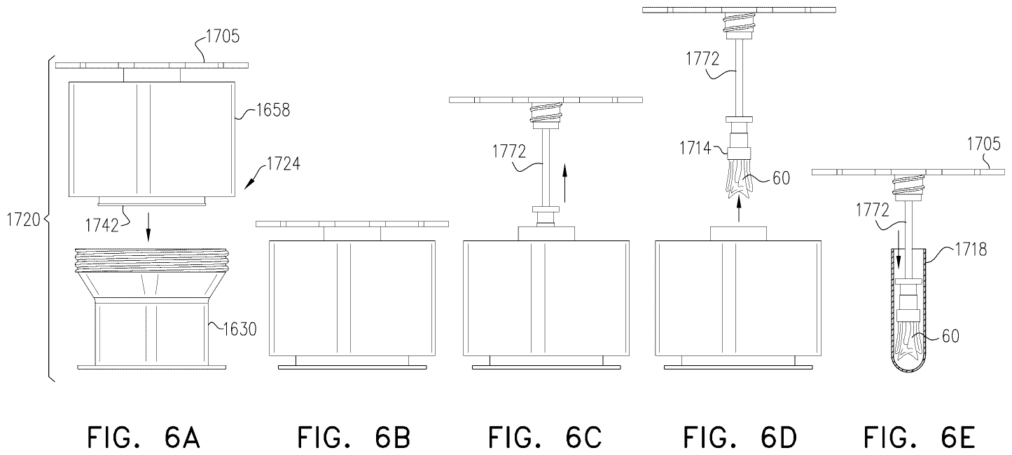

Reference is also made to FIGS. 6A-E, which are schematic illustrations of sampling device 1720 and a method of using sampling device 1720, in accordance with respective applications of the present invention.

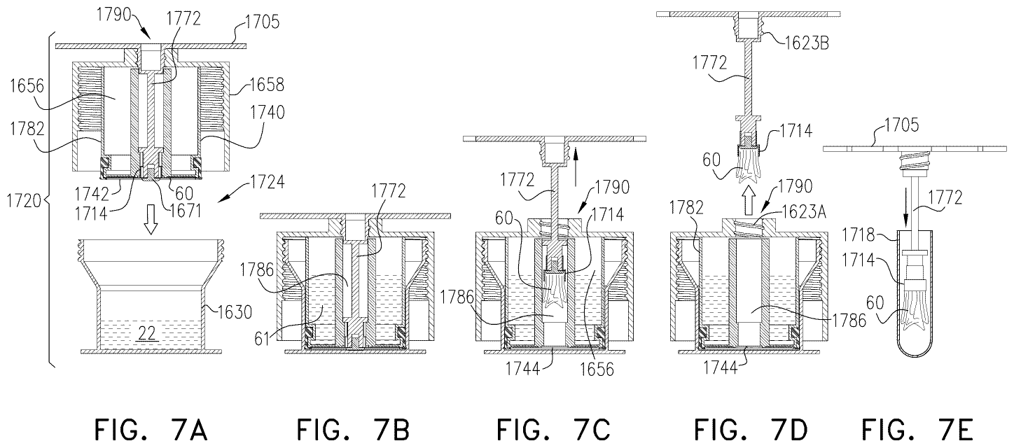

Reference is also made to FIGS. 7A-E, which are schematic cross-sectional illustrations of sampling device 1720 and the method of using sampling device 1720, in accordance with respective applications of the present invention.

Other than as described hereinbelow, sampling device 1720 is generally similar to sampling device 1620 described hereinabove with reference to FIGS. 1A-4, and may implement any of the features thereof, mutatis mutandis. Like reference numerals refer to like parts.

Similar to sampling device 1620, sampling device 1720 typically comprises a filtration assembly 1724, which may have any of the properties described hereinabove. Filtration assembly 1724 comprises tubular container 1630, a plunger 1740, and filter 60, which may have any of the properties described hereinabove with reference to FIGS. 1A-4. However, sampling device 1720 does not comprise a collection vial configured or disposed in a similar manner to collection vial 1650. Nevertheless, sampling device 1720 may optionally comprise extraction tube 1718, such as described hereinbelow with reference to FIGS. 6E and 7E.

Plunger head 1742 is shaped so as to define a plunger-head opening 1744 through plunger head 1742 and into an internal plunger space 1786 of a plunger rod 1782. A proximal end of plunger rod 1782 is shaped so as to define a plunger-space proximal opening 1790 of internal plunger space 1786.

Sampling device 1720 comprises a withdrawer 1792, which comprises a filter-withdrawal shaft 1772, which includes a distal portion that is directly or indirectly coupled to filter 60, and which is disposed passing through internal plunger space 1786. Exemplary ways in which distal portion 1708 of filter-withdrawal shaft 1772 may be directly or indirectly coupled to filter 60 include, but are not limited to:
distal portion 1708 of filter-withdrawal shaft 1772 may be directly coupled to filter 60, such as shown in FIG. 4, e.g., by an adhesive and/or by distal plate 1671, which may be fixed, e.g., pinned, to the distal end of the distal portion of the filter-withdrawal shaft; and
distal portion 1708 of filter-withdrawal shaft 1772 may be indirectly coupled to filter 60, such as shown in FIG. 4 for filter-withdrawal shaft 1672, e.g., by a rod that is fixed to the distal end of the distal portion of the filter-withdrawal shaft and optionally further by an adhesive and/or by distal plate 1671 which may be integral with the rod or fixed to the rod.

It will be appreciated by persons skilled in the art who have read the present application that the distal portion of the filter-withdrawal shaft may be directly or indirectly coupled to the filter in additional ways, all of which are within the scope of the present invention.

For some applications, withdrawer 1792 further comprises a shaft handle 1705, which is coupled to a proximal portion of filter-withdrawal shaft 1772. Optionally, shaft handle 1705 is shaped as a wing nut.

Sampling device 1720 is configured such that proximal withdrawal of filter-withdrawal shaft 1772 out of internal plunger space 1786, while plunger head 1742 and filter support 1662 remain within tubular container 1630, pulls filter 60 into internal plunger space 1786 via plunger-head opening 1744 (which is defined by a central opening of filter support 1662) and out of internal plunger space 1786 via plunger-space proximal opening 1790, and removes filter-withdrawal shaft 1772 and filter 60 from filtration assembly 1724. At least a portion of filter 60 is typically bunched up, such as into a flower-like arrangement, from the filter's initial flat shape while disposed on filter support 1662.

It is noted that filter-withdrawal shaft 1772 of sampling device 1720 is not an element of filtration assembly 1724, but instead is removable therefrom, as shown in FIGS. 6D-E and 7D-E.

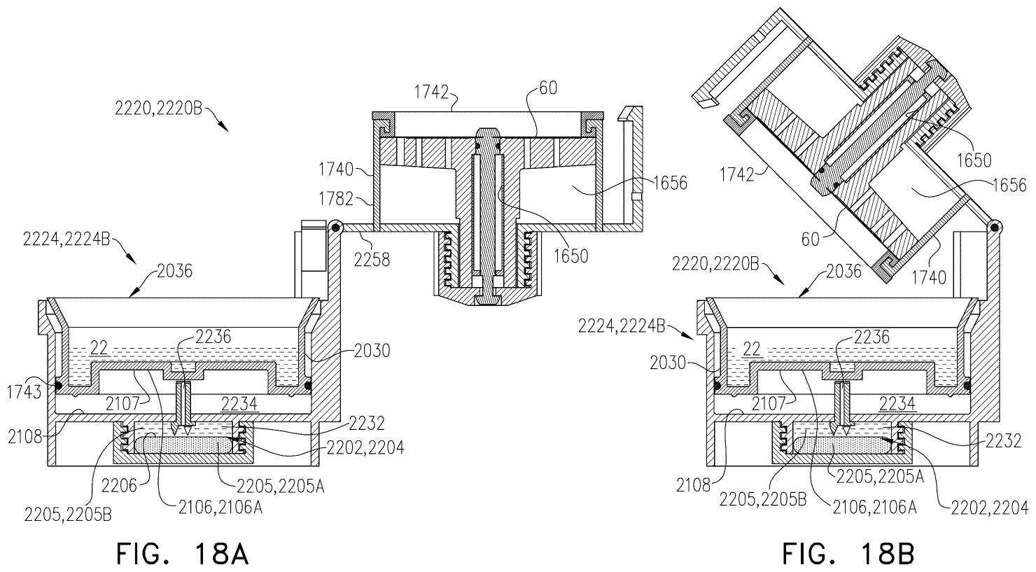

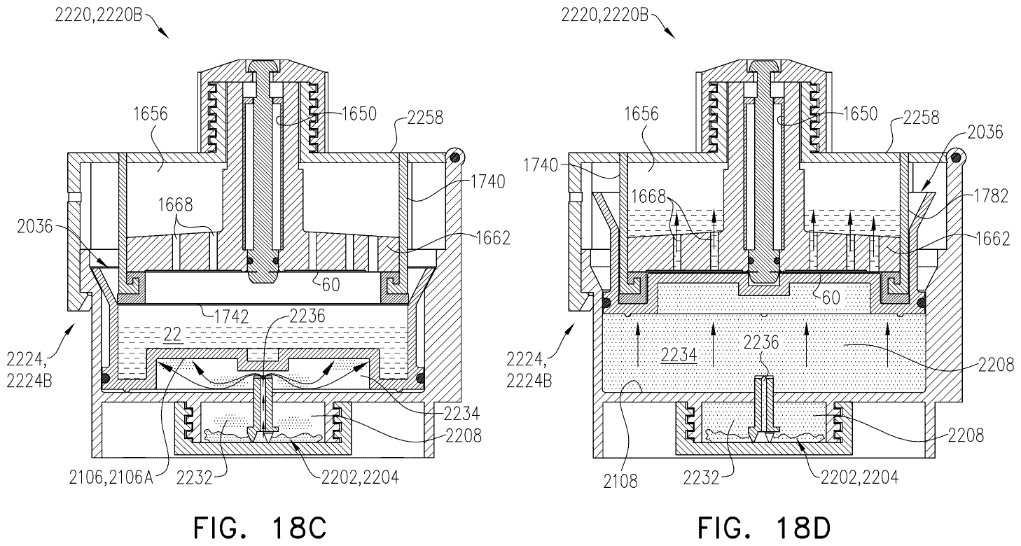

Typically, but not necessarily, after filter-withdrawal shaft 1772 and filter 60 have been removed from filtration assembly 1724, filter 60 and at a portion of filter-withdrawal shaft 1772 are inserted into extraction tube 1718, such as shown in FIGS. 6E and 7E. As mentioned below, the bunching up of at least a portion of filter 60 may help facilitate this insertion; in some respects, the bunched-up filter may function somewhat analogously to a conventional swab. One or more reagents may also be placed in the extraction tube 1718, before or after insertion of filter 60, as known in the diagnostic testing arts. Optionally, extraction tube 1718 implements all or a portion of the techniques described hereinabove with reference to FIGS. 16A-C in PCT Publication WO 2022/149135 to Feldman et al., mutatis mutandis.

For some applications, sampling device 1720 comprises a filter receptacle 1714 that is slidably coupled to a distal end portion of filter-withdrawal shaft 1772 and shaped so as to define a distal receptacle opening 1716. Sampling device 1720 is configured such that the proximal withdrawal of filter-withdrawal shaft 1772 out of internal plunger space 1786, while plunger head 1742 remains within tubular container 1630, pulls a portion of filter 60 into filter receptacle 1714 via distal receptacle opening 1716. For example, the portion of filter 60 may include a central portion (as viewed when filter 60 is flat). This pulling of the portion of filter 60 into filter receptacle 1714 typically causes the remainder of filter 60 to become bunched up, such as into a flower-like arrangement, and be disposed at least partially outside filter receptacle 1714, from the filter's initial flat shape while disposed on filter support 1662. The bunched-up filter may function somewhat analogously to a conventional swab, and, because of the reduced diameter because of the bunching up, may be readily inserted into extraction tube 1718, such as described above and shown in FIGS. 6E and 7E.

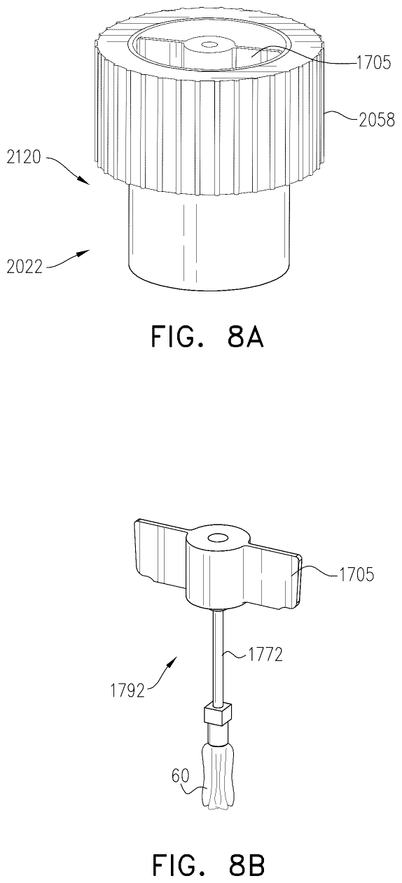

Reference is now made to FIGS. 8A-B, which are schematic illustrations of a sampling device 2120 for concentrating liquid specimen sample 22, and a portion of the sampling device, respectively, in accordance with an application of the present invention.

Reference is also made to FIGS. 9A-E, which are schematic illustrations of sampling device 2120 and a method of using sampling device 2120, in accordance with respective applications of the present invention.

Reference is further made to FIGS. 10A-E, which are schematic cross-sectional illustrations of a sampling device 2120, 2120A and the method of using sampling device 2120, 2120A, in accordance with respective applications of the present invention.

Reference is still further made to FIGS. 11A-D, which are schematic illustrations of a sampling device 2120, 2120B and a method of using sampling device 2120, 2120B, in accordance with respective applications of the present invention.

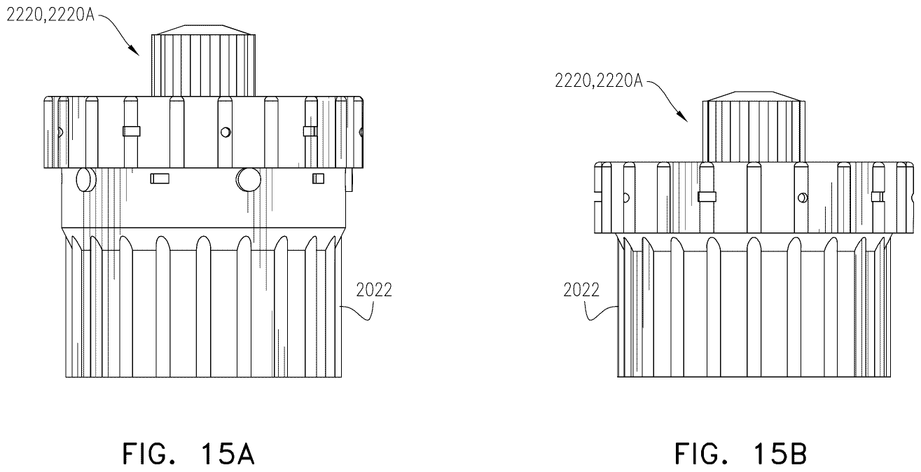

Reference is additionally made to FIGS. 12A-C, which are schematic cross-sectional illustrations of a sampling device 2120, 2120C and a method of using sampling device 2120, 2120C, in accordance with respective applications of the present invention.

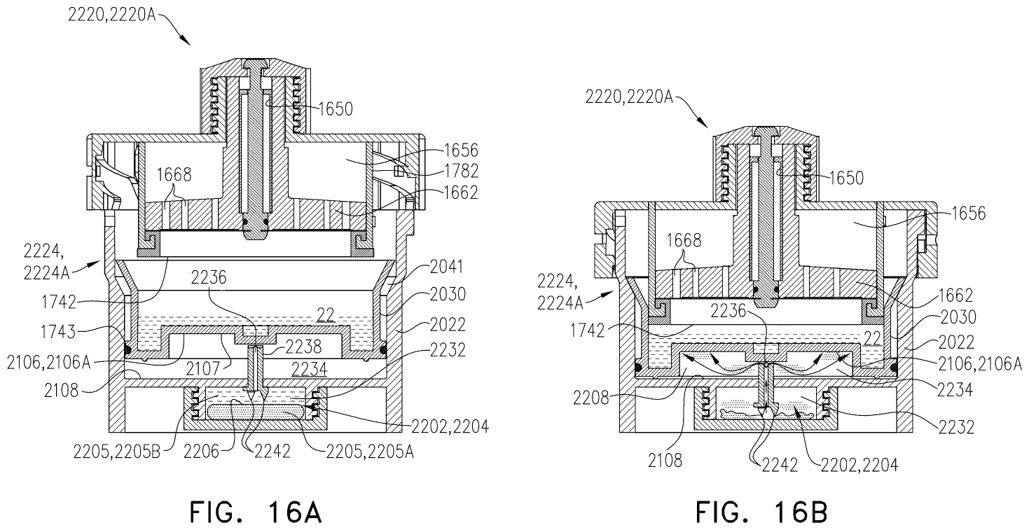

Reference is yet additionally made to FIGS. 13A-D, which are schematic cross-sectional illustrations of a sampling device 2120, 2120D and a method of using sampling device 2120, 2120D, in accordance with respective applications of the present invention.

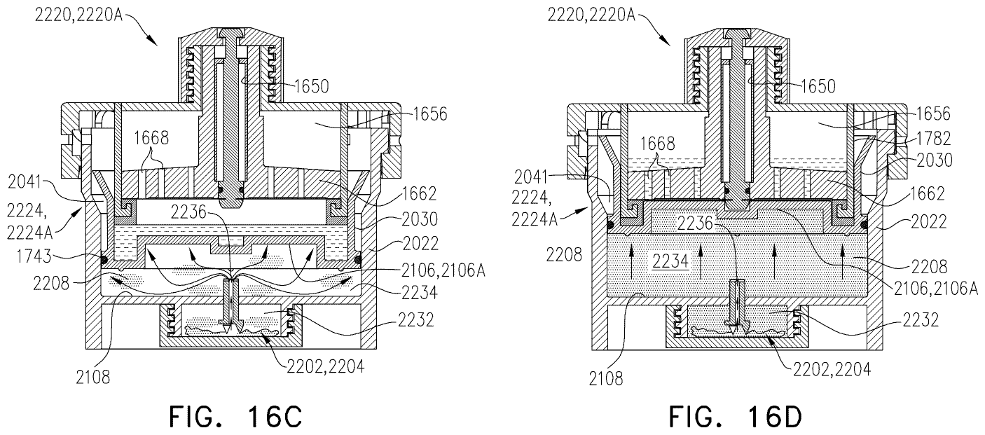

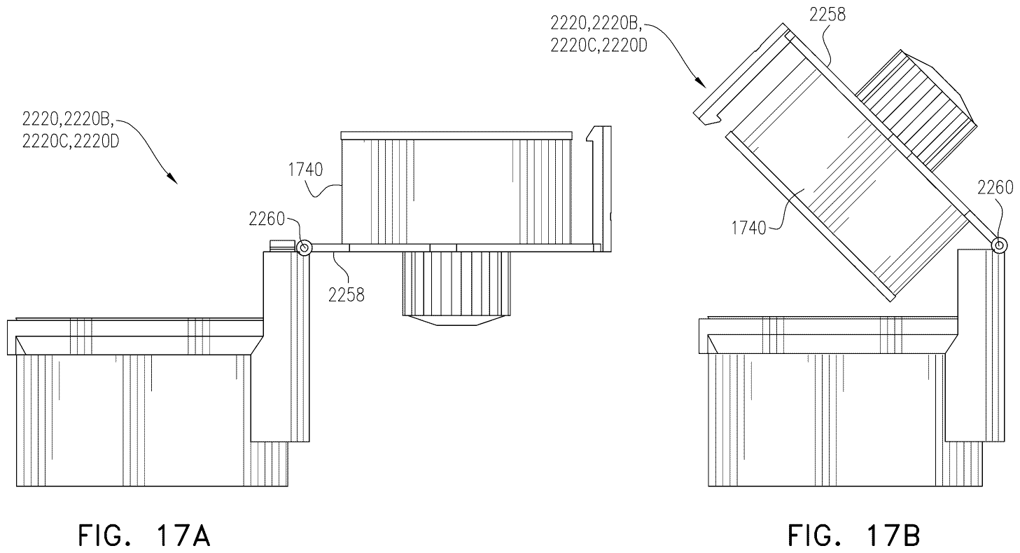

Reference is also made to FIGS. 14A-E, which are schematic cross-sectional illustrations of a sampling device 2120, 2120E and a method of using sampling device 2120, 2120E, in accordance with respective applications of the present invention.

Other than as described hereinbelow, sampling device 2120, in all of the above-mentioned configurations, is generally similar to sampling device 1720 described hereinabove with reference to FIGS. 5A-7E, and may implement any of the features thereof, mutatis mutandis. Like reference numerals refer to like parts. Alternatively or additionally, the features of sampling device 2120 may be implemented in combination with any of the other sampling devices described herein, mutatis mutandis, including, but not limited to sampling device 1620, described hereinabove with reference to FIGS. 1A-4, and/or sampling device 1720, described hereinabove with reference to FIGS. 5A-7E. For example, sampling device 2120 may optionally comprise collection vial 1650, as shown in FIGS. 11A-C, 12A-C, and 13A-D, and sampling device 2120 may be configured such that filter 60 is advanceable into (e.g., entirely into) collection vial 1650 via vial opening 1652 while collection vial 1650 is disengageably coupled to the filtration assembly, such as described hereinabove with reference to FIGS. 2C and 3C.

Sampling device 2120 comprises a filtration assembly 2124 that comprises a container housing 2022, which is shaped so as to define a cylindrical space 2023 within container housing 2022. Optionally, container housing 2022 is also shaped so as to define one or more first threads 2025A. Typically, the threads are configured to provide 1-2 turns, such as 1-1.5 turns.

Filtration assembly 2124 comprises, instead of tubular container 1630, a tubular container 2030, which is shaped so as to define an inner wall 2033 and a proximal container opening 2036 for receiving liquid specimen sample 22. Inner wall 2033 is typically not threaded, so as to make a good seal with a plunger head 1742;

alternatively, the inner wall is threaded. Tubular container 2030 is disposed at least partially within cylindrical space 2023 of container housing 2022. Tubular container 2030 may or may not be rotatable with respect to cylindrical space 2023. Tubular container 2030 may be cylindrical, as shown, or may alternatively have another, non-circular cross-sectional shape.

Filtration assembly 2124 further comprises a plunger support 2058, which is coupled to a proximal portion of plunger 1740, and which is shaped so as to define one or more second threads 2025B, shaped so as to engage the one or more first threads 2025A. The one or more first threads 2025A and/or the one or more second threads 2025B may each be a single entire thread, or a plurality of thread segments that do or do not include complete turns, such as described, for example, in above-mentioned International Application PCT/IL2023/050014 with reference to FIG. 38 thereof. A portion of plunger support 2058 may serve as a handle to enable easy manipulation of plunger 1740, including insertion of plunger 1740 into tubular container 2030. Optionally, the one or more first threads 2025A define 1-2 turns, such as 1-1.5 turns.

Plunger 1740 is insertable into tubular container 2030 via proximal container opening 2036, such that a lateral surface of plunger head 1742 forms a fluid-tight movable seal with inner wall 2033. To this end, the lateral surface of plunger head 1742 may comprise an elastomeric material, such as natural rubber, synthetic rubber, a thermoplastic elastomer, or a combination thereof, for example at or near a distal end of the lateral surface. For example, plunger head 1742 may be shaped so as to define a radial protrusion 1741 comprising the elastomeric material, such as shown in FIGS. 10A-D and 14A-D, and/or may comprise an O-ring 1743 comprising the elastomeric material, such as shown in FIGS. 11A-C, 12A-D, and 13A-D (and in FIGS. 16A-D, 18A-D, 19A-D, 20A-D, and 21A-C, described hereinbelow).

Plunger 1740 is coupled to plunger support 2058, such that rotation of plunger support 2058 with respect to container housing 2022, when the one or more second threads 2025B are engaged with the one or more first threads 2025A, distally advances plunger support 2058 with respect to container housing 2022 and thus plunger 1740 within tubular container 2030 as tubular container 2030 rotates with respect to container housing 2022.

Filtration assembly 2124 is configured such that movement of plunger head 1742 within tubular container 2030, when liquid specimen sample 22 is contained in tubular container 2030 and filter 60 is disposed in tubular container 2030, pushes at least a portion of liquid specimen sample 22 through filter 60 and into waste liquid receptacle 1656.

For some applications, the one or more first threads 2025A face radially outward, and the one or more second threads 2025B face radially inward, such as show in the figures. For other applications, the one or more first threads 2025A face radially inward, and the one or more second threads 2025B face radially outward (configuration not shown).

Optionally, proximal container opening 2036 is shaped as a funnel, such as shown.

Optionally, container housing 2022 includes a proximal portion 2041 that is proximal to cylindrical space 2023, has a greatest internal diameter that is greater than an internal diameter of cylindrical space 2023, and is shaped so as to define a funnel-shaped portion, such as shown. For example, a distal end of the funnel-shaped portion may be is within 2 cm, such as within 1 cm, of cylindrical space 2023, measured along a central longitudinal axis of cylindrical space 2023.

Sampling device 2120 further comprises an energy storage element 2102. A filtration assembly 2124 of sampling device 2120 is configured such that movement of plunger head 1742 within tubular container 2030, when liquid specimen sample 22 is contained in tubular container 2030 and filter 60 is disposed on support surface 1659 (labeled in FIG. 3A for sampling device 1620):
pushes at least a portion of liquid specimen sample 22 through filter 60 and filtrate-passage openings 1668 and into waste liquid receptacle 1656, and
stores energy in energy storage element 2102.

Energy storage element 2102 may function as a sort of shock absorber in the event that plunger 1740 is advanced within tubular container 2030 more quickly than liquid specimen sample 22 can pass through filter 60. Energy storage element 2102 transiently reduces the pressure that liquid specimen sample 22 is exerting on the filter. Without this technique, the excessive build-up of pressure in liquid specimen sample 22 in tubular container might possibly clog or tear the filter (which may comprise a fine material) and/or liquid specimen sample 22 may escape tubular container 2030 without passing through filter 60 using techniques for fluid escape described herein.

For some applications, the above-described movement of plunger head 1742 within tubular container 2030 that stores energy in energy storage element 2102 may be only minimal movement of plunger head 1742 within tubular container 2030, such as just enough movement for the plunger head to engage the tubular container and slightly move the tubular container.

For some applications, energy storage element 2102 may alternatively or additionally release energy that pushes at least a portion of liquid specimen sample 22 through filter 60 and into waste liquid receptacle 1656, such as shown in FIGS. 11A-C, 12A-C, and 13A-D. In these applications, filtration assembly 2124 is typically configured to push liquid specimen sample 22 through filter 60 at rate that falls within a predetermined range and that is not overly sensitive to the rate at which plunger head 1742 is advanced within tubular container 2030 by the user of the filtration unit.

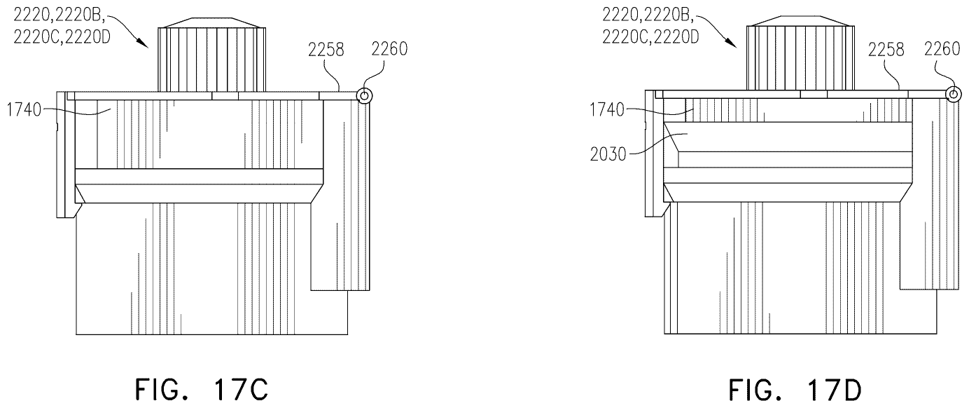

The energy released by energy storage element 2102 may be:
stored in energy storage element 2102 entirely during advancement of plunger head 1742 within tubular container 2030, such as described hereinbelow with reference to FIGS. 12A-C and 13A-D;
partially pre-stored in energy storage element 2102 prior to advancement of plunger head 1742 within tubular container 2030 and partially stored in energy storage element 2102 during advancement of plunger head 1742 within tubular container 2030, such as described hereinbelow with reference to FIGS. 11A-D; or
entirely pre-stored in energy storage element 2102 prior to advancement of plunger head 1742 within tubular container 2030, such as described hereinbelow with reference to FIGS. 15A-B, 16A-D, 17A-D, 18A-D, 19A-D, 20A-D, and 21A-C.

Reference is made to FIGS. 10A-E, 11A-D, 12A-C, 13A-D, and 14A-E. In these configurations, sampling device 2120 further comprises container housing 2022, and tubular container 2030 is disposed at least partially within container housing 2022, such that tubular container 2030 is moveable with respect to container housing 2022, e.g., axially and/or rotationally moveable with respect to container housing 2022. An energy storage element 2102 is disposed within container housing 2022, outside tubular container 2030 and in direct or indirect contact with an external surface 2106 of tubular container 2030, such that movement of plunger head 1742 within tubular container 2030 moves tubular container 2030 with respect to container housing 2022, thereby storing energy in energy storage element 2012. Generally, tubular container 2030 begins to move with respect to container housing 2022 when plunger head 1742 comes in contact with liquid sample 22.

For some applications, energy storage element 2102 comprises a mechanical storage element, which comprises an elastic element 2126, such as a spring 2103 (as shown in FIGS. 10A-E, 11A-D, 12A-C, and 13A-D), a balloon (configuration not shown), or soft beads (e.g., comprising silicone) (configuration not shown), configured to store mechanical energy.

Reference is made to FIGS. 10A-E, 11A-D, 12A-C, and 13A-D. In these configurations, mechanical energy storage element 2102 comprises spring 2103, as follows.

In the configurations shown in FIGS. 10A-E and 11A-D, a mechanical energy storage element 2102, 2102A comprises a spring 2103, 2103A. An external surface 2106, 2106A of tubular container 2030 is defined by a distal end 2107 of tubular container 2030. (Distal end 2107 may be generally flat, such as shown in FIGS. 10A-D, or may have a three-dimensional shape, such as shown in FIGS. 11A-C, 12A-C, 13A-D, 16A-D, 18A-D, 19A-D, 20A-D, and 21A-C.) Spring 2103, 2103A is disposed between external surface 2106, 2106A of tubular container 2030 and a proximally-facing internal surface 2108 of container housing 2022. Spring 2103, 2103A may either directly contact external surface 2106, 2106A, such as shown in FIGS. 10A-E, or indirectly contact external surface 2106, 2106A, such as via a support 2105, such as shown in FIGS. 11A-D. Spring 2103, 2103A may either directly contact proximally-facing internal surface 2108, such as shown in FIGS. 10A-E and 11A-D, or indirectly contact proximally-facing internal surface 2108 (configuration not shown).

For some applications, such as shown in FIG. 11A, mechanical energy storage element 2102, 2102A is pre-loaded, such as slightly pre-loaded, with energy in a pre-insertion state of sampling device 2120, 2120B in which plunger head 1742 is not within tubular container 2030) (and/or before the movement of plunger head 1742 within tubular container 2030 stores energy in the spring). For example, in configurations in which mechanical energy storage element 2102, 2102A comprises spring 2103, 2103A, the spring may comprise a compression spring that is partially compressed before the movement of plunger head 1742 within tubular container 2030. For example, container housing 2022 may comprise a retaining ring 2026 that functions as a stopper to prevent proximal movement of tubular container 2030, thereby holding spring 2103, 2103A partially compressed.

Slightly pre-loading spring 2103, 2103A results in the spring still being somewhat compressed as the spring finishes pushing liquid specimen sample 22 through filter 60. The final stages of pushing liquid specimen sample 22 through filter 60 often require the most pressure, because filter 60 generally becomes progressively more clogged during filtration.

Optionally, sampling device 2120 further comprises an absorbent material 2109, which absorbs the liquid filtrate to inhibit spillage and/or inhibit the liquid filtrate from returning through filter 60. For example, absorbent material 2109 may comprise sodium polyacrylate. Optionally, absorbent material 2109 is sandwiched by two layers of material, such as polyester, that can separate and allow expansion upon absorption of liquid by absorbent material 2109.

In the configuration shown in FIGS. 12A-C, a mechanical energy storage element 2102, 2102B comprises a spring 2103, 2103B, which is disposed encircling at least a longitudinal portion of tubular container 2030. For example, an external surface 2106, 2106B of tubular container 2030 may be defined by a proximal lip 2110 of tubular container 2030, such as shown. Alternatively, tubular container 2030 may be shaped so as to define one or more protrusions that protrude radially outward from a lateral external surface 2106 of tubular container 2030 and engage spring 2103, 2103B, in which case spring 2103, 2103B is in indirect contact with external surface 2106 of tubular container 2030.

In the configuration shown in FIGS. 13-D, a mechanical energy storage element 2102, 2102C comprises a spring 2103, 2103C, which is disposed alongside at least a longitudinal portion of tubular container 2030. Optionally, mechanical energy storage element 2102, 2102C comprises a plurality of springs 2103, 2103C disposed alongside the at least a longitudinal portion of tubular container 2030, such as shown; alternatively, mechanical energy storage element 2102, 2102C comprises exactly one spring 2103, 2103C disposed alongside the at least a longitudinal portion of tubular container 2030 (configuration not shown). For example, external surface 2106, 2106B of tubular container 2030 may be defined by proximal lip 2110 of tubular container 2030, such as shown. Alternatively, tubular container 2030 may be shaped so as to define one or more protrusions that protrude radially outward from a lateral external surface 2106 of tubular container 2030 and engage spring(s) 2103, 2103C, in which case spring(s) 2103, 2103C is in indirect contact with external surface 2106 of tubular container 2030.

Reference is made to FIGS. 12A-C and 13A-D. As mentioned above, for some applications, energy storage element 2102 may alternatively or additionally release energy that pushes at least a portion of liquid specimen sample 22 through filter 60 and into waste liquid receptacle 1656. In the configurations shown in FIGS. 12A-C and 13A-D, this energy is stored in energy storage element 2102 entirely during advancement of plunger head 1742 within tubular container 2030.

For example, spring 2103 may comprise a compression spring that is in a resting, fully uncompressed state before advancement of plunger head 1742 within tubular container 2030, such as shown in FIGS. 12A and 13A. Advancement of plunger head 1742 within tubular container 2030 compresses spring 2103, thereby storing energy in the spring, such as shown in FIGS. 12B and 13C. The advancement typically also pushes a portion of liquid specimen sample 22 through filter 60 and into waste liquid receptacle 1656. Upon completion of the advancement of plunger head 1742 within tubular container 2030, spring 2103 releases some or all of the stored energy, which proximally moves tubular container 2030 with respect to plunger head 1742 (and typically with respect to container housing 2022), such as shown in FIGS. 12C and 13D. This proximal movement pushes an additional portion of liquid specimen sample 22 through filter 60 and into waste liquid receptacle 1656. As used in the present application, including the claims, the plungers described herein are still considered plungers even if they are held stationary as they plunge and liquid specimen sample 22 is pushed through filter 60 and into waste liquid receptacle 1656, such as by proximal movement of tubular container 2030. This is somewhat analogous to how the plunger of a conventional syringe would still be considered a plunger if the plunger were to be held stationary as the barrel were moved proximally toward the handle of the plunger.

In some applications of the present invention, spring 2103 is disposed elsewhere from the locations described above. For example, spring 2103 may be disposed proximal to proximal to tubular container 2030, in which case spring 2103 may comprise an extension spring that stores energy as tubular container 2030 is advanced distally within container housing 2022. Alternatively, spring 2103 may be disposed within or alongside plunger 1740.

Reference is made to FIGS. 14A-E. In this configuration of sampling device 2120, 2120E, an energy storage element 2102, 2102D is disposed within tubular container 2030. For some applications, energy storage element 2102, 2102D comprises a flexible container 2128 containing a gas, such as air. Flexible container 2128 may or may not be elastic. Optionally, flexible container 2128 is coupled to an internal surface of tubular container 2030, such as a bottom thereof, to prevent the flexible container from floating up and contacting filter 60. Optionally, flexible container 2128 bursts at the end of the plunger stroke when the flexible container is squeezed between plunger head 1742 and the bottom of tubular container 2030.

Reference is now made to FIGS. 15A-B, which are schematic illustrations of a sampling device 2220, 2220A and a method of using sampling device 2220, 2220A, in accordance with respective applications of the present invention.

Reference is further made to FIGS. 16A-D, which are schematic cross-sectional illustrations of sampling device 2220, 2220A and the method of using sampling device 2220, 2220A, in accordance with respective applications of the present invention. Sampling device 2220, 2220A comprises a filtration assembly 2224, 2224A.

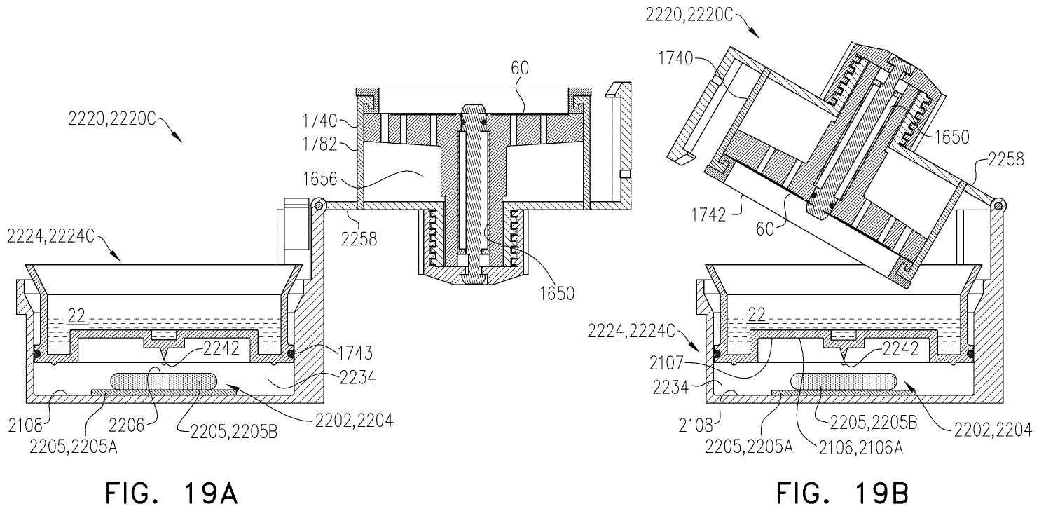

Reference is still further made to FIGS. 17A-D, which are schematic cross-sectional illustrations of a sampling device 2220, 2220B, 2220C, 2220D and a method of using sampling device 2220, 2220B, 2220C, 2220D, in accordance with respective applications of the present invention.

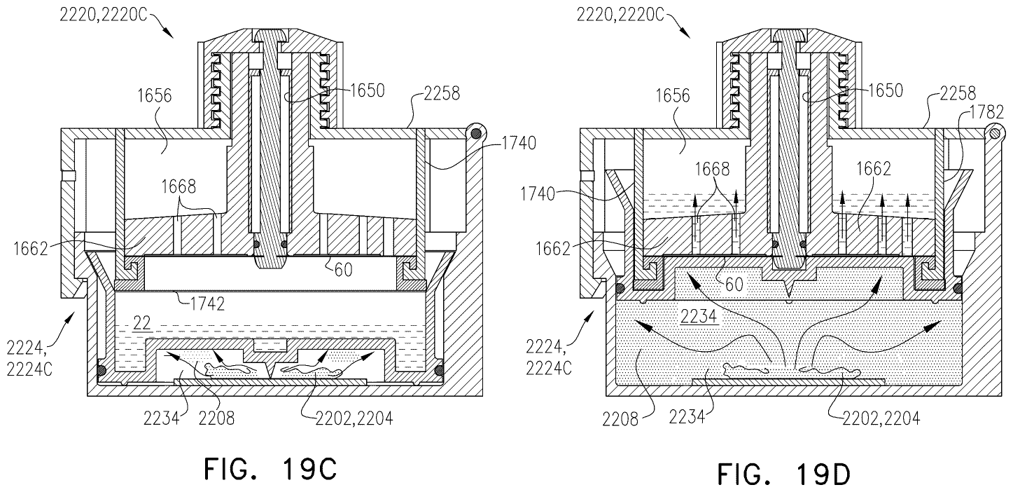

Reference is additionally made to FIGS. 18A-D, which are schematic cross-sectional illustrations of sampling device 2220, 2220B and the method of using sampling device 2220, 2220B, in accordance with respective applications of the present invention. Sampling device 2220, 2220B comprises a filtration assembly 2224, 2224B.

Reference is yet additionally made to FIGS. 19A-D, which are schematic cross-sectional illustrations of sampling device 2220, 2220C and the method of using sampling device 2220, 2220C, in accordance with respective applications of the present invention. Sampling device 2220, 2220C comprises a filtration assembly 2224, 2224C.

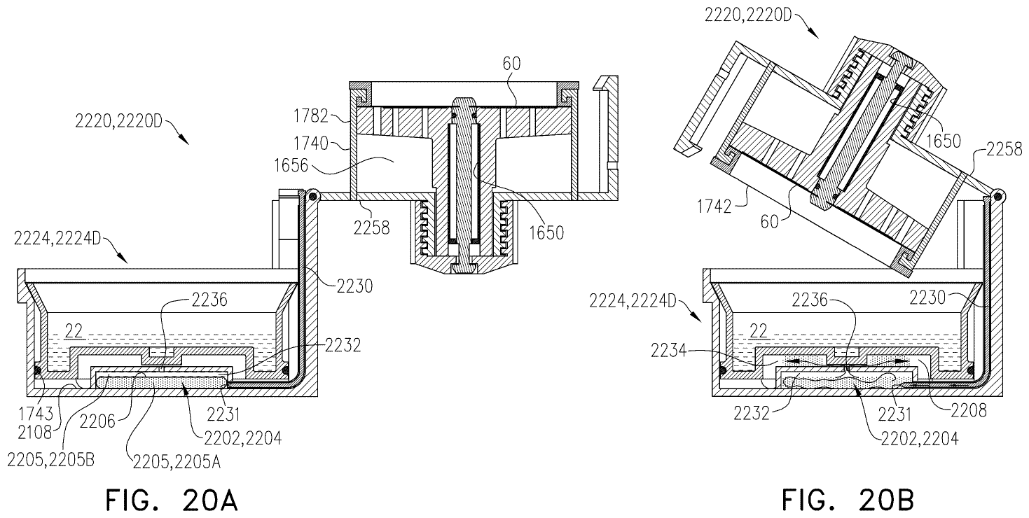

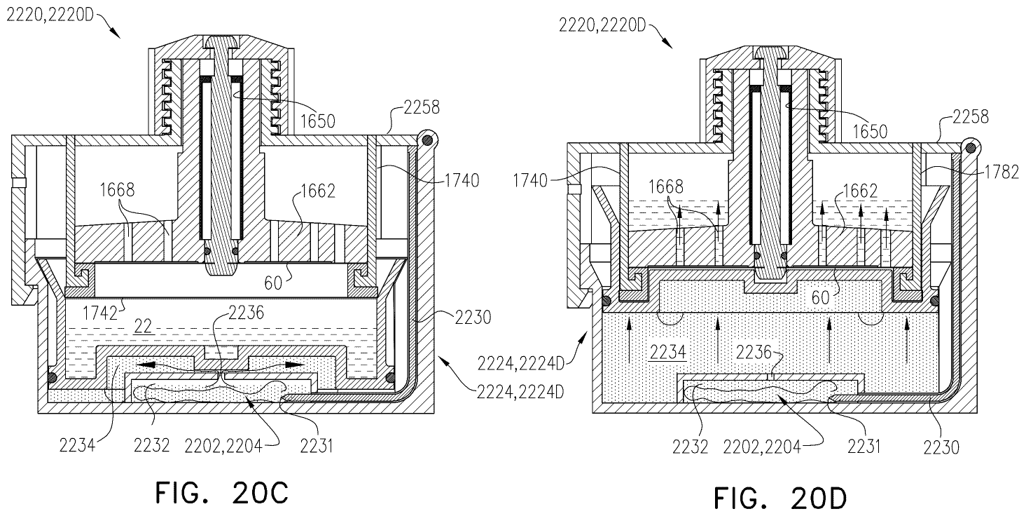

Reference is also made to FIGS. 20A-D, which are schematic cross-sectional illustrations of sampling device 2220, 2220D and the method of using sampling device 2220, 2220D, in accordance with respective applications of the present invention. Sampling device 2220, 2220D comprises a filtration assembly 2224, 2224D.

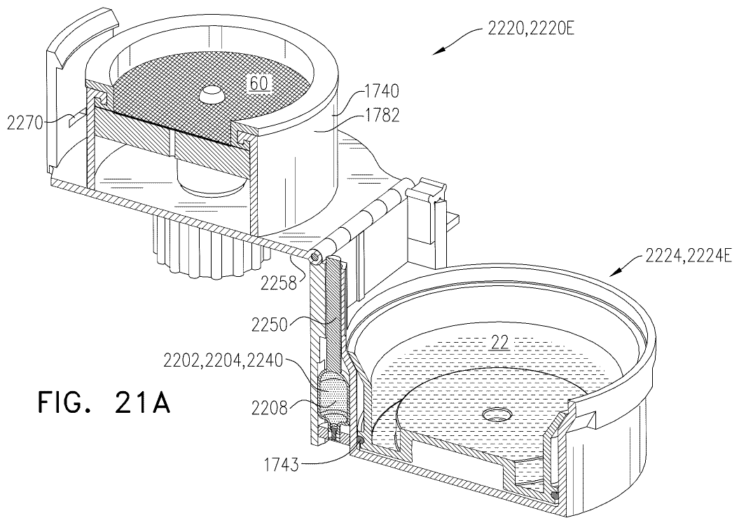

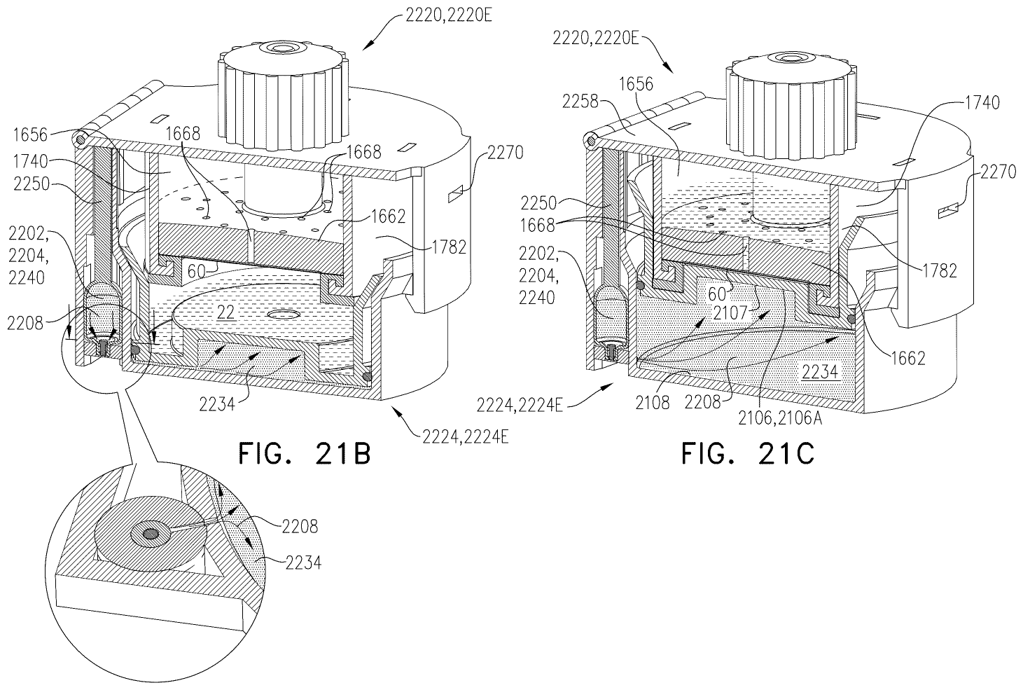

Reference is further made to FIGS. 21A-C, which are schematic cross-sectional illustrations of a sampling device 2220, 2220E and the method of using sampling device 2220, 2220E, in accordance with respective applications of the present invention. Sampling device 2220, 2220E comprises a filtration assembly 2224, 2224E.

Other than as described below, sampling device 2220 and filtration assembly 2224 are generally similar to sampling device 2120 and filtration assembly 2124, respectively, described hereinabove with reference to FIGS. 8A-14E, and like reference numerals refer to like parts. Alternatively or additionally, the features of sampling device 2220 may be implemented in combination with any of the other sampling devices described herein, mutatis mutandis, including, but not limited to sampling device 1620, described hereinabove with reference to FIGS. 1A-4, and/or sampling device 1720, described hereinabove with reference to FIGS. 5A-7E. For example, sampling device 2220 may optionally comprise collection vial 1650, as shown in FIGS. 16A-D, 18A-D, 19A-D, and 20A-D (and present in the configuration shown in FIGS. 21A-C, albeit not visible), and sampling device 2220 may be configured such that filter 60 is advanceable into (e.g., entirely into) collection vial 1650 via vial opening 1652 while collection vial 1650 is disengageably coupled to the filtration assembly, such as described hereinabove with reference to FIGS. 2C and 3C.

Sampling device 2220 comprises a pre-loaded energy storage element 2202, which is not dependent upon advancement of plunger head 1742 within tubular container 2030 to store energy in the energy storage element. For some applications, pre-loaded energy storage element 2202 comprises a source of gas 2204. For example, source of gas 2204 may comprise one or more substances 2205 that generate gas 2208, such as when combined with each other and/or with a liquid, such as liquid of liquid specimen sample 22. For some applications, the one or more substances 2205 may comprise a solid substance 2205A and a liquid substance 2205B. For example, solid substance 2205A may comprise sodium bicarbonate and liquid substance 2205B may comprise an acidic solution (e.g., comprising acetic acid or citric acid), which generate carbon dioxide gas 2208 when combined; or solid substance 2205A may comprise sodium bicarbonate and anhydrous citric acid and liquid substance 2205B may comprise water, which generate carbon dioxide gas 2208 when combined. Alternatively, the one or more substance 2205 may comprise one or more substances that are provided in combination, such as sodium bicarbonate and anhydrous citric acid, which generate carbon dioxide gas 2208 when combined with liquid of liquid specimen sample 22 (configuration not shown). Further alternatively, the one or more substance 2205 may comprise two or more liquids. In these configurations, tubular container 2030 typically forms a fluid-tight movable seal with an inner wall of container housing 2022, for example using O-ring 1743. For example, solid substance 2205A may comprise 0.5-2 g of sodium bicarbonate and liquid substance 2205B may comprise 1-5 mL of acetic acid.

Typically, as gas 2208 is released or generated, the resulting pressure gradually increases during filtration. This increase in pressure helps during the final stages of pushing liquid specimen sample 22 through filter 60, which often require the most pressure, because filter 60 generally becomes progressively more clogged during filtration. By contrast, during earlier stages of filtering, before the filter is particularly clogged, lower pressure is desirable, because using lower pressure results in better filtration. Source of gas 2204 thus appropriate applies lower pressure at the beginning of filtration, and gradually increasing pressure through filtration, which corresponds to, and helps address, the gradual increase in clogging of filter 60 during filtration.

Source of gas 2204 may comprise at least one container 2206, such as a pouch, in which typically one of the one or more substances 2205 is stored (e.g., either solid substance 2205A or liquid substance 2205B), isolated from the other of the one or more substances 2205 in applications in which two or more substances 2205 are provided and combined with each other.

Source of gas 2204 is configured to provide gas 2208 into a space 2234 defined between (a) proximally-facing internal surface 2108 of container housing 2022 and (b) external surface 2106, 2106A of tubular container 2030 that is defined by distal end 2107 of tubular container 2030. Space 2234 is typically airtight. Providing gas 2208 into space 2234 increases the pressure in space 2234, thereby proximally moving tubular container 2030 proximally with respect to plunger head 1742 (and typically with respect to container housing 2022), such as shown in the transitions between FIGS. 16B, 16C, and 16D, between FIGS. 18C and 18D, between FIGS. 19C and 19D, between FIGS. 20C and 20D, and between FIGS. 21B and 21C. This proximal movement of tubular container 2030 pushes a portion of liquid specimen sample 22 through filter 60 and into waste liquid receptacle 1656. This proximal movement of tubular container 2030 also increases the volume of space 2234, which thus defines a variable volume.

For some applications, such as shown in FIGS. 15A-B, 16A-D, 17A-D, 18A-D, and 19A-D, filtration assembly 2224 is configured such that movement of plunger head 1742 within tubular container 2030 causes source of gas 2204 to provide gas 2208. Typically, in these configurations, the movement of plunger head 1742 within tubular container 2030 is insufficient to push a meaningful portion of liquid specimen sample 22 through filter 60.

For some of these applications, the movement of plunger head 1742 within tubular container 2030 causes distal movement of tubular container 2030 within container housing 2022. This distal movement of tubular container 2030 within container housing 2022 may open container 2206 of source of gas 2204. For example, this distal movement of tubular container 2030 may open container 2206 by breaching (e.g., rupturing, penetrating, and/or tearing) container 2206, e.g., by pushing one or more spikes 2242 into a wall of container 2206. Optionally, the one or more spikes 2242 are defined by a distal end of a shaft 2238, and the proximal end of shaft 2238 is pushed distally by distal end 2107 of tubular container 2030. Opening of container 2206 causes a reaction that generates gas 2208, such as described above.

In the configurations shown in FIGS. 15A-B and 16A-D, the movement of plunger head 1742 within tubular container 2030 is typically caused by rotation of plunger head 1742 with respect to container housing 2022.

In the configurations shown in FIGS. 17A-D, 18A-D, and 19A-D, the movement of plunger head 1742 within tubular container 2030 is typically caused by non-rotational insertion of plunger head 1742 into tubular container 2030 with respect to container housing 2022. For example, filtration assembly 2224, 2224B, 2224C may further comprise a plunger support 2258, which is coupled to a proximal portion of plunger 1740. Plunger support 2258 may be hingedly attached to container housing 2022 (e.g., by a hinge 2260, labeled in FIGS. 17A-B), typically so as to enable a change in orientation between a central longitudinal axis of plunger 1740 and a central longitudinal axis of container housing 2022. This change in orientation transitions container opening 2036 from an open position to a closed position, in which plunger head 1742 covers container opening 2036.

For other applications, such as shown in FIGS. 20A-D, filtration assembly 2224 is configured such that movement of plunger head 1742 within tubular container 2030 is not necessary to cause source of gas 2204 to provide gas 2208. For example, tubular container 2030 may already be distally disposed within container housing 2022. Instead, plunger support 2258, upon movement (e.g., hinged movement) with respect to container housing 2022, opens container 2206 of source of gas 2204, such as via an elongate element 2230, e.g., by breaching (e.g., rupturing, penetrating, and/or tearing) container 2206. For example, elongate element 2230 may be shaped so as to define a spike 2231. The movement of plunger support 2258 with respect to container housing 2022 may also transition container opening 2036 from an open position to a closed position, in which plunger head 1742 covers container opening 2036.

For some applications, such as shown for the configuration of FIG. 16A-D, 18A-D, and 20A-D, filtration assembly 2224, 2224A, 2224B, 2224D is shaped so as to define an energy-storage element chamber 2232, in which pre-loaded energy storage element 2202 is disposed. Energy-storage element chamber 2232 is nearly entirely isolated from space 2234. Energy-storage element chamber 2232 is in fluid communication with space 2234 only by one or more narrow openings 2236, e.g., having a total (combined) area of 75-8,000 square microns, e.g., if a single circular narrow opening 2236 is provided, it may have a diameter of 10-100 microns. The one or more narrow openings 2236 may help provide a controlled flow rate of gas 2208 into space 2234. Optionally, the one or more narrow openings 2236 are defined by shaft 2238 that also defines the one or more spikes 2242 for puncturing container 2206 (labeled in FIGS. 16A-B). In the configurations shown in the figures, energy-storage element chamber 2232 is in fluid communication with space 2234 via exactly one narrow opening 2236.

For other applications, such as shown in FIGS. 19A-D, the filtration assembly is not shaped so as to define an energy-storage element chamber, and pre-loaded energy storage element 2202 is instead disposed in space 2234. For example, the one or more substances 2205 may comprise solid substance 2205A, which may comprise a solid, such as a tablet (as shown) or a powder (not shown), disposed at the bottom of space 2234. Optionally, the configuration of FIGS. 20A-D is implemented in this way (without energy-storage element chamber 2232), mutatis mutandis.

For other applications, pre-loaded energy storage element 2202 comprises another source of energy, such as a pre-loaded spring (configuration not shown).

Reference is made to FIGS. 21A-C. In this configuration, pre-loaded energy storage element 2202 comprises a compressed gas container 2240, which stores a gas 2208. Upon opening of container 2240, gas 2208 is released into space 2234. For example, as shown in FIGS. 21A-C, plunger support 2258, upon movement (e.g., hinged movement) with respect to container housing 2022, opens compressed gas container 2240, such as via an elongate element 2250. Alternatively, movement of plunger head 1742 within tubular container 2030 opens compressed gas container 2240 (configuration not shown).

In some applications of the present invention, pre-loaded energy storage element 2202 comprises a spring, such as a compression spring (configuration not shown).

Reference is now made to FIG. 11B-D. In some applications of the present invention, an outer wall of the container housing 2022 is shaped so as to define an optical window 2270. Filtration assembly 2124 further comprises a visual indicator 2272. Filtration assembly 2124 is configured such that visual indicator 2272 is:
not visible through optical window 2270 when tubular container 2030 is at a plurality of first distal axial locations 2274A within filtration assembly 2124, at which location visual indicator 2272 is not axially aligned with optical window 2270 (and thus is typically obscured by the wall of container housing 2022), as shown in FIG. 11B, and
visible through optical window 2270 when tubular container 2030 is at a second proximal axial location 2274B within filtration assembly 2124, at which location visual indicator 2272 is axially aligned with optical window 2270, as shown in FIGS. 11C and 11D.

When tubular container 2030 is at the plurality of first distal axial locations 2274A within filtration assembly 2124, tubular container 2030 has not completed its proximal movement with respect to plunger head 1742, and thus has not completed pushing the additional portion of liquid specimen sample 22 through filter 60 and into waste liquid receptacle 1656.

Optionally, a radially outward facing surface of support 2105, described hereinabove with reference to FIGS. 10A-E and 11A-D, comprises visual indicator 2272.

When tubular container 2030 is at second proximal axial location 2274B within filtration assembly 2124, tubular container 2030 has completed its proximal movement with respect to plunger head 1742, and thus completed pushing the additional portion of liquid specimen sample 22 through filter 60 and into waste liquid receptacle 1656. The visibility of visual indicator 2272 through optical window 2270 provides an indication to the user that the filtration of liquid specimen sample 22 is complete, and thus, for example, filter 60 may be removed from filtration assembly 2124, for example as described hereinabove with reference to FIGS. 2C-D and 3C-D; FIGS. 6C-D and 7C-D; or FIGS. 9C-D and 10C-D.

Optical window 2270 is optionally air-tight, e.g., comprises a transparent or translucent covering; alternatively, optical window 2270 is not air-tight, e.g., is defined by an opening through the outer wall of container housing 2022.

In some applications, an external surface of plunger support 2058 comprises a first rotational indicator 2280A, and an external surface of container housing 2022 comprises a second rotational indicator 2280B. The rotational indicators are disposed such that rotational alignment of the rotational indicators with each other indicates.

Any of the configurations described above with reference to FIG. 11B-D may implemented, mutatis mutandis, in combination with the features of sampling device 2120, 2102A, described hereinabove with reference to FIGS. 10A-E; sampling device 2120, 2120C, described hereinabove with reference to FIGS. 12A-C; sampling device 2120, 2120D, described hereinabove with reference to FIGS. 13A-D; sampling device 2220, 2220A, described hereinabove with reference to FIGS. 16A-D; sampling device 2220, 2220B, described hereinabove with reference to FIGS. 17A-18D; sampling device 2220, 2220C, described hereinabove with reference to FIGS. 19A-D; sampling device 2220, 2220D, described hereinabove with reference to FIGS. 20A-D; and sampling device 2220, 2220E, described hereinabove with reference to FIGS. 21A-C.

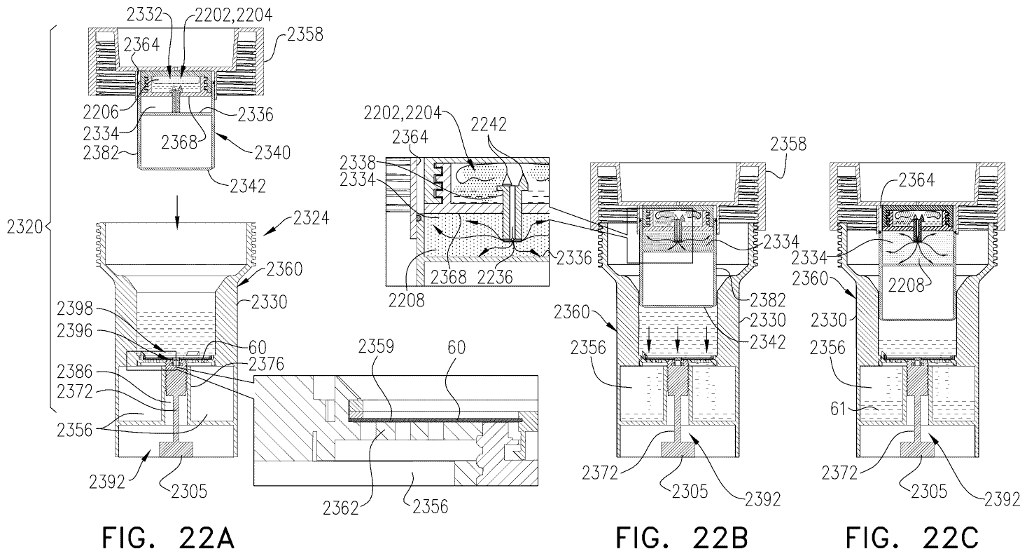

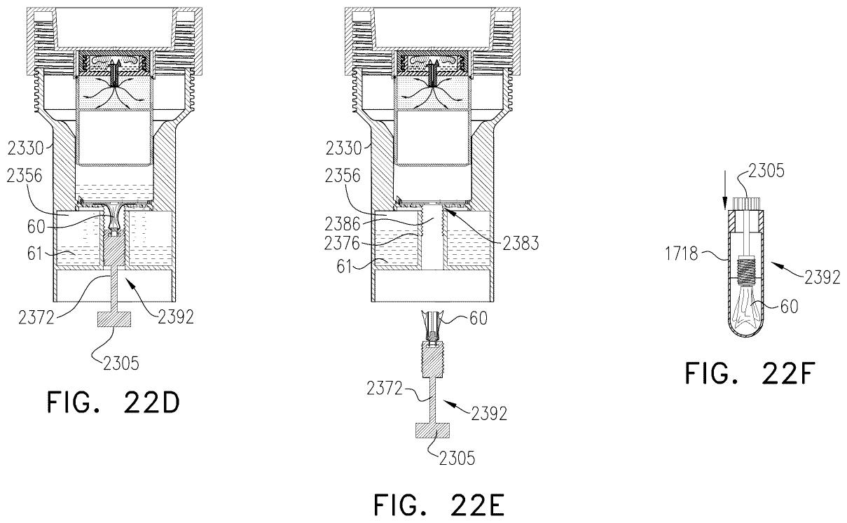

Reference is now made to FIGS. 22A-F, which are schematic cross-sectional illustrations of a sampling device 2320 for concentrating liquid specimen sample 22 and a method of using sampling device 2320, in accordance with respective applications of the present invention.

Other than as described hereinbelow, sampling device 2320 is similar in many respects to sampling device 2220 described hereinabove with reference to FIGS. 15A-21C, and may implement any of the features thereof, mutatis mutandis. Like reference numerals refer to like parts. The techniques of sampling device 2320 may be implemented in combination with the techniques of any of the other sampling devices described herein, mutatis mutandis, including, but not limited to, comprising collection vial 1650, described hereinabove with reference to FIGS. 1A-4, 16A-D, 18A-D, 19A-D, and 20A-D (and present in the configuration shown in FIGS. 21A-C, albeit not visible), and sampling device 2320 may be configured such that filter 60 is advanceable into (e.g., entirely into) collection vial 1650 via vial opening 1652 while collection vial 1650 is disengageably coupled to the filtration assembly, such as described hereinabove with reference to FIGS. 2C and 3C.

Sampling device 2320 comprises a filtration assembly 2324, which may have any of the properties described hereinabove. Filtration assembly 2324 comprises a tubular container 2330 and filter 60, which may have any of the properties described hereinabove with reference to FIGS. 1A-7E. Filtration assembly 2324 further comprises a plunger 2340, which comprises a plunger head 2342 and a plunger rod 2382.

Unlike in sampling device 2220, in sampling device 2320 plunger head 2342 is not shaped so as to define a filter support. Instead, a distal bottom surface 2398 of tubular container 2330 comprises (e.g., is shaped so as to define) a filter support 2362.

Filter support 2362 is shaped so as to define:
a support surface 2359, which may be perpendicular to a central longitudinal axis of tubular container 2330 (as shown), or may be angled with respect to the central longitudinal axis (configuration not shown),
a plurality of filtrate-passage openings through filter support 2362 into a waste liquid receptacle 2356, which is typically disposed distal to filter support 2362 and distal bottom surface 2398 of tubular container 2330, and
optionally, a central opening 2383 (labeled in FIGS. 22D and 22E).

For some applications, filtration assembly 2324 comprises a hollow shaft 2376, which extends distally from tubular container 2330, and is shaped so as to define an internal shaft space 2386 within hollow shaft 2376 (labeled in FIGS. 22A and 22E). Central opening 2383 is open to internal shaft space 2386.

For some applications, sampling device 2320 comprises a withdrawer 2392 comprising a filter-withdrawal shaft 2372, which includes a distal portion that is couplable (directly or indirectly) to filter 60 (for example, as described hereinabove for the other filter-withdrawal shafts described herein, mutatis mutandis). Filter-withdrawal shaft 2372 is disposed passing (a) through a distal opening 2396 defined by distal bottom surface 2398 of tubular container 2330 and (b) optionally, in configurations in which filtration assembly 2324 comprises hollow shaft 2376, through internal shaft space 2386.

For some applications, withdrawer 2392 further comprises shaft handle 2305, which is coupled to a proximal portion of filter-withdrawal shaft 2372. Shaft handle 2305 may have any appropriate shape, for example the shape of wingnut (as shown) or a circular shape (configuration not shown).

Filter 60 is (removably) disposed on support surface 2359, typically on an upstream side of support surface 2359 (which, in the configuration of sampling device 2320, is a proximal side of support surface 2359).

Filtration assembly 2324 is configured such that movement (typically distal advancement) of plunger head 2342 within tubular container 2330, when liquid specimen sample 22 is contained in tubular container 2330 and filter 60 is disposed in tubular container 2330, pushes at least a portion of liquid specimen sample 22 through filter 60. Filter 60 is configured to concentrate at least a portion of liquid specimen sample 22 onto filter 60, while allowing filtrate 61 to pass through filter 60. Typically, distal advancement of plunger head 2342 within tubular container 2330 applies pressure to drive (e.g., push) at least a portion of liquid specimen sample 22 contained in tubular container 2330 through filter 60 and the filtrate-passage openings and into waste liquid receptacle 2356, such as shown in the transitions between FIGS. 22B and 22C.

Sampling device 2320 comprises pre-loaded energy storage element 2202, described hereinabove with reference to FIGS. 15A-21C. Pre-loaded energy storage element 2202 may optionally implement any of the techniques described hereinabove with reference to FIGS. 15A-21C. Filtration assembly 2324 is configured such that release of energy from pre-loaded energy storage element 2202, when liquid specimen sample 22 is contained in tubular container 2330 and filter 60 is disposed on support surface 2359, pushes at least a portion of liquid specimen sample 22 through filter 60 and the filtrate-passage openings and into waste liquid receptacle 2356, such as shown in the transitions between FIGS. 22B and 22C.

For some applications, filtration assembly 2324 further comprises:
a housing 2360, which comprises tubular container 2330; and
a plunger support 2358, which is couplable to housing 2360 (such as by screwing, as described above, mutatis mutandis, e.g., with 1-2 turns, such as 1-1.5 turns), and which comprises a plunger tube 2364, in which plunger rod 2382 is at least partially disposed so as to be axially moveable with respect to plunger tube 2364.

Filtration assembly 2324 is configured such that the release of energy from pre-loaded energy storage element 2202 distally moves plunger rod 2382 with respect to plunger tube 2364 (which is axially stationary with respect to housing 2360 and tubular container 2330), thereby pushing the at least a portion of liquid specimen sample 22 through filter 60 and the filtrate-passage openings and into waste liquid receptacle 2356.

As described above with reference to FIGS. 15A-21C, for some applications pre-loaded energy storage element 2202 comprises source of gas 2204. In some of these applications, source of gas 2204 is configured to provide gas 2208 into a space 2334 by releasing or generating gas 2208. Space 2334 is defined between (a) a proximal surface 2366 of plunger rod 2382 and (b) a distally-facing internal surface 2368 of plunger support 2358. Filtration assembly 2324 is configured such that providing gas 2208 into space 2334 increases pressure in space 2334, thereby distally moving plunger rod 2382 with respect to plunger tube 2364. In these applications, plunger rod 2382 typically forms a fluid-tight movable seal with an inner wall of plunger tube 2364, for example using an O-ring, such as shown.

For some applications in which pre-loaded energy storage element 2202 comprises source of gas 2204, coupling of plunger support 2358 to housing 2360 causes proximal movement of plunger rod 2382 within plunger support 2358. This proximal movement of plunger rod 2382 within plunger support 2358 may open container 2206 of source of gas 2204. For example, this proximal movement of plunger rod 2382 may open container 2206 by breaching (e.g., rupturing, penetrating, and/or tearing) container 2206, e.g., by pushing one or more spikes 2242 into a wall of container 2206. Optionally, the one or more spikes 2242 are defined by a proximal end of a shaft 2338, and the distal end of shaft 2338 is pushed proximally by proximal surface 2366 of plunger rod 2382. Opening of container 2206 causes a reaction that generates gas 2208, such as described above.

For some applications, filtration assembly 2324 is shaped so as to define an energy-storage element chamber 2332, in which pre-loaded energy storage element 2202 is disposed. Energy-storage element chamber 2332 is nearly entirely isolated from space 2334. Energy-storage element chamber 2332 is in fluid communication with space 2334 only by one or more narrow openings 2236, e.g., having a total (combined) area of 75-8,000 square microns, e.g., if a single circular narrow opening 2236 is provided, it may have a diameter of 10-100 microns. The one or more narrow openings 2236 may help provide a controlled flow rate of gas 2208 into space 2334. Optionally, the one or more narrow openings 2236 are defined by shaft 2338 that also defines the one or more spikes 2242 for puncturing container 2206. In the configuration shown in the figures, energy-storage element chamber 2332 is in fluid communication with space 2334 via exactly one narrow opening 2236. For other applications, filtration assembly 2324 is not shaped so as to define an energy-storage element chamber, similar to the configuration of filtration assembly 2224, 2224C described hereinabove with reference to FIGS. 19A-D.

For other applications, pre-loaded energy storage element 2202 comprises another source of energy, such as a pre-loaded spring (configuration not shown).

For some applications, sampling device 2320 is configured such that distal withdrawal of filter-withdrawal shaft 2372 out of filtration assembly 2324, typically while plunger head 2342 remains within tubular container 2330, pulls filter 60 out of filtration assembly 2324 via distal opening 2396 defined by distal bottom surface 2398 of tubular container 2330 (and optionally via central opening 2383 and/or via internal shaft space 2386, in configurations in which filtration assembly 2324 comprises hollow shaft 2376), thereby removing filter-withdrawal shaft 2372 and filter 60 from filtration assembly 2324. At least a portion of filter 60 is typically bunched up, such as into a flower-like arrangement, from the filter's initial flat shape while disposed on filter support 2362.

It is noted that filter-withdrawal shaft 2372 of sampling device 2320 is not an element of filtration assembly 2324, but instead is removable therefrom.

For some applications, filtration assembly 2324 (e.g., distal opening 2396) and withdrawer 2392 (either shaft handle 2305 or filter-withdrawal shaft 2372 thereof) are shaped so as to define corresponding screw threads. Sampling device 2320 is configured such that rotation of withdrawer 2392 and distal opening 2396 with respect to each other causes at least an initial portion of the distal withdrawal of filter-withdrawal shaft 2372 out of filtration assembly 2324. For some applications, the remainder of the proximal withdrawal is performed by simply axially withdrawing withdrawer 2392 once the screw threads have entirely separately (as shown), while for other applications, the screw threads are longer and the remainder of the proximal withdrawal is performed by continuing to rotate withdrawer 2392 (configuration not shown).

For some applications, filtration assembly 2324 is configured such that withdrawer 2392 is removable from the filtration assembly via plunger rod 2382, such as described hereinabove with reference to FIGS. 1A-21C, mutatis mutandis (configuration not shown).

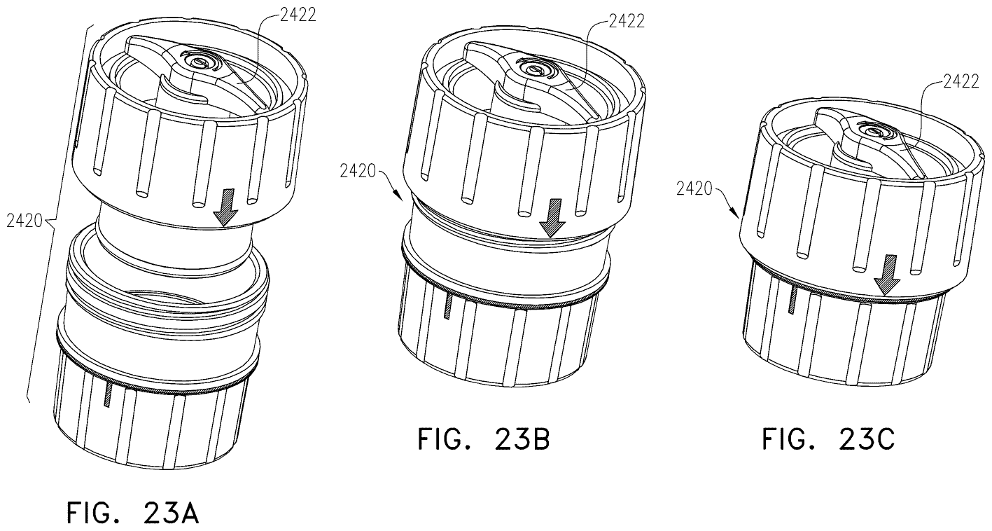

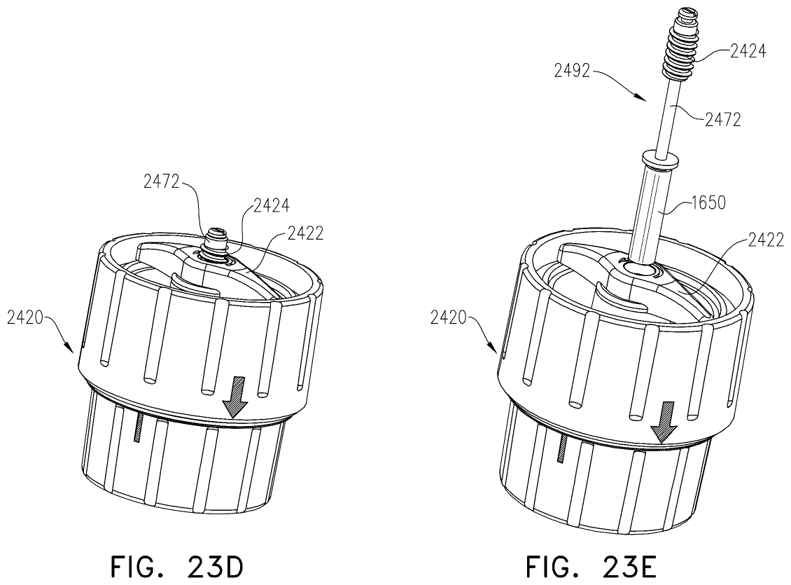

Reference is now made to FIGS. 23A-E, which are schematic illustrations of sampling device 2420 and a method of using sampling device 2420, in accordance with respective applications of the present invention.

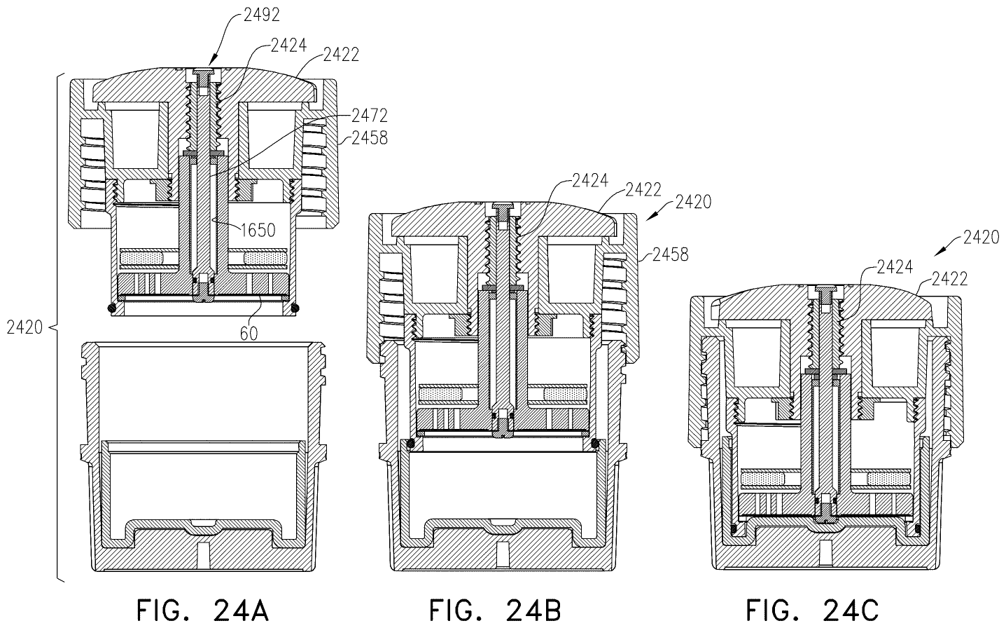

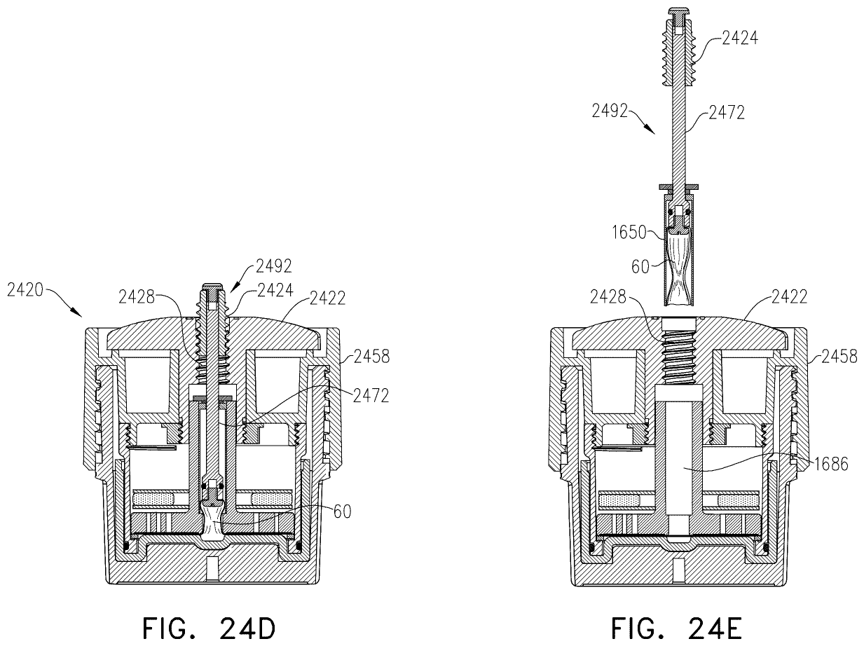

Reference is also made to FIGS. 24A-E, which are schematic cross-sectional illustrations of sampling device 2420 and the method of using sampling device 2420, in accordance with respective applications of the present invention.

Other than as described hereinbelow, sampling device 2420 is generally similar to sampling device 1620 described hereinabove with reference to FIGS. 1A-4, and may implement any of the features thereof, mutatis mutandis. Like reference numerals refer to like parts. The features of sampling device 2420 may be combined with any of the other sampling devices described herein, mutatis mutandis.

Sampling device 2420 comprises a withdrawer 2492, which comprises a filter-withdrawal shaft 2472. Withdrawer 2492 and filter-withdrawal shaft 2472 may implement any of the features of withdrawer 1692 and filter-withdrawal shaft 1672, respectively, of sampling device 1620, described hereinabove with reference to FIGS. 1A-4, mutatis mutandis.

Unlike withdrawer 1692 of sampling device 1620, withdrawer 2492 of sampling device 2420 does not comprise shaft handle 1605 coupled to a proximal portion of filter-withdrawal shaft 1672. Instead, sampling device 2420 comprises a knob 2422, which threadingly engages a proximal threaded portion 2424 of filter-withdrawal shaft 2472 (to this end, knob 2422 is shaped so as to define an internal screw thread 2428). Knob 2422 is axially fixed with respect to a plunger support 2458 of sampling device 2420. Rotation of knob 2422 causes proximal motion of filter-withdrawal shaft 2472 with respect to knob 2422 (and plunger support 2458), until proximal threaded portion 2424 of filter-withdrawal shaft 2472 disengages from plunger support 2458. Knob 2422 typically remains coupled to plunger support 2458 even after disengagement of filter-withdrawal shaft 2472 from plunger support 2458. Optionally, knob 2422 is shaped as a wing nut. (Plunger support 2458 is coupled to a proximal portion of plunger 1640 of sampling device 2420. Plunger support 2458 may implement any of the features of the plunger supports described herein, mutatis mutandis.)

Reference is now made to FIG. 25, which is a schematic illustration of a kit 1000, in accordance with an application of the present invention. Kit 1000 comprises extraction tube 1718, filter 60, liquid 1030 for bathing filter 60 within extraction tube 1718. Liquid 1030 may, for example, comprise one or more reagents, or may, for example, be selected from the group consisting of: a lysis buffer, an extraction buffer, saline solution (e.g., phosphate buffered saline (PBS)), and a transport medium (e.g., a universal transport medium or a viral transport medium). For example, the one or more reagents, which are also known as extraction reagents, may comprise saline, sodium nitrite, acid (e.g., acetic acid or citric acid), detergents, and/or preservatives, which may, for example, release a target analyte (e.g., an antigen) from the particulate, e.g., the cell, bacterium, or virus.

For some applications, kit 1000 comprises a container 1022 that contains liquid 1030; alternatively, extraction tube 1718 contains liquid 1030. For some applications, liquid 1030 has a volume of at least 150 microliters (e.g., at least 200 microliters), no more than 500 microliters (e.g., no more than 300 microliters), and/or 150-500 microliters (e.g., 150-300 microliters, such as 200-300 microliters). The bunched-up shape of filter 60 described herein may facilitate bathing filter 60 in a small amount of liquid 1030. Smaller volumes of liquid 1030 generally result in less dilution of the target analyte released into liquid 1030 from the biological particulate trapped by filter 60.

Kit 1000 further comprises a filter shaft 1072, which includes a distal portion 1008 that is coupled to or couplable to a central portion 1010 of filter 60, and which is configured to insert filter 60 into extraction tube 1718 for bathing filter 60 in the liquid 1030. (It will be appreciated that distal portion 1008 of filter shaft 1072 would not be considered coupled to central portion 1010 of filter 60 if distal portion 1008 of filter shaft 1072 were coupled to a non-central portion of filter 60, such as a peripheral portion of the filter.) For some applications, distal portion 1008 of filter shaft 1072 is coupled to central portion 1010 of filter 60 before use of filter 60 (typically during manufacture), while for other applications, distal portion 1008 of filter shaft 1072 is couplable to central portion 1010 of filter 60 during use of filter 60, such as, by way of example and not limitation, described in above-mentioned International Application PCT/IL2023/050014 with reference to FIGS. 25A-E and 26A-E thereof.

Optionally, filter shaft 1072 comprises any of the filter-withdrawal shafts described herein and/or in the patent applications or patent application publications incorporated herein by reference; likewise, any of the filter-withdrawal shafts described herein may implement any of the features of filter shaft 1072. For example, filter shaft 1072 may comprise: filter-withdrawal shaft 1672 (and optionally collection vial 1650 may additionally be provided), described hereinabove with reference to FIGS. 1A-4; or filter-withdrawal shaft 1772, described hereinabove with reference to FIGS. 5A-7E and 8A-21C.

Optionally, kit 1000 further comprises a shaft handle 1105, which is coupled to a proximal portion of filter shaft 1072. For example, shaft handle 1105 may have the shape of shaft handle 1605 or shaft handle 1805, described hereinabove.

For some applications, filter shaft 1072 has a length of at least 2 cm, such as at least 3 cm.

For some applications, filter 60 is circular when flat. Alternatively, filter 60 has another shape.

For some applications, filter 60 comprises filter reinforcement 2500, as described in above-mentioned International Application PCT/IL2023/050014 with reference to FIGS. 39, 40, 41, and/or 42A-B thereof.

For some applications, extraction tube 1718 comprises a flexible material.

For some applications, sterile packaging is provided, in which one or more elements of kit 1000 (and/or of testing kit 1100, described hereinbelow with reference to FIG. 26) are removably disposed.

For some applications, kit 1000 further comprises a diagnostic test 1040 for testing a portion of liquid 1030 for the presence of a target analyte released into liquid 1030 from biological particulate trapped by filter 60.

For some applications, diagnostic test 1040 comprises a lateral flow test strip 1799 (in which case liquid 1030 typically comprises one or more reagents), such as a lateral flow immunoassay test strip. Lateral flow test strip 1799 is configured to detect the presence of the particulate (such as by detecting a target analyte, e.g., protein antigen, e.g., from a bacterium or from a virus). For some applications in which the lateral flow test strip comprises a lateral flow immunoassay test strip, lateral flow immunoassay test strip 1799 is an element of a chromatographic digital immunoassay, such as the BD Veritor™ system, mentioned immediately below), which is configured to detect the presence of the particulate (such as by detecting a target analyte, e.g., a protein antigen, e.g., from a bacterium or from a virus), and, optionally, one or more reagents. (Lateral flow immunoassay test strips (optionally as an element of a chromatographic digital immunoassay) are well known in the art. For example, they typically contain an antibody specific to an antigen, and the specimen sample fluid migrates up the test strip and reacts with the antibody, thus generating a line on the test strip; the presence of this line indicates a positive test result. For example, the BD Veritor™ system for Rapid Detection of SARS-CoV-2 (Becton, Dickinson and Company, Maryland, USA, Ref: 256082) is a chromatographic digital immunoassay intended for the direct and qualitative detection of SARS-CoV-2 nucleocapsid antigens in nasal swabs.) Alternatively, for some applications, diagnostic test 1040 comprises a rapid molecular test, for example, an isothermal nucleic acid amplification (iNAAT) test, such as a rapid molecular test kit that uses a real-time loop mediated amplification reaction, such as the Lucira COVID-19 All-In-One Test Kit (Lucira Health, Inc., Emeryville, CA, USA), or a nicking enzyme amplification reaction (NEAR) technology, such as the ID NOW™ (Abbott Laboratories, Abbott Park, Illinois, USA), or a molecular test kit manufactured by Visby. Further alternatively, test 302 may comprise a CRISPR-based diagnostic test, an ELISA diagnostic test, or a spectroscopy-based diagnostic test.

Kit 1000 may be used, for example, for collecting liquid specimen sample 22 from the subject and testing at least a portion of the specimen sample using diagnostic test 1040, or sending at least a portion of the specimen sample to a remote laboratory in liquid 1030 in extraction tube 1718, such as for performing Polymerase Chain Reaction (PCR) testing for particulate in liquid specimen sample 22.

The particulate may, for example, be a virus (e.g., an Influenza virus, or a coronavirus, such as SARS-CoV-2), a bacterium (e.g., Streptococcus bacteria, such as Streptococcus pyogenes (Strep A)), a microorganism, an antigen, a human cell, a cellular biomarker, a hormone, a chemical mediator from cells (e.g., a mediator of inflammation), a pollen, mucous, saliva, sputum, a respiratory particle, droplets derived from the upper and lower airways, a nucleic acid including DNA and RNA, and a chemical originating from external vapors. When the particulate is a microorganism, the microorganism may be either a pathogenic microorganism or a non-pathogenic microorganism or both, for example, viruses, bacteria, protozoa, and fungi. When the particulate is a human cell, the human cell may be an epithelial cell, for example, a columnar epithelial cell primarily derived from the nasal cavity and a squamous epithelial cell primarily derived from the oral cavity. The human cell may also be a cellular responder of the immune system, for example, neutrophils, eosinophils, lymphocytes, monocytes, macrophages, mast cells, and histocytes.

For some applications, kit 1000 further comprises distal plate 1671 that is fixed to a distal end of distal portion 1008 of filter shaft 1072 such that central portion 1010 of filter 60 is between the distal end and the distal plate, so as to directly couple filter 60 to filter shaft 1072, such as described hereinabove with reference to FIG. 3A.

Reference is now made to FIG. 26, which is a schematic illustration of a testing kit 1100, in accordance with an application of the present invention. Testing kit 1100 typically comprises all of the elements of kit 1000, described hereinabove with reference to FIG. 25. Testing kit 1100 further comprises a sampling device 1020, such as any of the sampling devices described herein and/or in any of the patent applications or patent application publications incorporated herein by reference. Filter 60 is typically disposed within a portion of the sampling device.

Testing kit 1100 may be used, for example, for collecting liquid specimen sample 22 from the subject and testing at least a portion of the specimen sample using diagnostic test 1040, or sending at least a portion of the specimen sample to a remote laboratory in liquid 1030 in extraction tube 1718, such as for performing Polymerase Chain Reaction (PCR) testing for particulate in liquid specimen sample 22.

For some applications, testing kit 1100 further comprises a container 1150 containing oral wash fluid 1152. The subject may optionally gargle the oral wash fluid, and use sampling device 1020 to filter the gargled oral wash fluid. Typically, the oral wash fluid comprises a non-irritant solution; for example, the non-irritant solution may comprise or consist of water. In some applications, the non-irritant solution comprises saline solution that may be hypertonic, isotonic, or hypotonic, for example, a phosphate-buffered saline solution. For example, container 1150 may contain 5-15 ml, such as 5-10 ml, of oral wash fluid 1152.

Sampling device 1020 may comprise any of the sampling device described herein, and/or may implement any of the features of any of the sampling devices described herein. Any of the filter-withdrawal shafts described herein may be replaced with filter shaft 1072.

For some applications, sampling device 1020 is configured such that withdrawal of filter shaft 1072 out of a filtration assembly of sampling device 1020 removes filter shaft 1072 and filter 60 from the filtration assembly and bunches up at least a portion of filter 60, thereby facilitating insertion of the bunched-up filter into extraction tube 1718. Bunched-up filter 60 may function somewhat analogously to a conventional swab, and, because of the reduced diameter caused by the bunching up, may be readily inserted into extraction tube 1718, such as described above and shown in FIGS. 6E and 7E, FIGS. 9E and 10E, and FIG. 14E.

For some of these applications, sampling device 1020 is configured such that the withdrawal of filter shaft 1072 out of the filtration assembly removes filter shaft 1072 and filter 60 from the filtration assembly and bunches up the at least a portion of filter 60 into a flower-like arrangement, such as shown in many of the figures. Alternatively or additionally, the at least a portion of filter 60 is bunched up so as to have a plurality of folds, which optionally are soft folds (i.e., not creased). In this sense, the bunched-up filter may be considered to be shaped generally as a soft-pleated skirt without an opening at the waist. In general, the flower-like bunched-up shape of filter 60 may create open soft folds, rather than crumpled and/or closed folds that would create closed spaces that liquid 1030 cannot reach.

For some applications, sampling device 1020 is configured such that the withdrawal of filter shaft 1072 out of the filtration assembly removes filter shaft 1072 and filter 60 from the filtration assembly and bunches up the at least a portion of filter 60 such that:
an entirety of perimeter 1085 of filter 60 extends distally away from distal portion 1008 of filter shaft 1072 (such as shown and labeled in FIG. 3E by way of example and not limitation),
an entirety of perimeter 1085 of filter 60 points distally (such as shown and labeled in FIG. 3E by way of example and not limitation), and/or
the bunched-up portion of filter 60 defines an internal space 1087 open distally (such as shown and labeled in FIG. 3E by way of example and not limitation).

Typically, filter 60 is removably disposed in a flat shape on the support surface of the filter support of the filtration assembly of sampling device 1020, as shown in many of the figures illustrating sampling devices.

For some applications, the filtration assembly of sampling device 1020 is configured such that movement of a plunger head within a tubular container of the filtration assembly, when liquid specimen sample 22 is contained in the tubular container and filter 60 is disposed on the support surface of the filter support, pushes the at least a portion of liquid specimen sample 22 through filter 60 in an upstream-to-downstream direction, thereby trapping, on an upstream surface of filter 60, a portion of biological particulate present in liquid specimen sample 22, such as shown in many of the figures illustrating sampling devices.

For some of these applications, sampling device 1020 is configured such that the withdrawal of filter shaft 1072 out of the filtration assembly removes filter shaft 1072 and filter 60 from the filtration assembly and bunches up the at least a portion of filter 60 such that the upstream surface of the filter is inside the bunched-up filter, such as shown in FIGS. 3C-D, 7C-D, and 10C-D. As a result, any biological particulate present in liquid specimen sample 22 and trapped by filter 60 is positioned within bunched-up filter 60. When bunched-up filter 60 is inserted into extraction tube 1718, this position of the biological particulate within bunched-up filter 60 may help bring the biological particulate into good contact with liquid 1030 and maintain the good contact, by creating a contained area for liquid 1030 to interact with the biological particulate.

For others of these applications, sampling device 1020 is configured such that the withdrawal of filter shaft 1072 out of the filtration assembly removes filter shaft 1072 and filter 60 from the filtration assembly and bunches up the at least a portion of filter 60 such that a downstream surface of the filter is inside the bunched-up filter. As a result, any biological particulate present in liquid specimen sample 22 and trapped by filter 60 is positioned on an outer folded surface of bunched-up filter 60. This position of the biological particulate may help increase the contact of the biological particulate with liquid 1030 outside bunched-up filter 60 when bunched-up filter 60 is inserted into extraction tube 1718.

Reference is made to FIGS. 25 and 5A-7E. For some applications, kit 1000 further comprises filter receptacle 1714 coupled to a distal portion of filter shaft 1072 and shaped so as to define distal receptacle opening 1716, such as described hereinabove with reference to FIGS. 5A-7E. In these applications, sampling device 1020 is configured such that the withdrawal of filter shaft 1072 out of the filtration assembly pulls central portion 1010 of filter 60 into filter receptacle 1714 via distal receptacle opening 1716, thereby causing the remainder of filter 60 to become bunched up and be disposed at least partially outside filter receptacle 1714. Optionally, filter receptacle 1714 is slidably coupled to a distal portion of filter shaft 1072.

Reference is made to FIGS. 25 and 26. In an application of the present invention, a method is provided comprising:
passing at least a portion of liquid specimen sample 22 through filter 60, using (a) techniques described with reference to many of the figures herein, (b) techniques described in the patent applications or patent application publications incorporated hereinbelow by reference, such as, by way of example and not limitation, with reference to FIGS. 14A-B of PCT Publication WO 2021/224925 to Levitz et al., or (c) conventional filtering techniques and devices known in the art; for some applications, the at least a portion of liquid specimen sample 22 is passed through filter 60 while filter 60 is in a flat shape, such as shown in many of the figures;
bunching up at least a portion of filter 60 while central portion 1010 of filter 60 is coupled to distal portion 1008 of filter shaft 1072, such as described with reference to many of the figures herein; this bunching up of filter 60 may help facilitate insertion of filter 60 into extraction tube 1718; filter 60 may be coupled to distal portion 1008 of filter shaft 1072 either before or after liquid specimen sample 22 is passed through filter 60, such as described herein;
placing liquid 1030 in extraction tube 1718; alternatively, extraction tube 1718 is provided already containing liquid 1030;
before or after placing liquid 1030 in extraction tube 1718, inserting the bunched-up portion of filter 60 into extraction tube 1718 (via proximal end opening 1721 of extraction tube 1718), such as described with reference to many of the figures herein;
bathing filter 60 in liquid 1030 in extraction tube 1718; and
thereafter, testing a portion of liquid 1030 for the presence of a target analyte released into liquid 1030 from biological particulate trapped by filter 60 (for example, liquid 1030 may be expelled (e.g., dripped or squeezed) onto a diagnostic test, such as onto a sample pad 1797 of a lateral flow test strip 1799).

This method may or may not include separating portion of filter-withdrawal shaft 1772 from each other.

Reference is made to FIG. 26. For some applications, the at least a portion of liquid specimen sample 22 is passed through filter 60 using filtration assembly of sampling device 1020 while filter 60 is removably disposed the filtration assembly and filter shaft 1072 is removably disposed partially within the filtration assembly. The filtration assembly of sampling device 1020 may implement any of (a) the techniques of the filtrations assemblies described herein, (b) techniques described in the patent applications or patent application publications incorporated hereinbelow by reference, such as, by way of example and not limitation, with reference to FIGS. 14A-B of PCT Publication WO 2021/224925, or (c) conventional filtering techniques and devices known in the art.

For some applications, the bunched-up portion of filter 60 is inserted into extraction tube 1718 using the techniques described hereinabove with reference to FIGS. 3E-F.

Reference is again made to FIGS. 25 and 26. For some applications, the at least a portion of filter 60 is bunched up by passing filter 60 through a tube, such as a cylindrical tube. The tube is typically separate from the filtration assembly. Alternatively, for some applications, the at least a portion of filter 60 is bunched up by passing filter 60 into and/or through extraction tube 1718. These two techniques may be particularly useful when a filtration assembly is used that does not bunch up the filter, such as a conventional filtration assembly or, by way of example and not limitation, the filtration assembly described with reference to FIGS. 14A-B of PCT Publication WO 2021/224925.

Alternatively, filter shaft 1072 comprises filter-withdrawal shaft 1672 and collection vial 1650 is additionally provided, such as described hereinabove with reference to FIGS. 1A-4. For some of these applications, the at least a portion of filter 60 is bunched up by passing filter 60 at least partially into collection vial 1650, by sliding proximal portion 1687 of filter-withdrawal shaft 1672 through shaft-passage hole 1609 of collection vial 1650. This technique may be used even in configurations in which a filtration assembly is used that does not bunch up the filter, in which case collection vial 1650 is optionally not initially disposed within a filtration assembly as described hereinabove with reference to FIGS. 1A, 2A-C, and 3A-C. Alternatively or additionally, this technique may be used more than once during a testing procedure, such as a first time in a filtration assembly, as described hereinabove with reference to FIGS. 2B-D and 3B-D, and a second time after removing filter 60 from extraction tube 1718.

Reference is still made to FIGS. 25 and 26. For some applications, liquid 1030 is selected from the group consisting of: a lysis buffer, an extraction buffer, saline solution, and a transport medium. For some applications, liquid 1030 comprises one or more reagents, and the portion of liquid 1030 is tested by testing the portion of the one or more reagents for the presence of the target analyte released into the one or more reagents from the biological particulate trapped by filter 60. For some applications, the portion of the one or more reagents is tested by applying the portion of the one or more reagents to lateral flow test strip 1799.

For some applications, the bunched-up portion of filter 60 is not rotated before, during, and/or after squeezing.

For some applications, the bunched-up portion of filter 60 is rotated before, during, and/or after squeezing. For some of these applications, an inner surface of a side wall of extraction tube 1718 is shaped so as to define one or more protrusions that may help change the direction in which the folds of bunched-up filter 60 point (from clockwise to counterclockwise and back) as the filter is rotated clockwise and counterclockwise). For example, extraction tube 1718 may implement configurations described with reference to FIGS. 13A-E of PCT Publication WO 2022/044002 to Levitz et al. for receptacle 1124 thereof, mutatis mutandis.

Typically, filter 60 is not agitated in extraction tube 1718, although it may optionally be agitated.

For some applications, extraction tube 1718 comprises a flexible material, and the bunched-up portion of filter 60 is squeezed by squeezing a longitudinal portion of extraction tube 1718 along which longitudinal portion the bunched-up portion of filter 60 is disposed, such as shown in FIG. 3I.

For some applications, after filter 60 is bathed in liquid 1030 in extraction tube 1718 and before the bunched-up portion of filter 60 is squeezed, excess liquid 1030 is removed (e.g., drained) from extraction tube 1718. Removal of the excess liquid may help reduce the dilution of the liquid absorbed in and expelled from filter 60.

For some applications, the bunched-up portion of filter 60 is removed from extraction tube 1718 before the bunched-up portion of filter 60 is squeezed (while outside extraction tube 1718). During this removal, excess liquid 1030 remains in extraction tube 1718, which may help reduce the dilution of the liquid absorbed in and expelled from filter 60.

Reference is again made to FIGS. 25 and 26. Typically, filter-withdrawal shaft 1772 extends away from a first side of filter 60 (the top side shown in FIGS. 25 and 26) and does not extend away from a second side of filter 60 opposite the first side (the bottom side in FIGS. 25 and 26) (as shown), or extends away from the second side of filter 60 by less than 10 mm, such as less than 2 mm. As a result, when the portion of filter 60 is bunched up, filter-withdrawal shaft 1772 does not extend, or extends by less than 10 mm (such as less than 2 mm), into the internal space defined by the bunched-up portion of filter 60. The absence of filter-withdrawal shaft 1772 within the bunched-up portion of filter 60 leaves the internal space free for liquid 1030 to fill and make good contact with a large portion of the surface area of the inner surface of the bunched-up portion of filter 60. In addition, the absence of filter-withdrawal shaft 1772 within the bunched-up portion of filter 60 may make it easier to thoroughly squeeze filter 60 than if the relative rigid shaft were within the bunched-up portion of filter 60.

Alternatively, for some applications, the bunched-up portion of filter 60 is squeezed by inserting an object into extraction tube 1718 and using the object to squeeze the bunched-up portion of filter 60 (configuration not shown).

Alternatively or additionally, for some applications, the portion of liquid 1030 is tested using a diagnostic test to test the portion of liquid 1030 for the presence of a target analyte released into liquid 1030 from the biological particulate, and the bunched-up portion of filter 60 is squeezed by inserting a portion of the diagnostic test into extraction tube 1718 and using the portion of the diagnostic test to squeeze the bunched-up portion of filter 60 (configuration not shown).

Further alternatively, the bunched-up portion of filter 60 is removed from extraction tube 1718 after bathing in liquid 1030, and thereafter the bunched-up portion of filter 60 is squeezed to squeeze the portion of liquid 1030 from filter 60 (configuration not shown). Optionally, the bunched-up portion of filter 60 is inserted into another tube before squeezing and squeezed while in this second tube (configuration not shown).

Optionally, excess liquid 1030 is drained from extraction tube 1718 before the bunched-up portion of filter 60 is squeezed (configuration not shown), such as while the bunched-up portion of the filter 60 is in extraction tube 1718.

For some applications, the at least a portion of filter 60 is bunched up into a flower-like arrangement, such as shown in many of the figures.

Reference is now made to FIGS. 27A-E, which are schematic cross-sectional views of a container assembly 3100 and a method of using container assembly 3100, in accordance with an application of the present invention. Container assembly 3100 comprises an extraction tube 3118. Extraction tube 3118 may implement any of the features of extraction tube 1718, described hereinabove with reference to FIGS. 3E-K, and extraction tube 3118 may be used for performing any of the methods described herein as being performed using extraction tube 1718, mutatis mutandis. Similarly, extraction tube 1718 may implement any of the features of extraction tube 3118, and extraction tube 1718 may be used for performing any of the methods described herein as being performed using extraction tube 3118, mutatis mutandis. Similarly, extraction tube 3118 may implemented in combination with any of the extraction tubes described in above-mentioned International Application PCT/IL2023/050014, including extraction tube 3018 thereof, mutatis mutandis; for example, extraction tube 3118 may be integrated with housing 3010 or housing 3410, described in above-mentioned International Application PCT/IL2023/050014.

Extraction tube 3118 is shaped so as to define:
an internally-wider proximal portion 3120, shaped so as to define a proximal opening 3122 of extraction tube 3118, and
an internally-narrower distal portion 3130, shaped so as to define a closed distal end 3132 of extraction tube 3118; closed distal end 3132 may be permanently closed or may be removably closed with a distal tip cap, such as described for distal tip cap 1749 hereinabove with reference to FIGS. 3E-I.

Container assembly 3100 further comprises an elongate sealing insert 3140, which is removably coupled to extraction tube 3118. Elongate sealing insert 3140 comprises:
a shaft 3142 including a distal shaft portion 3144, distal shaft portion 3144 narrower than, and removably disposed at least partially within, internally-narrower distal portion 3130 of extraction tube 3118;
one or more distal plugs 3150 (e.g., exactly one) located along distal shaft portion 3144 or at a distal end 3152 of distal shaft portion 3144, and removably disposed within internally-narrower distal portion 3130 of extraction tube 3118; and
one or more proximal plugs 3154 (e.g., exactly one or exactly two) located along shaft 3142 proximal to the one or more distal plugs 3150;

The at least a portion of distal shaft portion 3144 disposed within internally-narrower distal portion 3130 defines a space between distal shaft portion 3144 and internally-narrower distal portion 3130.

Extraction tube 3118 may be cylindrical or another shape, and the plugs may be circular or another shape.

The one or more distal plugs 3150 may be integral to distal shaft portion 3144, e.g., shaped as protrusions, collars, or ledges, and/or comprises separate sealing elements coupled surrounding distal shaft portion 3144, e.g., O-rings. The one or more distal plugs 3150, when removably disposed within internally-narrower distal portion 3130 of extraction tube 3118, typically form a fluid-tight movable seal with an inner wall of internally-narrower distal portion 3130 of extraction tube 3118.

Similarly, the one or more proximal plugs 3154 may be integral to shaft 3142, e.g., shaped as protrusions, collars, or ledges, and/or comprises separate sealing elements coupled surrounding shaft 3142, e.g., O-rings. Alternatively, one of the one or more proximal plugs 3154 (e.g., proximal plug 3154B, described below) may be shaped as a cap for extraction tube 3118.

Container assembly 3100 still further comprises a first substance 3160A and a second substance 3160B, separate and distinct from first substance 3160A.

As shown in FIG. 27A, first substance 3160A is contained within internally-narrower distal portion 3130 of extraction tube 3118 distal to the one or more distal plugs 3150, such that the one or more distal plugs 3150 seal first substance 3160A within internally-narrower distal portion 3130 of extraction tube 3118.

Also as shown in FIG. 27A, second substance 3160B is contained within extraction tube 3118 distal to the one or more proximal plugs 3154 and proximal to the one or more distal plugs 3150, such that:
the one or more proximal plugs 3154 seal second substance 3160B within extraction tube 3118, and
the one or more distal plugs 3150 sealingly isolate second substance 3160B from first substance 3160A.

Container assembly 3100 is configured such that proximal withdrawal of the one or more distal plugs 3150 from within internally-narrower distal portion 3130 to internally-wider proximal portion 3120, by proximal withdrawal of shaft 3142, brings second substance 3160B into fluid communication with first substance 3160A, such as shown in the transition between FIG. 27A and FIG. 27B.

For some applications, the one or more proximal plugs 3154 comprise a proximal plug 3154, 3154A located along distal shaft portion 3144, and removably disposed within internally-narrower distal portion 3130 of extraction tube 3118. Proximal plug 3154, 3154A, when removably disposed within internally-narrower distal portion 3130 of extraction tube 3118, typically forms a fluid-tight movable seal with an inner wall of internally-narrower distal portion 3130 of extraction tube 3118.

For some applications, the one or more proximal plugs 3154 comprise a proximal plug 3154, 3154B removably plugging proximal opening 3122 of extraction tube 3118.

For some applications, the one or more proximal plugs 3154 comprise:
a first proximal plug 3154, 3154A located along distal shaft portion 3144, and removably disposed within internally-narrower distal portion 3130 of extraction tube 3118, and
a second proximal plug 3154, 3154B removably plugging proximal opening 3122 of extraction tube 3118.

Optionally, proximal plug 3154A is configured to expand upon proximal withdrawal from internally-narrower distal portion 3130, so as to form a seal with the internal wall of internally-wider proximal portion 3120, so as to inhibit spillage of second substance 3160B in the state shown in FIG. 27B.

For some applications (configuration not shown), container assembly 3100 further comprises a third substance, contained within extraction tube 3118 proximal to first proximal plug 3154, 3154A and distal to second proximal plug 3154, 3154B, such that:
second proximal plug 3154, 3154B seals the third substance within extraction tube 3118, and
first proximal plug 3154, 3154A sealingly isolates the third substance from second substance 3160B, and

Container assembly 3100 is configured that:
proximal withdrawal of first proximal plug 3154, 3154A from within internally-narrower distal portion 3130 to internally-wider proximal portion 3120, by proximal withdrawal of shaft 3142, brings the third substance into fluid communication with second substance 3160B, and
proximal withdrawal of the one or more distal plugs 3150 from within internally-narrower distal portion 3130 to internally-wider proximal portion 3120, by further proximal withdrawal of shaft 3142, brings second substance 3160B and the third substance and into fluid communication with first substance 3160A.

First and second substances 3160A, 3160B (and the third substance, if provided) may comprise liquids and/or solids (e.g., powders). The substances, when separate or after being combined, may have any of the characteristics of liquid 1030 described hereinabove with reference to FIGS. 1A-4, FIG. 25, and/or FIG. 26, and/or may be used for testing such as described herein, e.g., with reference to FIGS. 1A-4, FIG. 25, and/or FIG. 26, or with any of the testing devices described herein. For example, the substances may comprise one or more reagents, e.g., configured for use with a lateral flow test strip, or may, for example, be selected from the group consisting of: a lysis buffer, an extraction buffer, saline solution (e.g., phosphate buffered saline (PBS)), and a transport medium (e.g., a universal transport medium or a viral transport medium). For example, the one or more reagents, which are also known as extraction reagents, may comprise saline, sodium nitrite, acid (e.g., acetic acid or citric acid), detergents, and/or preservatives, which may, for example, release a target analyte (e.g., an antigen) from the particulate, e.g., the cell, bacterium, or virus.

In some applications, second substance 3160B comprises a citric acid solution or an acetic acid solution at a concentration that is non-toxic, in case a bit of the second substance spills during removal of shaft 3142 from extraction tube 3118. In these applications, first substance 3160A may comprise, for example, sodium nitrite in solution or solid form.

For some applications, container assembly 3100 comprises a base for holding extraction tube 3118 vertical with respect to a surface on which it is placed, so as to orient container assembly 3100 such that proximal opening 3122 of extraction tube 3118 of container assembly 3100 is above closed distal end 3132 of extraction tube 3118 with respect to the Earth.

Reference is made to FIGS. 27D-E. In some applications of the present invention, a kit is provided that comprises container assembly 3100, and further comprises a filter assembly comprising:
filter 60;
collection vial 1650, described hereinabove; and
filter shaft 1672, described hereinabove, which comprises (a) proximal portion 1687 that is slidably disposed passing through shaft-passage hole 1609 through end 1604 of collection vial 1650 opposite vial opening 1652; and (b) distal portion 1608 that is coupled to filter 60.

The kit is configured such that collection vial 1650 is insertable at least partially into extraction tube 3118, and distally advanceable within extraction tube 3118 until filter 60 is positioned near closed distal end 3132 of extraction tube 3118. Extraction tube 3132 is shaped so as to prevent collection vial 1650 from reaching closed distal end 3132 of extraction tube 3118, such that collection vial 1650 slides up a portion of filter-withdrawal shaft 1672 as filter 60 is positioned near closed distal end 3132, thereby ejecting filter 60 from vial opening 1652 and exposing filter 60 to first and second substances 3160A, 3160B in internally-narrower distal portion 3130 of extraction tube 3118.

Alternatively, container assembly 3100 is provided without the additional elements of the kit described with reference to FIGS. 27D-E.

Alternatively, the method of using container assembly 3100 does not comprise the steps described with reference to FIGS. 27D-E.

Reference is again made to FIGS. 27A-C. In an application of the present invention, a method is provided for using container assembly 3100, the method comprising:
orienting container assembly 3100 such that proximal opening 3122 of extraction tube 3118 of container assembly 3100 is above closed distal end 3132 of extraction tube 3118 with respect to the Earth; and
proximally withdrawing the one or more distal plugs 3150 from within internally-narrower distal portion 3130 to internally-wider proximal portion 3120, by proximally withdrawing shaft 3142, so as to bring second substance 3160B into fluid communication with first substance 3160A.

For some applications, container assembly 3100 further comprises the third substance, contained within extraction tube 3118 proximal to first proximal plug 3154, 3154A and distal to second proximal plug 3154, 3154B, such that (a) second proximal plug 3154, 3154B seals the third substance within extraction tube 3118, and (b) first proximal plug 3154, 3154A sealingly isolates the third substance from second substance 3160B. The method further comprises, before proximally withdrawing the one or more distal plugs 3150 from within internally-narrower distal portion 3130 to internally-wider proximal portion 3120, proximally withdrawing first proximal plug 3154, 3154A from within internally-narrower distal portion 3130 to internally-wider proximal portion 3120, by proximally withdrawing shaft 3142, so as to bring the third substance into fluid communication with second substance 3160B. The one or more distal plugs 3150 are proximally withdrawn from within internally-narrower distal portion 3130 to internally-wider proximal portion 3120, by further proximally withdrawing shaft 3142, so as to bring second substance 3160B and the third substance and into fluid communication with first substance 3160A.

For some applications, the method further comprises, after proximally withdrawing the one or more distal plugs 3150 from within internally-narrower distal portion 3130 to internally-wider proximal portion 3120, inserting collection vial 1650 of the filter assembly at least partially into extraction tube 3118, and distally advancing collection vial 1650 within extraction tube 3118 until filter 60 of the filter assembly is positioned near closed distal end 3132 of extraction tube 3118, wherein the filter assembly further comprises filter shaft 1672, which comprises (a) proximal portion 1687 that is slidably disposed passing through shaft-passage hole 1609 through end 1604 of collection vial 1650 opposite vial opening 1652; and (b) distal portion 1608 that is coupled to filter 60. Extraction tube 3132 is shaped so as to prevent collection vial 1650 from reaching closed distal end 3132 of extraction tube 3118, such that collection vial 1650 slides up a portion of filter-withdrawal shaft 1672 as filter 60 is positioned near closed distal end 3132, thereby ejecting filter 60 from vial opening 1652 and exposing filter 60 to first and second substances 3160A, 3160B in internally-narrower distal portion 3130 of extraction tube 3118.

In an embodiment, the techniques and apparatus described herein are combined with techniques and apparatus described in one or more of the following patent applications, which are assigned to the assignee of the present application and are incorporated herein by reference:
US Patent Application Publication 2019/0381498 to Fruchter et al.;
U.S. Provisional Application 62/727,268, filed Sep. 5, 2018;
PCT Publication WO 2020/049566 to Fruchter et al.;
US Patent Application Publication 2021/0215585 to Fruchter et al.;
U.S. Provisional Application 62/988,145, filed Mar. 11, 2020;
U.S. Provisional Application 62/988,259, filed Mar. 11, 2020;
U.S. Provisional Applications 63/020,723, filed May 6, 2020; 63/037,707, filed Jun. 11, 2020; 63/067,535, filed Aug. 19, 2020; 63/117,294, filed Nov. 23, 2020; 63/156,843, filed Mar. 4, 2021; 63/158,005, filed Mar. 8, 2021; 63/166,378, filed Mar. 26, 2021; and 63/176,565, filed Apr. 19, 2021;
U.S. Provisional Application 63/071,529, filed Aug. 28, 2020;
PCT Publication WO 2021/044417 to Holtz et al.;
US Patent Application Publication 2021/0102876 to Fruchter et al.;
PCT Publication WO 2021/181338 to Fruchter et al., and US Patent Application Publication 2023/0098151 in the US national stage thereof;
PCT Publication WO 2021/181339 to Feldman et al., and US Patent Application Publication 2023/0096409 in the US national stage thereof;
PCT Publication WO 2021/224925 to Levitz et al., and U.S. application Ser. No. 17/921,672 in the national stage thereof;
PCT Publication WO 2022/044002 to Levitz et al., and U.S. application Ser. No. 18/023,607 in the national stage thereof;
U.S. Provisional Application 63/134,282, filed Jan. 6, 2021;
PCT Publication WO 2022/149135 to Feldman et al.;
U.S. Provisional Application 63/275,130, filed Nov. 3, 2021;
U.S. Provisional Application 63/277,238, filed Nov. 9, 2021;
U.S. Provisional Application 63/388,851, filed Jul. 13, 2022;
U.S. application Ser. No. 17/980,200, filed Nov. 3, 2022, which published as US Patent Application Publication 2023/0061094 to Levitz et al.;
US Patent Application Publication 2023/0152192 to Feldman et al.;
PCT Publication WO 2023/095146 to Levitz et al;
U.S. Provisional Application 63/432,231, filed Dec. 13, 2022; and
International Application PCT/IL2023/050014, filed Jan. 5, 2023, which published as WO 2023/131948 to Levitz et al.

In an embodiment, the techniques and apparatus described herein are combined with techniques and apparatus described in PCT Publication WO 2022/149135 to Feldman et al., with reference to FIGS. 1A-35B thereof.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A sampling device for concentrating a liquid specimen sample, the sampling device comprising a filtration assembly, which comprises:
a tubular container, which is shaped so as to define an inner wall and a proximal container opening for receiving the liquid specimen sample;
a plunger, which (i) comprises a plunger head and a plunger rod, which has a distal end portion to which the plunger head is coupled, and (ii) is insertable into the tubular container via the proximal container opening, such that a lateral surface of the plunger head forms a fluid-tight movable seal with the inner wall of the tubular container;
a waste liquid receptacle;
a filter;
a filter support, which is shaped so as to define (a) a support surface on which the filter is removably disposed, and (b) a plurality of filtrate-passage openings through the filter support into the waste liquid receptacle; and
a source of gas, which is configured to provide gas by releasing or generating the gas,
wherein the filtration assembly is configured such that providing the gas by the source of gas, when the liquid specimen sample is contained in the tubular container and the filter is disposed on the support surface, pushes at least a portion of the liquid specimen sample through the filter and the filtrate-passage openings and into the waste liquid receptacle.

2. (canceled)

3. The sampling device according to claim 1, wherein the source of gas comprises one or more substances that generate gas.

4. The sampling device according to claim 1, wherein the source of gas comprises a compressed gas container.

5. The sampling device according to claim 1, wherein the filtration assembly is configured such that movement of the plunger head within the tubular container causes the source of gas to provide gas by releasing or generating the gas.

6. The sampling device according to claim 5,
wherein the movement is non-rotational movement,
wherein the sampling device further comprises a container housing, and
wherein the filtration assembly further comprises a plunger support, which is (a) coupled to a proximal portion of the plunger and (b) hingedly attached to the container housing.

7. The sampling device according to claim 1,
wherein the plunger rod is shaped so as to define the waste liquid receptacle within the plunger rod, and
wherein the plunger head comprises the filter support.

8. The sampling device according to claim 7,
wherein the sampling device further comprises a container housing,
wherein the tubular container is disposed at least partially within the container housing, such that the tubular container is moveable with respect to the container housing, and
wherein the filtration assembly is configured such that the providing of the gas by the source of gas proximally moves the tubular container with respect to the plunger head, thereby pushing the at least a portion of the liquid specimen sample through the filter and the filtrate-passage openings and into the waste liquid receptacle.

9. The sampling device according to claim 8,
wherein the source of gas is configured to provide the gas into a space defined between (a) a proximally-facing internal surface of the container housing and (b) an external surface of the tubular container that is defined by a distal end of the tubular container, and
wherein the filtration assembly is configured such that providing the gas into the space increases pressure in the space, thereby proximally moving the tubular container with respect to the plunger head.

10. The sampling device according to claim 1, wherein a distal bottom surface of the tubular container comprises the filter support.

11. The sampling device according to claim 10,
wherein the filtration assembly further comprises:
a housing, which comprises the tubular container; and
a plunger support, which is couplable to the housing, and which comprises a plunger tube, in which the plunger rod is at least partially disposed so as to be axially moveable with respect to the plunger tube,
wherein the source of gas is configured to provide the gas into a space defined between (a) a proximal surface of the plunger rod and (b) a distally-facing internal surface of the plunger support,
wherein the filtration assembly is configured such that the providing of the gas into the space increases pressure in the space, thereby distally moving the plunger rod with respect to the plunger tube, thereby pushing the at least a portion of the liquid specimen sample through the filter and the filtrate-passage openings and into the waste liquid receptacle.

12-13. (canceled)

14. The sampling device according to claim 1,
wherein the source of gas is configured to provide the gas into a space defined within the filtration assembly,
wherein the filtration assembly is shaped so as to define a source-of-gas chamber, which is in fluid communication with the space only by one or more narrow openings having a total area of 75-8,000 square microns, and
wherein the source of gas is disposed in the source-of-gas chamber.

15. A method for concentrating a liquid specimen sample, the method comprising:
placing, via a proximal container opening, the liquid specimen sample in a tubular container of a filtration assembly of a sampling device;
inserting a plunger head of a plunger of the filtration assembly into the tubular container via the proximal container opening of the tubular container, such that a lateral surface of the plunger head forms a fluid-tight movable seal with an inner wall of the tubular container, wherein the plunger further comprises a plunger rod, which has a distal end portion to which the plunger head is coupled; and
causing a source of gas of the filtration assembly to provide gas by releasing or generating the gas, so as to push at least a portion of the liquid specimen sample through a filter removably disposed in the tubular container on a support surface of a filter support, wherein the filter support is shaped so as to define a plurality of filtrate-passage openings through the filter support into a waste liquid receptacle of the filtration assembly.

16. (canceled)

17. The method according to claim 15, wherein the source of gas comprises one or more substances that generate gas.

18. The method according to claim 15, wherein the source of gas comprises a compressed gas container.

19. The method according to claim 15, wherein causing the source of gas to provide the gas comprises moving the plunger head within the tubular container to cause the source of gas to provide gas by releasing or generating the gas.

20. The method according to claim 19,
wherein the sampling device further comprises a container housing,
wherein the filtration assembly further comprises a plunger support, which is (a) coupled to a proximal portion of the plunger and (b) hingedly attached to the container housing, and
wherein moving the plunger head within the tubular container comprises non-rotationally moving the plunger head within the tubular container.

21. The method according to claim 15,
wherein the plunger rod is shaped so as to define the waste liquid receptacle within the plunger rod, and
wherein the plunger head comprises the filter support.

22. The method according to claim 21,
wherein the sampling device further comprises a container housing,
wherein the tubular container is disposed at least partially within the container housing, such that the tubular container is moveable with respect to the container housing, and
wherein causing the source of gas to provide the gas proximally moves the tubular container with respect to the plunger head, thereby pushing the at least a portion of the liquid specimen sample through the filter and the filtrate-passage openings and into the waste liquid receptacle.

23. The method according to claim 22, wherein causing the energy the source of gas to provide the gas comprises causing the source of gas to provide gas into a space defined between (a) a proximally-facing internal surface of the container housing and (b) an external surface of the tubular container that is defined by a distal end of the tubular container, so as to increase pressure in the space, thereby proximally moving the tubular container with respect to the plunger head.

24. The method according to claim 15, wherein a distal bottom surface of the tubular container comprises the filter support.

25. The method according to claim 24,
wherein the filtration assembly further comprises:
a housing, which comprises the tubular container; and
a plunger support, which is couplable to the housing, and which comprises a plunger tube, in which the plunger rod is at least partially disposed so as to be axially moveable with respect to the plunger tube,
wherein the source of gas is configured to provide the gas into a space defined between (a) a proximal surface of the plunger rod and (b) a distally-facing internal surface of the plunger support, and
wherein causing the source of gas to provide the gas into the space increases pressure in the space, thereby distally moving the plunger rod with respect to the plunger tube, thereby pushing the at least a portion of the liquid specimen sample through the filter and the filtrate-passage openings and into the waste liquid receptacle.

26-27. (canceled)

28. The method according to claim 15,
wherein the source of gas is configured to provide the gas into a space defined within the filtration assembly,
wherein the filtration assembly is shaped so as to define a source-of-gas element chamber, which is in fluid communication with the space only by one or more narrow openings having a total area of 75-8,000 square microns, and
wherein the source of gas is disposed in the source-of-gas chamber.

29. The method according to claim 15, further comprising, after the filter has been removed from the tubular container, detecting the presence of a biological particulate trapped by the filter.

30-80. (canceled)
